(19) United States
(12) Patent Application Publication
(10) Pub. No.: US 2011/0141218 A1
(43) Pub. Date: Jun. 16, 2011

(54) Multifunction Apparatus for Telecommunications

(76) Inventor: Enzo Stancato, Trumbull, CT (US)

(21) Appl. No.: 13/001,132

(22) PCT Filed: Feb. 24, 2009
(86) PCT No.: PCT/IT2009/000063

§ 371 Date: Feb. 14, 2011

(30) Foreign Application Priority Data
Jun. 25, 2008 (IT) CS2008A000016
Feb. 21, 2009 (IT) CS2009A000005

(51) Int. Cl. H04N 7/00; H04N 7/10; H04N 7/14; H04N 7/167

(52) U.S. Cl. 348/14.01; 348/552; 725/32; 725/31; 348/E07.001; 348/E07.077

(57) ABSTRACT

Multifunction apparatus for telecommunications that includes two hard disks or two separated partitions of one hard disk, expansion cards for web connection, tv tuner and decoder for receiving radio and television programs, remote control where a first OS for the multimedia functions on the first partition or hard disk, that both the first and the second Partition or hard disk are controlled with the same remote control, that the first OS has hardware and software restrictions and that it cannot be modified by the user or replaced and that the second operating system does not have restrictions and can be modified or replaced by the user, that this multifunction apparatus also contains a removable and rechargeable battery. The same apparatus can be used for a system for the management of the sale of on-demand content, utilizing three servers and two separated keys where one is an access key and one is decryptation key, as it can implement a security system.

### TECHNICAL AREA OF THE INVENTION

The invention concerns a multifunction telecommunication apparatus and has been created to allow all users in the world to access freely, with the internet connection to any multimedia content, communicating and interacting simply and rapidly, acquiring in this way fast and useful information that is still today not possible to obtain.

The multifunction telecommunication apparatus is one of the most innovative inventions of the multimedia television and web entertainment market, and it possesses DVD, cd and virtual digital communications devices. The various mechanical and components of the hardware are of very advanced technology, allowing all functions hereby described.

This invention is developed in four basic and independent physical structures, defined as follows:
a) A multifunction telecommunications apparatus integrated in a Tv home center, from now on called Tv Net Media Home Centre;
b) A multifunction telecommunications apparatus from now on called Media Magic Box.
c) c) A mobile multifunction telecommunications apparatus from now on called Media Magic Box Mobile.
d) d) A system of multifunction apparatuses of which one has a Master function and the other Slave function, from now on named Media Magic Box Master/Slave;

These tools are based on operating systems, electronic devices and various software of multifunction platforms, with interfaces and applications that use last generation technologies and components, helping at the same time the user access.

The multifunction telecommunication apparatus is a system that unites various technologies of physical television structures, LCD monitors, interfaces, applications and connections via new generation internet cables, wireless broadband and innovative software, constituting one single physical expandable and divisible robotic structure.

Moreover, the multifunction telecommunication apparatus offers the possibility to use all these systems in an independent way, connecting them, independently, to a traditional type monitor (CRT) or an LCD monitor.

This invention has been conceived also in order to obtain a mobile product; in fact, adding a mini LCD panel that composes one structure with the system, makes it similar and uniformed to a portable PC, that possesses the same functions of the above mentioned physical structure and is, moreover usable during travels (auto etc . . . ), because it is possible to use it also at very high speeds

A wireless, traditional or laser projected keyboard can also be connected to the multifunction telecommunication apparatus.

Moreover it is also possible to have several different final independent audio/video channels, thanks to the separate transmission with independent outputs to the various devices, located in different places equipped for audio/video reception.

The transmission methods this apparatus can receive with are three:
1. Satellite
2. Cable
3. Internet (wifi, wimax, broadband)

This is possible, thanks to the hardware it is equipped with, and to our innovative distribution system [FIG. d2].

All this is possible also to the introduction of the “SATELLITE/INTERNET ROUTER” [FIG. d3], that is a device that functions as distributor in the household of internet connection and also of satellite transmissions and decoding.

### STATE OF THE ART AND GOALS OF THE INVENTION

Up to this moment, the integration of TV, PC, DVD, CD, fax, Telephone, printer, scanner, videophone and virtual secretary, could not be obtained if not with the combination of different physical structures and the combination of software and hardware of various types and with different results. The Multifunction telecommunication Apparatus has the functions of a PC, of a television, a monitor, radio, DVD and CD reader and burner, telephone, fax, printer, scanner, videophone (videoconferencing), virtual secretary and closed circuit of video security visualization, allowing the simultaneous and/or independent use of technologies physically located in one unit.

This avoids the need to buy various devices such as: computers, monitors, radios, DVD/CD readers and burners, telephone. Faxes, printers, scanners, videophones (videoconferencing) virtual secretary or other electronic devices.

All this can be achieved thanks to the multifunction telecommunication apparatus In one mechanical, digital and virtual structure.

This implies great economic and space savings, uniting the family in one environment, promoting family harmony and offering a safe entertainment, with the possibility for the parents to monitor and manage the contents available to the children.

Moreover, the multifunction telecommunication apparatus can be used also independently as a traditional television, a office or home PC, call center, mobile office.

In this way the quality of communication, entertainment, data transmission is improved, costs are minimized and the agility and simplicity is increased, especially in order to allow the family can use this invention.

An important part of this invention multifunction telecommunications Apparatus, is that it offers the family a place to stay united, although each member does a different activity, saves money, time and physical space (in order to avoid having to have several distinct electronic tools perform different actions). Moreover, being all together, parents may supervise what their children are doing and check for access or look functions that are not suited to them. In other words our invention provides many functions, all securely.

Even if it is an invention that can be used in all the world and by all social classes, it particularly favors those who cannot afford the luxury of using a PC, DVD, TV, Telephone Monitor, CD, Internet connection at the same time. The advantage is that you do not have to change place, not even move from your comfortable armchair to perform two tasks in same time.

It can also perform some of these functions without the need to remain facing the screen because with Bluetooth and Wi Fi, you may be in another part of the house listening to music from a CD or a radio or listen to news broadcast from your favorite station.

The new and innovative technology of this multifunction telecommunications Apparatus, also applied to a traditional screen, offers opportunity to save money already at the moment of purchase, because the user gains access to multiple operations through a single monitor.

### BRIEF DESCRIPTION OF FIGURES

FIG. D1. Shows the Tvnet media Backend Security system for contents protected by copyright.

FIG. D2—Shows distribution system of channels and on-demand content

FIG. D3 shows the Magic Media Router Structure

FIG. D4—Structure of the Hotel/gated community network

FIG. D5—Shows the Geographical distribution of servers and clients

FIG. D6—Tvnet media Selling system and Call centre

FIG. 1 shows the physical structure of TV NET MEDIA in its entirety, supported on removable media, electronic, mechanical and robotic, that allows any type of rotation.

FIG. 2 shows some physical components of NET TV MEDIA

Number 2.1 shows the coffers for the audio output, side to the facility. These boxes are removable and/or optional according to the tastes of the user, you can open robotics or manually via a remote control

Number 2.2 shows the LCD monitor of TV MEDIA NET

Number 2.3 shows the speakers for the audio output embedded within the physical structure of TV NET MEDIA

Number 2.4 shows a innovative interne camera with a Rotation of 180°, the integratedTV NET MEDIA or removable from MAGIC MEDIA BOX, connected by wireless. This camera acts as webcam or intrusion detector, thanks to an infrared device it's functioning may be scheduled during the hours when the apartment is empty, noting any intrusion. The anti-intrusion can be activated or deactivated Remotely

FIG. 3 shows the accessories that come with the TV MEDIA NET

3.1 shows the location where the cordless phone is stored

3.2 shows the location where the audio video control panel is stored

3.3 shows the drawer where CD/DVD audio/video are Stored, this structure also serves as a player audio/video

3.4 shows the number plate which is stored on the device TECH CONTROL

Number 3.5 show the structural support of NET TV MEDIA

FIG. 4 shows the structures controlled by robotic control or tech manually, embedded in the NET TV MEDIA

Number 4.1 shows the opening of the CD/DVD internal DECODER embedded in the structure of TV MEDIA NET

Number 3.3 shows the opening of the tray where they are housed CD/DVD

FIG. 5 shows the structural support system of TV MEDIA NET

Number 5.1 shows the vertical links that block the physical structure NET allowing the TV to remain well anchored to the structure of support.

Number 5.2 shows the horizontal links that block the rotation of physical structure allowing NET TV MEDIA to remain well anchored to support structure

FIG. 6 shows a assonometric base of support NET TV MEDIA that allows the structure to be able to rotate both horizontally and vertically

Number 6.1 show the system that allows the rotation of the structure support along the vertical axis

6.2 Number plan supported by the physical structure of TV NET MEDIA

Number 6.3 show the system that allows the rotation of the structure support along the horizontal axis

FIG. 7 shows the inside of the of TV NET MEDIA

Number 7.1 shows the inside of the cradle of TV NET MEDIA through system that allows mechanical, electronic and robotic, the rotation of monitor horizontally

FIG. 8 shows the front view of the TV NET MEDIA, resting on stable that allows any type of rotation

Number 8.1 Overview of loudspeakers, optional and removable from TV NET MEDIA

FIG. 9 shows a view from above of NET TV MEDIA

Number 9.1 shows the position of loudspeakers placed behind the TV NET MEDIA

FIG. 10 shows a view from the TV NET MEDIA

Number 10.1 shows the movement of robotic loudspeakers Commanded via the Tech Control

FIG. 11 shows a view from above of NET TV MEDIA opening with robotics and/or manual loudspeakers

11.1 show the number of hinges system that allows rotation of boxes audio up to an angle of 180°

FIG. 12 shows a view from the TV NET MEDIA with a total opening 180 of loudspeakers

8.1 shows the number loudspeakers open

FIG. 13 shows the back of TV NET MEDIA with all the shortcuts and hardware

13.1 shows the number loudspeakers separated by NET TV MEDIA

Number 13.2 shows the placement of loudspeakers placed within the TV NET MEDIA

FIG. 14 shows the back of TV NET MEDIA with all the circuits and hardware

Number 14.1 shows the placement of loudspeakers connected to the TV NET MEDIA

FIG. 15 shows an enlargement of the hardware installed on the back of NET TV MEDIA

Number 15.1 Employment of the innovative integrated rechargeable battery TV NET MEDIA

FIG. 16 shows the individual components mechanical, electronic and robotic on the back of the TV NET MEDIA

16.1 Number player displays CD-DVD burner with bay opening upwards

16.2 shows the number of cooling fans

Number 16.3 shows the Wi-Fi and Wi-Max, which allows you to connect devices to wireless local area networks

16.4 show the number of data storage media: the ‘hard disk”.

16.5 shows the number Mainboard LCD

16.6 shows the number Mainboard PC, the printed circuit board that houses the Microprocessor (CPU), memory Ram, the IDE and SATA controllers, the PCI bus, the PCI Express bus for video cards, the keyboard controller, the mouse controller, parallel port, the USB

Number 16.7 shows the location of the integrated Webcam TV NET MEDIA, connected with wireless device

16.8—displays CD-DVD burner with opening bay

16. shows the satellite and digital terrestrial tuners

16.10 shows the Power supply location

13.1 shows the number loudspeakers separated from the TV NET MEDIA

Number 13.2 show the placement of loudspeakers placed within the NET TV MEDIA

Number 15.1 shows the integrated rechargeable battery and the pull-TV NET MEDIA

FIG. 16/A panel highlighted the bottom of the TV NET MEDIA separated from the main LCD panel.

FIG. 17 shows the TV NET MEDIA structure supporting position Standard

Number 17.1 shows the LCD monitor

FIG. 18 shows the support of TV NET MEDIA upside down in this position are visible mechanisms which allow the rotation

Number 18.1 cylindrical structure that is located within the entire mechanical Rotational of the support structure of TV NET MEDIA

Number 18.2 shows the mechanism that allows the specific Vertical move

Number 18.3 shows the mechanism that enables the specific Horizontal movement

FIG. 19 shows the mechanical rotational given by the action of the spring on ball

19.1 shows the number of mechanical rotational sections inside the base of TV NET MEDIA

19.2 prospect of the rotational mechanics inside the TVNETMEDIA base.

FIG. 20 shows the vertical movement that can move NET TV MEDIA

FIG. 21 shows the horizontal movement that can move NET TV MEDIA

FIG. 22 shows the TV NET MEDIA in its provision of physical screen Telescopic system with mobile, fixed to a wall

Number 22.1 shows the outline of the structure NET TV MEDIA

FIG. 23 shows the mechanism through which it is possible movement of the physical structure of NET TV MEDIA perpendicular to wall

Number 23.1 shows the mechanical guide along which the movement is made Move the TV NET MEDIA

FIG. 24 shows the mechanical device that allows three-dimensional traveling through the movement of the physical structure of TV NET MEDIA. This system is anchored on the back of the TV NET MEDIA

Number 24.1 show the plan support of three-dimensional TV NET MEDIA moving system

FIG. 25 shows the locking System of TV NET MEDIA mechanical gears

25.1 shows a special locking system, through a toothed disc with springs that allow the release and compression of a sphere that captures the sudden movements of the system

FIG. 26 shows the prospect of the system that allows the rotational movement along the vertical and horizontal axis

Number 18.2 shows the mechanism that allows the specific vertical translation

Number 18.3 shows the mechanism that allows for specific horizontal translation

FIG. 27 shows the TV NET MEDIA and the support structure that allows the various turns on the TV

Number 27.1 shows the plane upon which the TV rests

Number 27.2 shows the placement of the internal mechanics

Number 7.1 shows the inside of the base of TV NET MEDIA allowing through mechanical systems, robotic and electronic rotation

Number 3.5 show the structural support of TV NET MEDIA

FIG. 28 shows the specific mechanical system of rotational

Number 28.1 shows a spring, mechanical component

Number 28.2 shows a pin with spherical side exits

Number 28.3 shows the internal mechanism that allows the rotation of the pin

Number 18.2 shows the mechanism that allows the Vertical movement of the support structure TV NET MEDIA

FIG. 29 BASE view of the rotational bar

Number 29.1 Base view of the pin-spring-central gear that allows horizontal rotation of TV NET MEDIA

FIG. 30 shows a particular of mechanical hinge that allows the rotation of the horizontal structure

Number 30.1 view of the internal zipper located at the base of the TV NET MEDIA,

Number 7.1 shows the inside of the base of TV NET MEDIA that allows the mechanical rotation of the monitor

FIG. 31 section view of the mechanical system of support

31.1 Section view of the anchoring system of the base of the TV NET MEDIA

FIG. 32 shows in perspective the physical structure of MEDIA MAGIC BOX

32.1 shows the cooling fan (side)

32.2 show the system heat dissipation—COOLER

32.3 shows the Mainboard

32.4 show the LCD display

32.5 show the infrared sensor

32.6 shows the buttons to switch on or off MEDIA MAGIC BOX

32.7 show the CD/DVD reader

32.8 shows the hard disk, data storage media

32.9 show the Booster, used to maintain the quantity of Incoming band

32.10 shows the location of the power supply

32.11 shows the location of digital terrestrial tuner

32.12 shows the location of the video card

FIG. 33 shows the input output ports placed on the rear of MEDIA MAGIC BOX

33.1 shows the Serial Port

33.2 shows USB ports

33.3 shows the video output (VGA)

33.4 shows the number audio outputs

33.5 shows the Card/flash slots that read media: SD, MMC and all other standard market formats

33.6 shows the Firewire port

33.7 shows the Ethernet ports

33.8 shows the PS2 ports

33.9 shows the DVI ports

33.10 shows the protective wings of the cooling system

33.11 number shows the S-Video

33.12 number shows the output of Wi-Max

33.13 show the satellite card input

33.14 show the digital terrestrial card inputl

33.15 shows the composite video output

FIG. 34 assonometric view of the components of MEDIA MAGIC BOX

34.1 shows the slot where the front of MEDIA MAGIC BOX is inserted

34.2 shows the location of Wi-Fi chip

34.3 shows the location of Wi-Max chips

34.4 shows the power supply

34.5 shows the USB ports

34.6 shows the location of the chip Satellite

34.7 shows the location of the cooling management chip

34.8 show the heat sink, an integral part of MEDIA MAGIC BOX

34.9 shows the BATTERY of MEDIA MAGIC BOX

32.4 show the LCD display

32.5 show the infrared sensor

32.6 shows the number buttons to switch on or off MEDIA MAGIC BOX

32.7 show the reader CD/DVD

32.8 shows the hard disk, data storage media

32.9 show the number BOOSTER

32.11 number shows the location tab Digital Terrestrial

32.12 number shows the location of the video card

FIG. 34A Shows the magic box closed

FIG. 34B

34.B1 view of the open box

FIG. 35

35.1 shows the detail of the Booster, used to maintain stable incoming bandwidth

FIG. 36

36.1 shows the video card

FIG. 37

37.1 shows the detail of the satellite receiver

FIG. 38

32.2 shows the detail of the dissipation COOLER, to channel the hot air out of MEDIA MAGIC BOX

FIG. 39

Number 32.8 show the detail of Hard Disk, in our system are mounted more than one hard disk, partitioned in such a way to guarantee both the use of the TV NET MEDIA system “personal computer”

FIG. 40

32.7 show the detail of the CD/DVD player

FIG. 41

32.3 shows the PC Mainboard, printed circuit houses the microprocessor (CPU), the Memory Ram, Controllers IDE and SATA, the Bus PCI, PCI Express bus for video cards, the keyboard controller, Mouse Controller, input and output ports.

FIG. 42

32.1 show the detail the cooling fan inside the MAGIC MEDIA BOX

FIG. 43

43.1 show the details of USB and Firewire ports

FIG. 44

44.1 shows the number of audio/video ports

FIG. 45

45.1 shows the TV tuner

FIG. 46

32.5 shows the detail of the infrared port

FIG. 47

32.4 shows the LCD Monitor

FIG. 48

34.10 show the detail of the integrated heatsink MEDIA MAGIC BOX

FIG. 49

34.9 shows the detail of the Battery MEDIA MAGIC BOX

49.1 show the battery fitting in the-Media Magic Box

49.2 shows the power supply device for battery

50 shows a side of the TECH CONTROL(Dual System)

50.1 shows the number keypad of TECH CONTROL

50.2 shows mouse integrated into TECH CONTROL

50.3 show buttons for navigation within Our interface

50.4 shows the number keys to adjust the volume

50.5 shows the number buttons for scrolling through the different channels

FIG. 51

51.1 shows the profile of TECH CONTROL(Dual System)

52 shows the second side of TECH CONTROL(Dual System)

52.1 shows the audio/video CD/DVD commands

52.2 shows the keyboard for surfing the internet or writing documents, similar to a PC keyboard

50.1 shows the number keypad of TECH CONTROL(dual system)

50.2 shows a mouse integrated into TECH CONTROL(Dual System)

50.3 show buttons for navigation within our interface

50.4 shows the number keys to adjust the volume

50.5 shows the number buttons for scrolling through the different channels

FIG. 53

Number 53.1 show the removable phone and integrated TV NET MEDIA, which both perform the function of fixed phone than to a common phone

FIG. 54

Number 54.1 shows the openness with innovative system of sliding flip phone with removable and integrated TV NET MEDIA

54.2 show the number system of infrared sensor

54.3 show the number of phone design

FIG. 55

Number 55.1 shows the back of the phone, retractable.

FIG. 56

Number 56.1 show the shell that covers the battery

FIG. 57

57.1 shows the rechargeable battery inside the bay of NET TV MEDIA

FIG. 58

Number 58.1 shows the system of reception by double card that allows a dual reception

FIG. 59

Number 59.1 shows the screenshot of the system welcome MULTIFUNCTION TELECOMMUNICATION APPARATUS

FIG. 60 specifically describes all the controls into the Welcome system MULTIFUNCTION OF APPARATUS TELECOMMUNICATIONS

60.1 shows the BANNER advertising (dynamic bar)

60.2 shows the “HOME”, allows the user to return to Home Page or interface Welcome

60.3 shows the “MAIN”, allows the user to return to the page initial section

60.4 shows the “BACK”, allows user to set the pace Previous

60.5 shows the number of BAR BANNER ADVERTISING almost always This interfaces with the exception of full screen visualizations. This advertising rotates dynamically at fixed intervals.

60.6 shows the BAR ICONS quick access to functionalities, almost always present I the various interfaces, excluding fullscreen views, it is horizontally scrollable

60.7 shows the icon that allows for immediate viewing of Traditional TV

60.8 shows the icon that allows viewing of radio channels

60.9 shows the icon that allows immediate browsing on the Internet

60.10 number shows the icon called “Net Phone Guide”, which uses the integrated to our operating system that allows you to search the web,

60.11 shows the icon that allows you to view directly the box your e-mail address

60.12 number shows the icon that allows you to display phone numbers of doctors and communicate with them.

60.13 shows the icon that allows you to view system resources

60.14 shows the icon that allows you to view information

60.15 shows the icon that allows you to see time emergency numbers such as police, fire etc.

60.16 shows the icon that allows you to view the weather in any time

60.17 shows the icon that allows you to activate video calls and/or access multimedia files

60.18 shows the icon that allows entertainment through games

60.19 shows the icon that allows you to view the menu for choice language

60.20 shows the icon that allows you to view the screen in Full Screen

60.21 the SCROLL icon along the taskbar icons

60.22 the BAR MENU ‘with horizontal scroll

60.23 show the button “LANGUAGE”, which allows the choice of language selected

60.24 show the button “MENU ‘OR’, which allows the user to see requests for content (ON DEMAND)

60.25 show the key TV MENU’”, to watch TV channels with their information

60.26 show the button “SPLIT”, which allows viewing of the different types of display FRAME for up to six channels TV chosen by the same interface

60.27 show the button “INFO”, which allows you to view General information on the system such as updates sent to you

60.28 show the button “HELP” to help guide the user in Navigation within the system

60.29 show the button “Internet”, allows browsing on the Internet via our browser

60.30 show the button “TV GUIDE”, can see what the programming channels from around the world

60.31 show the button “Interact”, which allows multi-and multiprocess

60.32 show the logo “TV NET MEDIA”

59.1 shows the interface of the system welcome MULTIFUNCTION TELECOMMUNICATION APPARATUS

FIG. 61 shows the interface and initial selection by the user of button “LANGUAGE” put on BAR MENU’

61.1 shows key LANGUAGE selected by the user who lights allowing you to open a new interface

60.6 shows the number of BAR ICONS quick access to functionality, almost always present interfaces, excluding full views screen, with horizontal scroll

60.22 shows the number BAR MENU ‘with horizontal scroll

FIG. 62 shows the interface specific category LANGUAGE

62.1 shows the panel for the selection of the nation choosing the way that the user prefers to see contents and channels of the nation

62.2 show the box that allows the user to choose the language you want to see the labels in.

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable.

60.22 shows the MENU BAR ‘with horizontal scroll

FIG. 63 shows the HOME interface, viewable by you when System starts

63.1 shows the selection made of the TV icon for TV display interface

FIG. 64 shows the TV interface, viewable by selecting the appropriate icon (see FIG. 63 Number 63.1)

Number 64.1 shows displaying a full screen TV channel, which will appear immediately after the choice icons TV

FIG. 65 shows the TV interface with the menu function BAR that allows the user to be able at any time interact with all features of our system

64.1 shows the number viewing a TV channel that will appear immediately after choosing a TV channel

60.29 shows the button “INTERNET”, which allows the user a immediate internet surfing

60.31 shows the button “Interact” and that allows multi multiprocess on our system

60.25 shows the key TV MENU’”, to watch TV channels with their information

60.24 shows the button “MENU ‘OD’, which allows the user to choose content on demand

60.26 shows the button “SPLIT”, which allows viewing the list of the various types of FRAME for up to six TV channels chosen by the same interface

60.27 shows the button “INFO”, which allows you to view General information on the system such as updates sent to you

60.32 shows the logo “TV NET MEDIA”

65.2 shows the “REC”, which allows the user to access the registration panel to be able to record directly or program a recording a non proprietary content

65.3 shows the “MUTE”, which allows the user to be able to disable audio content

65.4 shows the “CHANNELS”, allows for access directly to the bar containing a list of all the TV channels

FIG. 66 shows the TV interface

66.1 show the button “CHANNEL”, which allows selected by the Displays the list of BAR CHANNELS. This tool has horizontal scroll

66.2 shows the CHANNELS BAR, with horizontal scroll, viewable within the TV

65.1 BAR TV shows, with horizontal scroll, viewable within the TV, which appears to be approaching the pointer mouse down the screen, or through a dedicated button on the special remote control

FIG. 67 shows the interface and TV BARs

67.1 shows the screen for viewing TV programs

67.2 shows the list of CHANNELS

66.1 show the button “CHANNEL”, as chosen by 66.2 shows the number of CHANNELS BAR, with horizontal scroll, viewable within the TV

65.1 BAR TV shows, with horizontal scroll, viewable within the TV, which appears to be approaching the pointer mouse down the screen, or through a dedicated button on the special remote control

60.29 shows the button “INTERNET”, which allows the user an immediate internet surfing

60.31 shows the button “Interact” and that allows multiprocess on our system

60.25 show the key TV MENU’”, to watch TV channels with their information

60.24 show the button “MENU ‘OD’, which allows the user to require content

60.26 show the button “SPLIT”, which allows viewing FRAMEs for up to six TV channels contemporarily chosen by the same interface

60.27 show the button “INFO”, which allows you to view General information on the system such as updates sent to you

60.32 shows the logo “TV NET MEDIA”

65.2 shows the “REC”, which allows the user to access the registration panel to be able to record directly or program a recording a non proprietary content

65.3 shows the “MUTE”, which allows the user to be able to disable audio content

FIG. 68 shows an example of selecting a TV channel

66.1 show the button “CHANNEL”, chosen

68.1 number is highlighted key channel of choice

68.2 number is highlighted on the monitor TV channel choice

FIG. 69 shows the HOME interface, viewable by you when loading the System

69.1 shows the selection of the command MENU TV, which allows the user to enter a new interface system and watch the TV channels with information

60.5 shows the BANNER ADVERTISING BAR (almost always present, except in few screens and fullscreen views), horizontally scrollable.

60.6 shows the number of BAR ICONS quick access to functionality, almost always present interfaces, excluding full views screen, with horizontal scroll

60.22 shows the number BAR MENU ‘with horizontal scroll

FIG. 70 shows the TV MENU interface, viewable by you after you selected the TV MENU button (see FIG. 69 Number 69.1)

70.1 shows the BAR MENU ‘with horizontal scroll, in TV MENU

70.2 show the key INT.CH “which allows the user to view the international channels

70.3 shows the “SCHEDULE”, allows the user to see the program schedule (programming) of the selected channel

70.4 shows the header of Advertising column.’

70.5 shows advertisements managed by the system, this section has Vertical scroll

70.6 shows the number of headline MENU ‘CHANNELS

70.7 shows the number BAR with TV CHANNELS. This bar has a scroll vertical

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable.

60.24 show the button “MENU ‘OR’, which allows the user to require content

60.25 show the key TV MENU‘”, to watch TV channels with their information

60.26 show the button “SPLIT”, which allows viewing of the different types of display FRAME for up to six channels TV chosen by the same interface

60.27 show the button “INFO”, which allows you to view General information on the system such as updates sent to you

60.28 show the button “HELP” to help guide the user in Navigation within the system

60.29 show the button “Internet”, allows browsing on the Internet via our browser

60.30 show the button “TV GUIDE”, can see what the programming channels from around the world

65.3 shows the “MUTE”, which allows the user can disable audio content selected

FIG. 71 shows the selection of information programs in the TV MENU

71.1 shows the selection of a channel within the TV MENU

71.2 shows the display of selected channel

71.3 shows the selection of the “schedule” button that views the schedule of the selected channel-(Channel programming)

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable.

70.1 shows the BAR MENU ‘with horizontal scroll, in TV MENU

70.5 shows advertisements managed by the system, this section has Vertical scroll

FIG. 72 shows the interface with MENU TV viewing the selected channel

72.1 is displayed on the TV screen program schedule (programming) of the selected channel

72.2 shows the headline of the selected channel for viewing programming

71.1 shows the selection of a channel within the BAR of TV MENU

71.3 shows the selection of the “schedule” button wich views the schedule of the selected channel-(Channel programming)

70.1 shows the BAR MENU ‘with horizontal scroll, in TV MENU

70.5 shows advertisements managed by the system, this section has Vertical scroll

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable.

FIG. 73 shows the sequence of selections for viewing INTERNATIONAL CHANNELS “INT.CH” in the TV MENU

73.1 shows the selection of “INT.CH” Key, clicking on which the user enters the category of INTERNATIONAL CHANNELS

73.2 shows the selection of NATIONS BAR: Italian

73.3 shows the channel selection

73.4 shows the channel viewing on the TV monitor

73.5 shows the selected channel header

FIG. 74 shows the commands within the selected category INTERNATIONAL CHANNELS in the TV MENU

74.1 shows the headline of NATIONS BAR

74.2 shows the NATIONS BAR, which allows the user to choose the channels of any nation in the world, this bar has vertical scroll

74.3 shows the subcategories of NATIONS BAR, where the user can Choose a regional channel of the selected nation.

74.4 shows the specific channels that correspond to the selection made by the user. This tool has a horizontal scroll

73.1 shows the selection of “INT.CH” Key, clicking on which the user enters the category of INTERNATIONAL CHANNELS

73.2 shows the selection of NATIONS BAR: Italian

73.3 shows the channel selection

73.4 shows the channel viewing on the TV monitor

73.5 shows the selected channel header

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable.

Number 70.3 shows the “SCHEDULE”, allows the user to see the program schedule (programming) of the selected channel

70.4 shows the header of Advertising column.’

70.5 shows advertisements managed by the system, this section has Vertical scroll

60.24 show the button “MENU ‘OR’, which allows the user to see requests for content (ON DEMAND)

60.25 show the key TV MENU’”, to watch TV channels with their information

60.26 show the button “SPLIT”, which allows viewing of the different types of display FRAME for up to six channels TV chosen by the same interface

60.27 show the button “INFO”, which allows you to view General information on the system such as updates sent to you

60.28 show the button “HELP” to help guide the user in Navigation within the system

60.29 show the button “Internet”, allows browsing on the Internet via our browser

60.30 show the button “TV GUIDE”, can see what the programming channels from around the world

65.3 shows the “MUTE”, which allows the user to be able to disable audio content

FIG. 75 shows the selection of the Internet button. You can access this selection from any category.

64.1 display shows the contents of a full screen, already in execution

75.1 shows when viewing a full screen the content selection function INTERNET

FIG. 76 displays interactivity ‘with INTERNET default, MAIN FRAME in with the possibility of swapping, allowing not to lose the contents that where previously displayed in full screen (see FIG. 75)

64.1 shows the display of the content displayed in the first full screen

76.1 shows the connection request to the server on MAIN FRAME—For MAIN FRAME we intend the larger frame placed in the center.

76.2 Shows the lateral frames, with which users can interact and view more channels and/or content

76.3 shows the MENU BAR, where the INTERNET button is visible, with horizontal scroll, viewable within the INTERNET interface, which appears by placing the mouse pointer on the bottom of the screen, or through a dedicated button on the remote control

66.2 shows the CHANNELS BAR, with horizontal scroll, viewable within the TV

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable.

FIG. 77 shows how you can switch in the INTERACT default different views. While the initial Internet page is loading, the user can swap content and the loading internet page

77.1 loading the internet page on the SIDE FRAME

77.2 Shows in the MAIN FRAME the visualization of content in the meantime the internet page is loading in the sideframe

76.3 shows the menu bar, with horizontal scroll, viewable within the INTERACT

76.2 shows other SIDE FRAMES, that the user can interact with to visualize other content.

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable.

66.2 shows the CHANNELS BAR, with horizontal scroll, viewable within the TV

FIG. 78 shows how you can switch different views using the swap and the Internet homepage loading completed

INTERNET

78.1 shows the web page loaded

78.2 shows in the MAIN FRAME the visualization of the content chosen by the user.

76.2 shows other SIDE FRAMES, that the user can interact with to visualize other content.

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable.

66.2 shows the CHANNELS BAR, with horizontal scroll, viewable within the TV

76.3 shows the menu bar, with horizontal scroll, viewable within the INTERACT

FIG. 79 Shows how the user can switch, with the swap function, the different visualizations. Once that the homepage is loaded, In this screenshot the user swaps the content, inserting in the MAIN FRAME the content of the requested internet page, and in the side frame the contents that was previously shown in the MAIN FRAME [FIG. 78.]

79.1 Shows the internet visualization that the user has decided to insert in the MAIN FRAME.

79.2 Shows the video visualization that the user has decided to insert in the SIDE FRAME, By swapping it with the internet.

76.2 shows other SIDE FRAMES, that the user can interact with to visualize other content.

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable.

66.2 shows the CHANNELS BAR, with horizontal scroll, viewable within the TV

76.3 shows the menu bar, with horizontal scroll, viewable within the INTERACT

60.20 shows the icon that allows you to view the content selected in Full Screen

FIG. 80 shows how the user decides to switch to full screen mode, through the appropriate button (see FIG. 60 60.20) or with a dedicated button on the TECH CONTROL

80.1 Internet viewing: shows our browser fullscreen mode.

FIG. 81 Shows the interface that is displayed when the user selects the INTERACT button where a MAIN FRAME ad three SIDE FRAMES are shown, allowing the user to visualize any content, and to do any combination of swapping between windows.

81.1 shows the selection of the INTERACT button

81.2 main frame on the monitor

81.3 three SIDE FRAMES

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable.

66.2 shows the CHANNELS BAR, with horizontal scroll, viewable within the TV

76.3 shows the menu bar, with horizontal scroll, viewable within the INTERACT

FIG. 82 shows the HOME interface, where the user can select categories through the menu bar (see page 48, FIG. 60)

82.1 shows the selection of key MENU OD. “The ON MENU DEMAND allows the user to enter a new category and make any type of purchase or request through the system

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable.

66.2 shows the CHANNELS BAR, with horizontal scroll, viewable within the TV

FIG. 83 shows the initial interface MENU OD, which allows the user to perform any type of purchase and/or request with ease.

83.1 shows the BAR of principal categories selected within the OD MENU

83.2 shows the “SEARCH PROD” button, which allows the user to do any research of product through our search engine.

83.3 show the button “MOVIES”, which allows the user to see the trailer and choose the kind of favorite movie, to buy or rent

83.4 shows the “SPORT”, which allows the user to view the favorite sporting event, eventually to purchase

83.5 shows the “RADIO”, which allows the user to listen and choose the kind of music on demand he/her prefers

83.6 shows the “GAMES”, which allows the user to view the trailer and choose the favorite games, and eventually purchase

83.7 shows the “MUSIC”, which allows the user to buy a CD/DVD audio/video, or even individual songs

83.8 shows the “EVENTS”, which allows the user to buy Tickets for the cinema, to sports events, concerts etc.

83.9 show the button “EDUCATION”, the user through this function has the ability to access multimedia services regarding education

83.10 show the button “CHILD. MOVIES”, which allows the user to view and buy any programming for kids

83.11 shows the advertising system managed by the main FRAME during the purchase or request for a content from the server

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable.

70.5 shows advertisements managed by the system, that section has Vertical scroll

FIG. 84 shows the initial interface MENU OD, with an example of Selection of the category “MOVIES.” For each category is selected into a sub-display that guides you in a simple simple and intuitive manner to choose the desired content

84.1 shows the selected button: category “MOVIES”, within Categories of the bar for searching video content

84.2 shows the subcategory “BAR MENU” with a vertical scroll on the selection of category MOVIES

83.1 shows the BAR of principal categories selected within the OD MENU

FIG. 85 describes all the specific commands in the OD MENU

84.1 shows the selected button: category “MOVIES”, within Categories of the bar for search of video content

83.1 shows the BAR of principal categories selected within the OD MENU

83.2 shows the “SEARCH PROD” button, which allows the user to do any research of product through our search engine.

83.3 show the button “MOVIES”, which allows the user to see the trailer and choose the kind of favorite movie, to buy or rent

83.4 shows the “SPORT”, which allows the user to view the favorite sporting event, eventually to purchase

83.5 shows the “RADIO”, which allows the user to listen and choose the kind of music on demand he/her prefers

83.6 shows the “GAMES”, which allows the user to view the trailer and choose the favorite games, and eventually purchase

83.7 shows the “MUSIC”, which allows the user to buy a CD/DVD audio/video, or even individual songs

83.8 shows the “EVENTS”, which allows the user to buy Tickets for the cinema, to sports events, concerts etc.

83.9 show the button “EDUCATION”, the user through this function has the ability to access multimedia services regarding education

83.10 show the button “CHILD. MOVIES”, which allows the user to view and buy any programming for kids

85.1 shows the information window

85.2 shows the sub-MENU button “ACTION” that allows the user to view the trailer and choose his of favorite action movie

85.3 shows the sub-MENU button “CARTOON” that allows the user to view the trailer and choose his of favorite cartoon

85.4 shows the sub-MENU button “COMEDY” that allows the user to view the trailer and choose his of favorite comedy

85.5 shows the sub-MENU button “Document” that allows the user to view the trailer and choose his of favorite documentary

85.6 shows the sub-MENU button “DRAMA” that allows the user to view the trailer and choose his of favorite drama

85.7 shows the sub-MENU button “FOREIGN” that allows the user to view the trailer and choose his of favorite foreign programming.

85.8 shows the sub-MENU button “MUSICAL” that allows the user to view the trailer and choose his of favorite MUSICAL programming.

85.8 shows the sub-MENU button “Sci-Fi” that allows the user to view the trailer and choose his of favorite science fiction movie.

85.10 85.8 shows the sub-MENU button “TERROR” that allows the user to view the trailer and choose his of favorite horror movie.

85.12 show the button “INFO” that allows the user to receive information relating to the selection

85.13 show the button “BUY” that allows the user to purchase of desired content

85.14 show the button “HELP” that helps you through the various steps

85.15 show the button “RENT” to rent desired content

85.16 show the button “REC”, can open a panel of all recordings being made and allows you to record in the immediate non proprietary content, the user can also can program the recording. Allows access to the records available quickly

85.17 show the button “SCHEDULE”, allows you to view the scheduling of any channel

85.18 show the button “GUIDE”, allows the user to receive general instructions of the whole system

85.19 show the button “MUTE”, allows the user to remove the sound of selected content

83.11 Shows in the main frame the advertising managed by the system during the purchase or request for content.

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable.

70.5 shows advertisements managed by the system, this section has Vertical scroll

FIG. 86 shows the interface MENU OD, with an example selection of category “MOVIES”, and the display of the type of movie you may want to buy or rent.

84.1 shows the “MOVIES” selected by the user, within the categories BAR of searching for video content

86.1 shows the sub Menu referring to the selection of CATEGORY MOVIES

86.2 shows the choice of the user you want to see MOVIES, a specific kind of like “ACTION”, within the subcategories BAR 86.3 shows of issues advertising by content

86.4 shows content ACTION selectable through Contents of the BAR, with a vertical scroll

83.1 shows the main category of selected topics within the MENU OD

FIG. 87 shows in the MENU OD, the next step OF selection after selecting a MOVIES and a specific type: ACTION

84.1 show the button “MOVIES” selected by the user, within the Categories of BAR, searching for video content

86.2 shows the choice of the user you want to see MOVIES, a specific kind of like “ACTION”, within the subcategories BAR

87.1 shows the selection by the user specifies a MOVIES, ACTION generally selected on the BAR CONTENT

86.4 shows content ACTION selectable through Contents of the BAR, with a vertical scroll

87.2 show the trailer of selected content, viewable in MAIN FRAME

87.3 shows how the user, after viewing the trailer contents selected, may decide to buy, rent, or perform other operations BAR on the OPTIONS. This bar has a horizontal scroll

87.4 shows how the user after viewing the trailer contents Selected decides to rent and view an content immediately

85.12 show the button “INFO” that allows the user to receive information relating to the selection

85.13 show the button “BUY” that allows the user to purchase of desired content

85.14 show the button “HELP” that helps you through the various steps

85.15 show the button “RENT” to rent desired content

85.16 show the button “REC”, can open a panel of all recordings being made and allows you to record in the immediate non proprietary content, the user can also can program the recording. Allows access to the records available quickly

85.17 show the button “SCHEDULE”, allows you to view the scheduling of any channel

85.18 show the button “GUIDE”, allows the user to receive general instructions of the whole system

85.19 show the button “MUTE”, allows the user to remove the sound of selected content

FIG. 88 shows the first phase of the rental/purchase where the user is preparing to rent/purchase the selected content MOVIES—ACTION

88.1 shows in the MAIN FRAME the trailer of selectd contents

88.2 shows the of CONFIRM BAR where he invites you to confirm the hiring of the chosen content

87.1 shows the selection by the user specifies a MOVIES, ACTION generally selected on the BAR CONTENT

86.4 shows content ACTION selectable through Contents of the BAR, with a vertical scroll

83.1 shows the main category of selected topics within the MENU OD

84.1 show the button “MOVIES” selected by the user, within the categories bar searching for video content

FIG. 89 shows the second phase of the rental/purchase, the system asks the user to enter their data for the rental of content

84.1 show the button “MOVIES” selected by the user, within the Categories of BAR, searching for video content

87.1 shows the selection by the user specifies a MOVIES, ACTION generally selected on the BAR CONTENT

89.1 shows the interface for the rental of selected content

FIG. 90 shows the description of the second phase of the rental/purchase process

89.1 shows the interface for the rental of selected content

87.1 shows the selection by the user, he specifies a MOVIES, ACTION generally selected on the CONTENT BAR

86.4 shows content ACTION selectable through Contents BAR, with a vertical scroll

83.1 shows the main category of selected topics within the MENU OD

90.1 shows area for the inclusion of own personal “USERNAME”

90.2 shows area for the inclusion of own personal “PASSWORD”

90.3 shows area for the inclusion of own personal “EMAIL”

90.4 shows the area for the inclusion of its “PHONE”,

90.5 shows the area for the inclusion of personal “USER COD.” or customer code

90.6 shows in a non-editable area the title of the chosen content

90.7 Shows the area where the system asks for the date of rental

90.8 shows the application of the system asking for the our rental time

90.9 shows the application of the system asking for how many days you want to rent

90.10 that shows the cost for the purchase of specific content

90.11 shows various methods of payment that can be accepted by system

90.12 show the “OK” button to start the confirmation for the purchase of content

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable

FIG. 91 shows the interface with the credit card info by the system

91.1 shows the information after the request to the system to perform confirmation

91.2 show the button of transaction confirmation

FIG. 92 Shows the interface where descriptions of the product appear, before visualizing the selected content the user can decide the type of video definition and see the specs of the purchase he just made

92.1 show the button of transaction confirmation

FIG. 93 shows the details of the interface viewable within the MENU ‘OD, before viewing the content chosen

90.1 shows area for the inclusion of own personal “USERNAME”

90.2 shows request for the inclusion of own personal “PASSWORD”

93.1 shows the response of the transition done

93.2 shows the type of credit card with which the user has made the transition

93.3 shows the user the date chosen for the rental of content

93.4 to show the type of product rented/purchased

93.5 to show the kind of film that was hired, that is if you a film for the whole family or a movie forbidden to minors

93.6 Show the time and date of the product rented/purchased

93.7 Shows in which kind of definition prefers view the contents rented

93.8 Shows the user how many days is the rental

93.9 Shows the cost i for the chosen rental of content

93.10 START button to display content

83.1 shows the BAR of principal categories selected within the OD MENU

84.1 show the button “MOVIES” selected by the user, within the Categories of BAR, searching for video content

87.1 shows the selection by the user specifies a MOVIES, ACTION generally selected on the BAR CONTENT

86.4 shows content ACTION selectable through Contents of the BAR, with a vertical scroll

FIG. 94 shows the interface that allows you to view the video rental with a simple media player

94.1 show the FRAME where the user sees the rented contents

94.2 show the button that allows the display of rented content in full screen mode

94.3 shows the commands to increase or decrease the audio This command also exists on the tech control

94.4 show the button that allows the user to return in the Previous

94.5 shows the “PAUSE button

94.6 shows the “STOP”, button

94.7 show the button “PLAY” to start easily see chosen content

94.8 shows the “reverse” to send video backwards

94.9 shows the “fast forward” to send video ahead

83.1 shows the main category of selected topics within MENU of the OD

84.1 show the button “MOVIES” selected by the user, within the BAR categories of searching for video content

87.1 shows the selection by the user specifies CONTENT BAR

86.4 shows content ACTION selectable through Contents of the BAR, with a vertical scroll

FIG. 95 shows the interface viewable in the OD MENU BAR of categories, which allows the user to add products to CART order to make purchases

95.1 shows the selection of button “CART” that allows the user to enter into specific where you see the contents of THE CART

FIG. 96 shows all specific controls in “CART” section (All products)

95.1 shows the selection of button “CART” that allows the user to enter into specific where you see the contents of THE CART

96.2 show the “PURCHASES button”, which allows the user to view the purchases made through our system

96.3 shows the “USER” by accessing into CART

96.4 shows the selectable bar inserted in the cart, this bar has a vertical scroll

96.5 shows the product descriptions included in the basket

96.6 shows the clickable options on this interface

96.7 shows the key to the selection of all products included in the basket

96.8 shows the button for deselecting all products included in Cart

96.9 shows the button to reset or clear the cart

96.10 shows the button to delete the selected product

96.11 shows the button to buy selected products

96.12 show the total price of the products you want to buy

96.13 show the NAME I of tems in cart

96.14 show the type of items in cart

96.15 show the price of individual items in the cart

96.16 the system asks you how you wish to pay the selected objects

96.17 show the button that must be selected to select the product from purchase

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable 70.5 shows advertisements managed by the system, that section has Vertical scroll

83.2 shows the “SEARCH PROD” button, which allows the user to do any research of product through our search engine.

83.3 show the button “MOVIES”, which allows the user to see the trailer and choose the kind of favorite movie, to buy or rent

83.4 shows the “SPORT”, which allows the user to view the favorite sporting event, eventually to purchase

83.5 shows the “RADIO”, which allows the user to listen and choose, the kind of music on demand he/her prefers

83.6 shows the “GAMES”, which allows the user to view the trailer and choose the favorite games, and eventually purchase

83.7 shows the “MUSIC”, which allows the user to buy a CD/DVD audio/video, or even individual songs

83.8 shows the “EVENTS”, which allows the user to buy Tickets for the cinema, to sports events, concerts etc.

FIG. 97 shows the interface viewable in the OD MENU BAR of categories, which allows the user to view purchases made through our system

96.2 show the “PURCHASES button”, which allows the user to view the purchases made through our system

FIG. 98 shows specifically all controls in “PURCHASES” (Purchases made)

96.2 show the “PURCHASES button”, which allows the user to view the purchases made through our system

98.1 shows the bar with a vertical scroll of the products purchased

98.2 show the area where entering data for product search, with drop-down menu

98.3 shows the system application where you are asked to insert the time range in wich you would like to make to search

98.4 shows the application of the system to where it is asked to insert the way you want to search product previously purchased. Example: ordering products purchased in Alphabetical order

98.5 shows how the search of product previously purchased can be made by entering the name of the desired product

98.6 shows the “SEARCH” button to search for the product previously purchased

98.7 shows the button to reset the search

98.8 shows the name of the product previously purchased

98.9 shows the type of product previously purchased

98.10 shows the date and time in which the product was purchased

98.11 shows the price paid to purchase the product

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable 70.5 shows advertisements managed by the system, that section has Vertical scroll

70.5 shows advertisements managed by the system, that section has Vertical scroll

FIG. 99 shows the interface, as the user selects the button Emergency from the ICON BAR

99.1 show the EMERGNCY “button selected by the user

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable

FIG. 100 shows the interface that is displayed by clicking on the s on the bar of icons for rapid access capabilities

99.1 show the EMERGNCY “button selected by the user

100.1 shows the interface “EMERGENCY” with all the useful s

100.2 shows the icon for emergency contact, this command directly connects to the fire department

100.3 shows the icon that allows access to useful content through Web or phone, regarding airlines

100.4 hows the icon that allows access to useful content through Web or phone, regarding restaurants

100.5 shows the icon that allows the user to book travel in a simple and immediate way

100.6 shows the useful icon that lets the user view maps

100.7 shows the icon that allows access to useful content through Web or phone, regarding buses

100.8 shows the icon that allows access to useful content through Web or phone, regarding trains

100.9 shows the icon for emergency contact through the selection, this command connects directly to the emergency room

100.10 shows the icon for emergency contact, this command directly connects to the police

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable

70.5 shows advertisements managed by the system, that section has Vertical scroll

70.5 shows advertisements managed by the system, that section has Vertical scroll

FIG. 101 shows the moment when the user views a full video In the case of unwanted advertisements in the system, the user can move them in any moment the user can move the advertising in any moment on the side frame and watch any other channel he prefers on the main frame.

101.1 show the videos in full screen format

101.2 shows the arrival during the viewing of a video channel advertising

101.3 shows the of choice through the mouse or controller to enter INTERACT mode

101.4 shows the MENU BAR with horizontal scroll

101.5 shows the of CHANNELS BAR, with horizontal scroll

101.6 shows the chosen by the user to view a new MAIN FRAME on the channel. The user through the tech control has made the swap, switching the images

96.2 show the “PURCHASES button”, which allows the user to view the purchases made through our system

101.7 shows how the user can interact dynamically with the advertising of our information system

101.8 view of a video channel on a SIDE FRAME

101.9 shows that you have the opportunity to move the movie from the SIDE FRAME to FRAME MAIN without losing an Instant of the film, and then returning to the video mode fullsceen

FIG. 102 shows how the user accesses the interface of the registration Panel if the button REC is selected

102.1 shows the registration panel

FIG. 103 shows for the specific symbols in the present registration panel

103.1 shows the “Channel”, which indicates the channel source that is recording

103.2 shows how the user can set the start and end of recording,

103.3 shows how the user can set the desired date of recording

103.4 shows the “REC” to start recording after setting all the parameters

103.5 show the “OK” to confirm the registration after setting all the parameters

103.6 shows channels bar to perform registration, the bar has a vertical scroll

103.7 shows the dates selected when the recordings will run, this bar is equipped with vertical scroll

103.8 shows the hour of recording, this bar is with a vertical scroll

103.9 shows the state of the recording, this bar is with a vertical scroll

103.10 icon shows the “STOP” to stop recording

103.11 icon shows the “PLAY” to start recording

103.12 icon shows the “DEL” to cancel the registration

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable

60.22 shows the MENU BAR ‘with horizontal scroll

70.5 shows advertisements managed by the system, this section has Vertical scroll

FIG. 104 shows the interface “SEARCH PRODUCT” vision from any search button, which allows the user to search for any content desired

104.1 shows the headline of “SEARCH PRODUCT”

FIG. 105 shows specifically the buttons of the “SEARCH PRODUCT ” interface

104.1 shows the headline of “SEARCH PRODUCT”

105.1 shows the of advertising related to credit cards

105.2 shows the “USER search

105.3 area for the user name search

105.4 area for the category search

105.5 area for the type search

105.6 area for the company search

105.7 area for distributor search

105.8 area for language search

105.9 shows the indication by the system of the day and time in where you search

105.10 user questions on the amount of product required

105.11 show the price range in which the product results must fall

105.12 show the “OK” to start searching

60.5 shows the BANNER ADVERTISING BAR (almost always present, except in few screens and fullscreen views), horizontally scrollable.

60.6 shows the ICONS BAR for quick access to functionality, almost always present in the interfaces, excluding fullscreen views, horizontally scrollable

70.5 shows advertisements managed by the system, this section has Vertical scroll

FIG. 108 The new Tv net media splash screen

FIG. 109—The new Tvnet media Homepage with the new ICON BAR and the CLOCK,

FIG. 110 a screenshot of the ondemand function (with central Advertisments)

FIG. 111 The TVFS Bar And Preview window.

FIG. 112 The phone function—an incoming call arrives while the user is watching a movie.

FIG. 113 the VIDEO function, with the central screen visualization and the media content in the little screen of the phone

FIG. 114—The NETPHONE GUIDE search interface

FIG. 115—The NETPHONE GUIDE Telephone search interface

FIG. 116—The NETPHONE GUIDE Telephone search interface results, with the phone number highlighted, ready to place a call with the Phone function.

FIG. 118—ADVERTISING AND THE FAVORITES ADVERTISING BAR, to save and then retrieve your favorite advertisments and eventually place an order. the “save” button will add the current viewed advertisment to the bar. close will close the bar.

FIG. 119—tv full screen

FIG. 120—tv full screen with incoming call

FIG. 121—SWITCH FUNCTION SELECTED—the viewed movie passes in the preview window on the bottom right and the call passes in Fullscreen mode.

FIG. 122.—the Netphone guide interface

FIG. 123.—the Netphone guide interface with the commercial code selected

FIG. 124.—the Netphone guide telephone search mask

FIG. 125.—the Netphone guide telephone search mask results

FIG. 126.—the Netphone guide advertising, with the FAVORITE link selected, so that the displayed adversisement will be added to the FAVORITES BAR.

FIG. 127—The net phone guide ADVANCED WEB SEARCH

FIG. 128—The net phone guide ADVANCED WEB SEARCH results

FIG. 129—The LOCAL CHANNELS and INTERNATIONAL CHANNELS interface, to visualize the available channels, navigating through the scrolls selecting the countrie and region the channel belongs to.

FIG. 130 options of shutdown/restarting systems: restart tuo, start other OS, shutdown, standby.

### DETAILED DESCRIPTION OF AN EMBODIMENT OF THE INVENTION

Multimedia Function and Traditional PC Function

The device object of the present invention is composed by an electronic structure and various operating systems that allow to operate independently, both as an electronic system for the multimedia function, and as a traditional PC dividing part of the Hardware and Software components, maintaining two separate hard disks or only one HD with two separate partitions, one hard disk or partition for our multimedia system (A) and another hard disk or partition for the Traditional PC system (B).

The hard disks or partitions will have no conflict between them, and will maintain the media system (A) free from any potential computer virus, blocking all possible unauthorized access, using independent operating system, with open source platforms adapted for the functioning of the system. The hard disk or partition for the multimedia system (here called: A) contains an operating system independent for the single telecommunication function with hardware and software restrictions.

Software: to protect our multimedia system from voluntary and involuntary manumissions of the user or other software that may cause possible damage. Hardware: one or more security seals, for the same reasons described for the software and also not to give the opportunity to copy and then carry or distribute proprietary material, as in the case of video content that has been only rented;

The other hard disk or partition (here called: B), serves for the operation of the traditional integrated computer. The operating system on A cannot be changed by the user, while the other operating system B for traditional PC can be adapted or replaced installing one of any operating systems currently available on the market. Also the user can switch from A to B easily, without user interaction from B to A or from A to B. The only possible interaction is the invocation of the system B from A,

The passage from B to A will happen automatically at the shutdown of B. This is because B cannot call the system A but A can call the system B. At the system startup A will be reloaded. The reason of this is to avoid the risk of unauthorized tampering or infections by viruses that could damage the system A.

Hardware Components that Constitute the Patent

The Multifunction telecommunications Apparatus has the following characteristics:
RAM for high performance;
high-performance CPU;
Dedicated Video Card high performance;
Slim CD-DVD Optical Drive;
Small but high performance motherboard.

Expansion ports such as:
PCI, FireWire, Serial port, USB ports, Video and Audio outputs, Analogue and Digital;
HDMI; DVI outputs, D-Sub outputs and S/PDIF, up to 8 channels multichannel high-definition audio,
card reader (CF, MMC, MS, SD);
connectivity via LAN, high capacity Gbit;
WI-FI, Bluetooth,
Battery with innovative heat sink.

Booster Hardware and Software: manages the output frequency as a bridge that stabilizes the bandwidth using a the hardware and software system. This is used to ensure the display of content without loss of resolution and speed system for correcting errors of data transmission. Also another device called Monitor net is present in the system: the monitor is equipped with main board, a Net card and Wi-Fi card, with an operating system, that connects to the main box actively, sending any requests to view content, ensuring the security of shared data with a hardware/software password system, The quality of the video display is guaranteed by the hardware and software performance, (as Boosting and MPEG decoder).

The system is therefore particularly optimized for playback of video streams via network and DVDs and allows you to enjoy a video far better than the one of a normal DVD player, even high-end, at the same time providing the features a TV, Personal Computer, reader, radio etc.; with the visualization automatically adaptable to small sizes.

The Four Basic and Independent Physical Structures

Multifunction Telecommunication Apparatus Lodged in a CRT, LCD or PLASMA TV, from Now on Called TvNet Media Home Center.

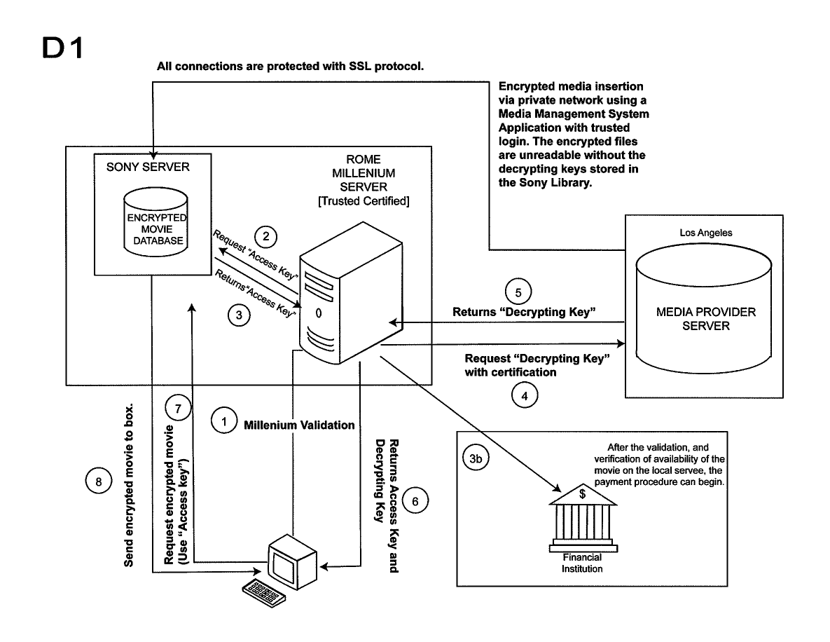

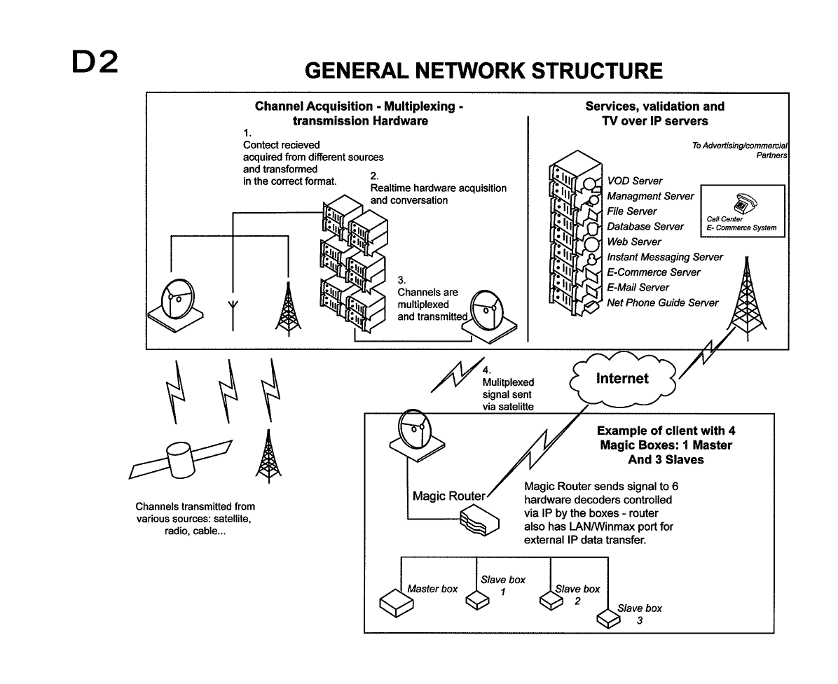

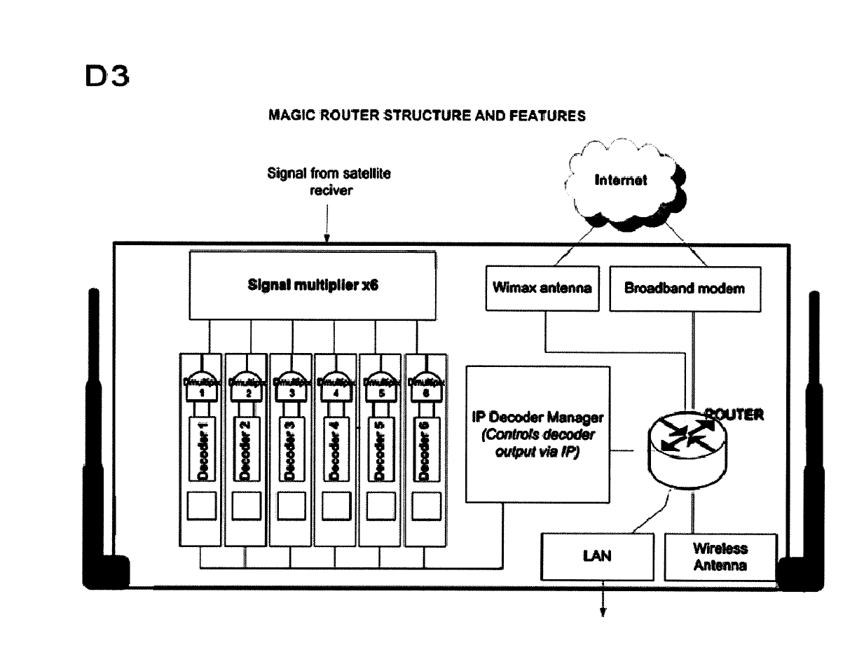

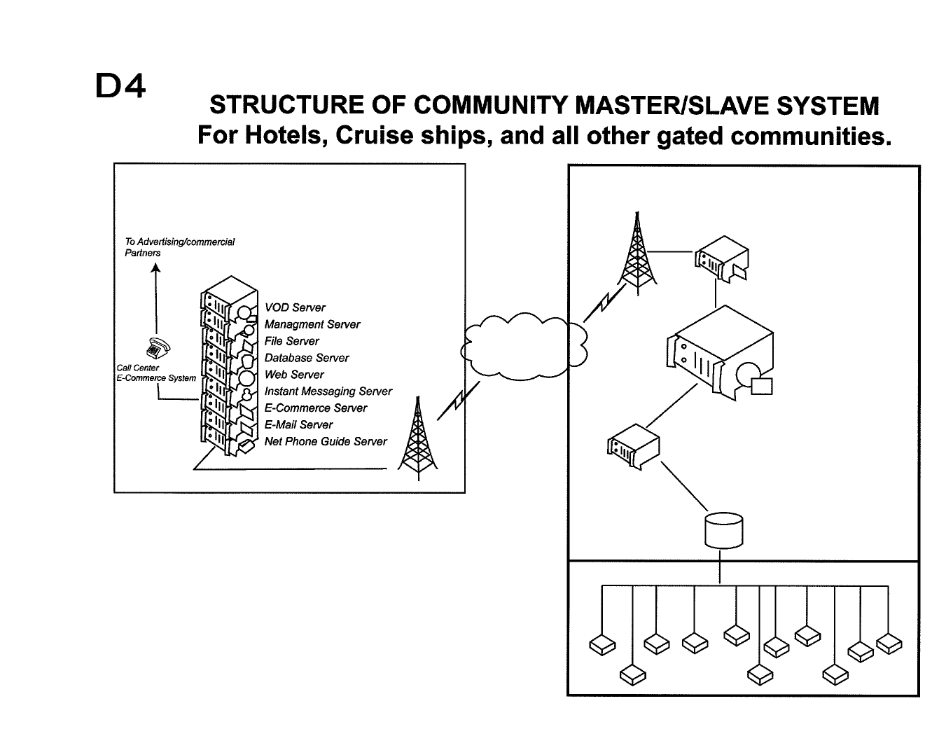

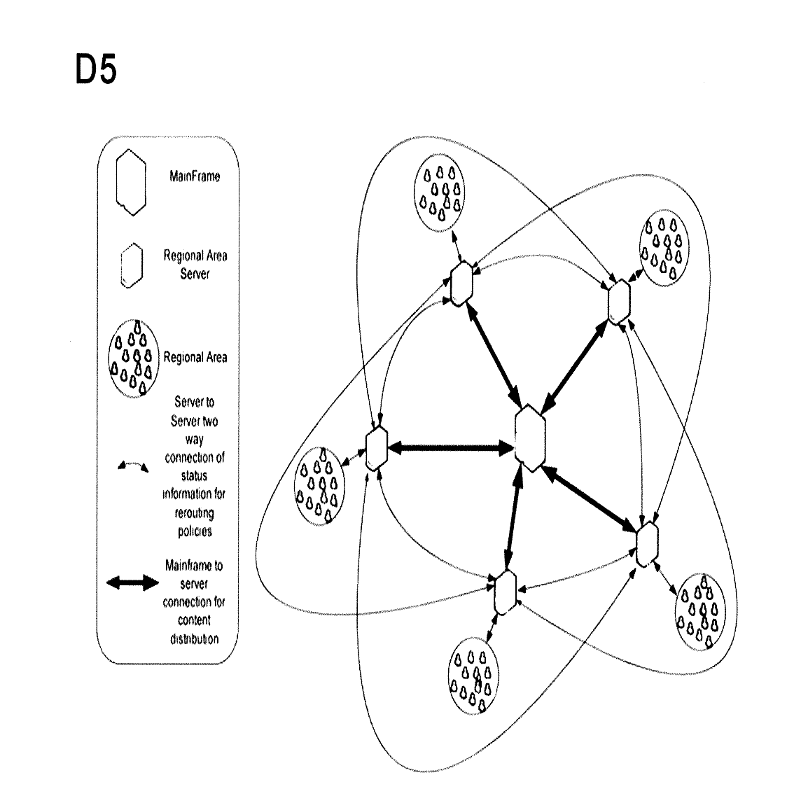

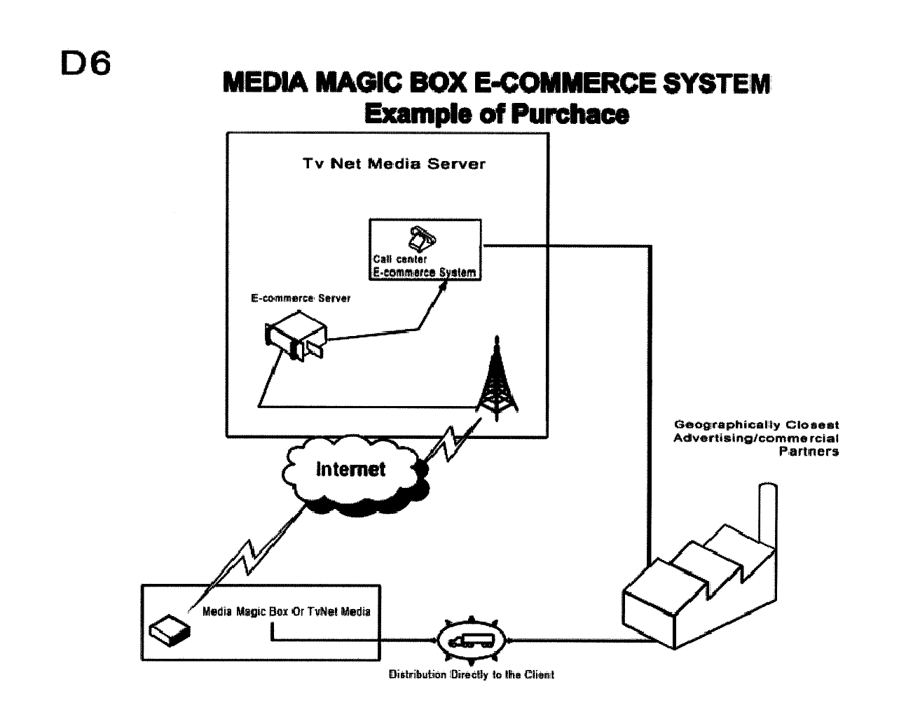

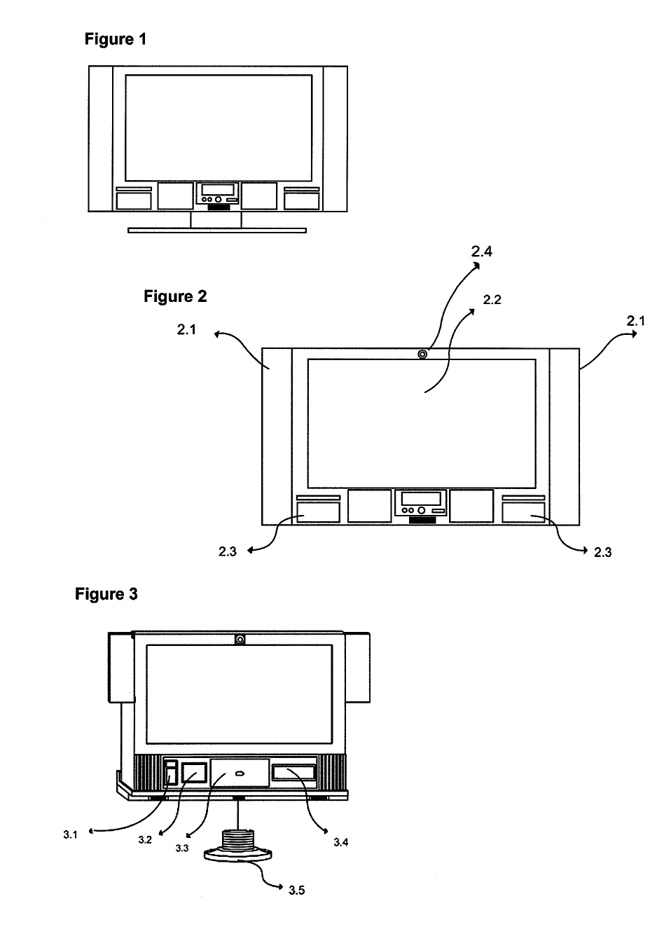

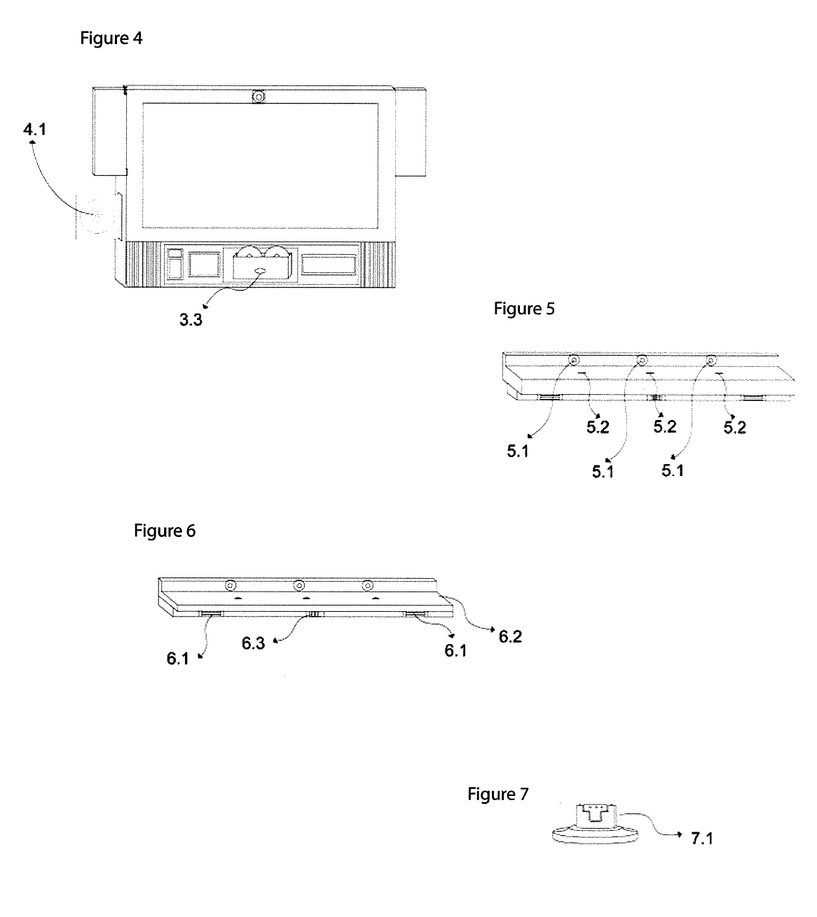

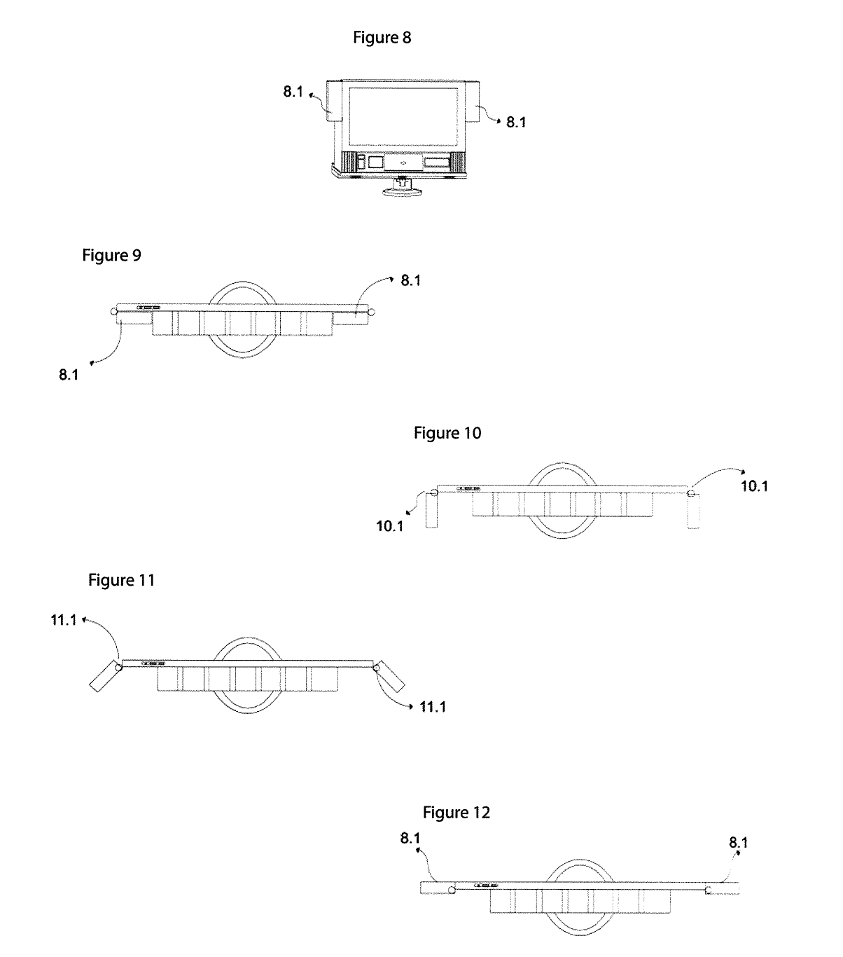

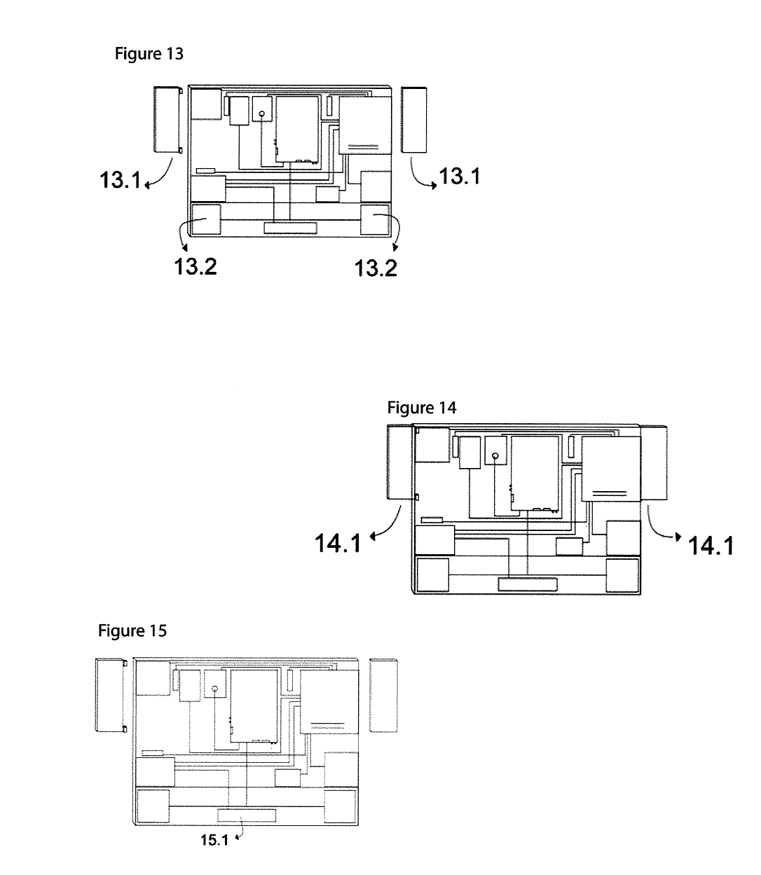

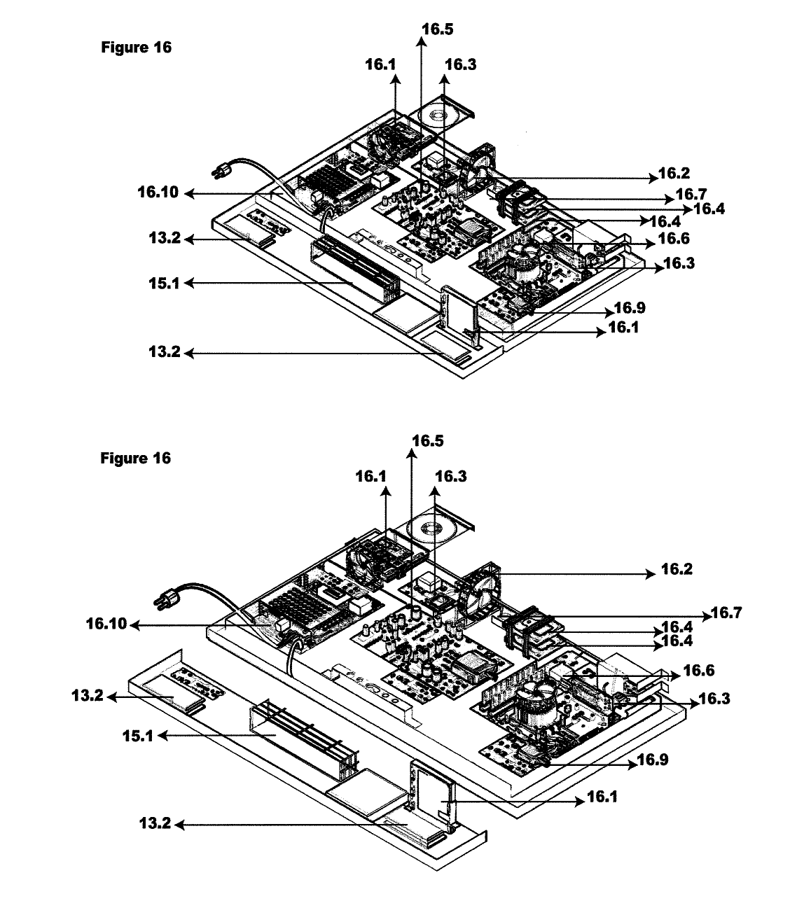

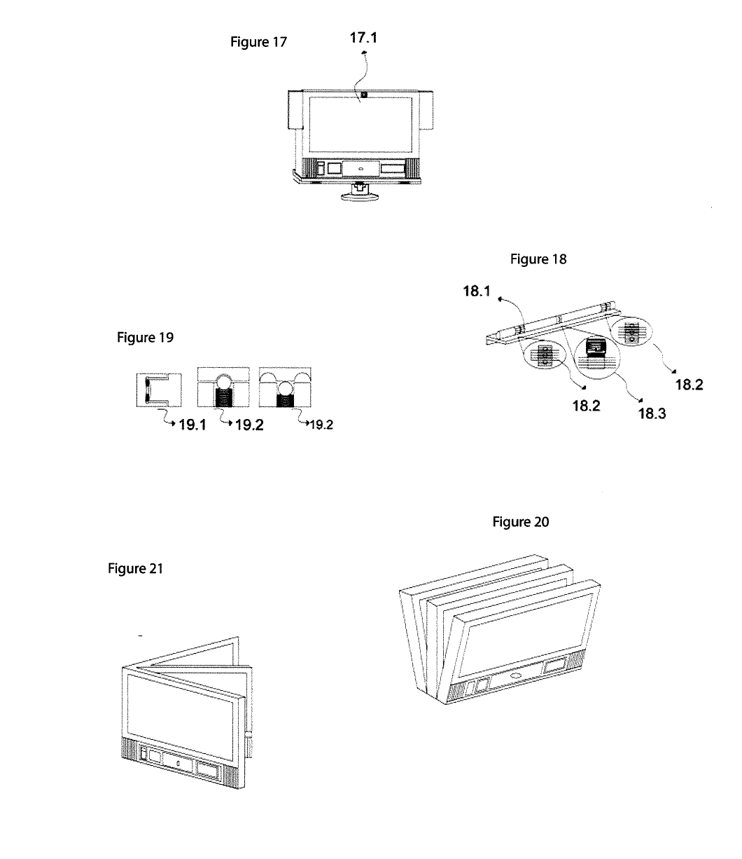

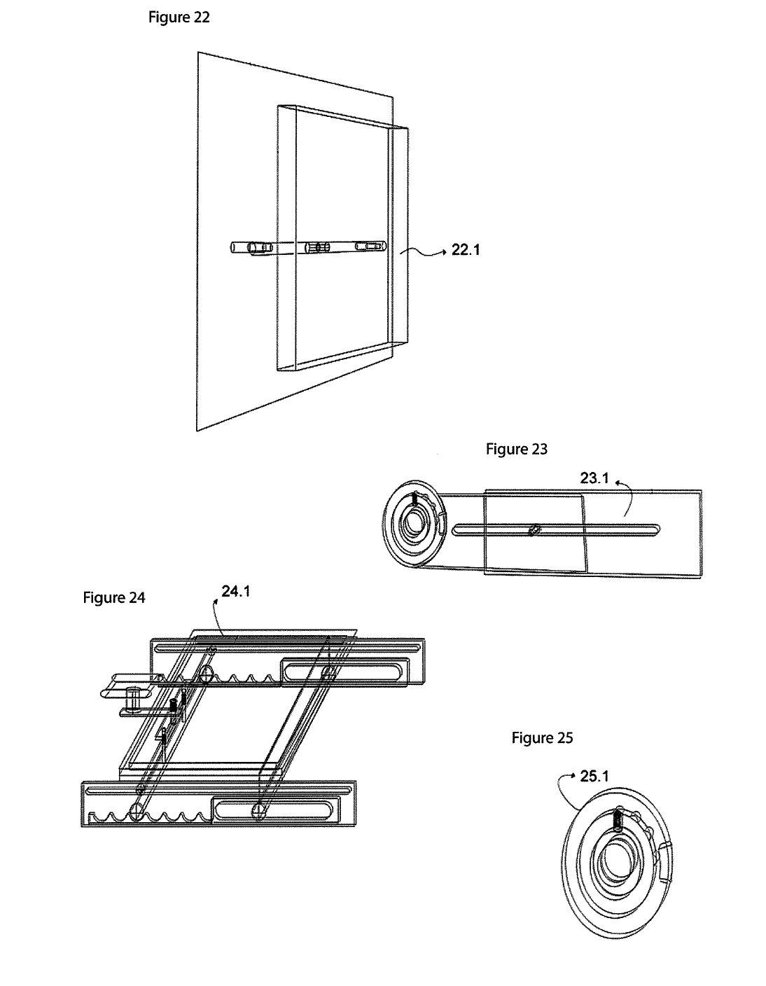

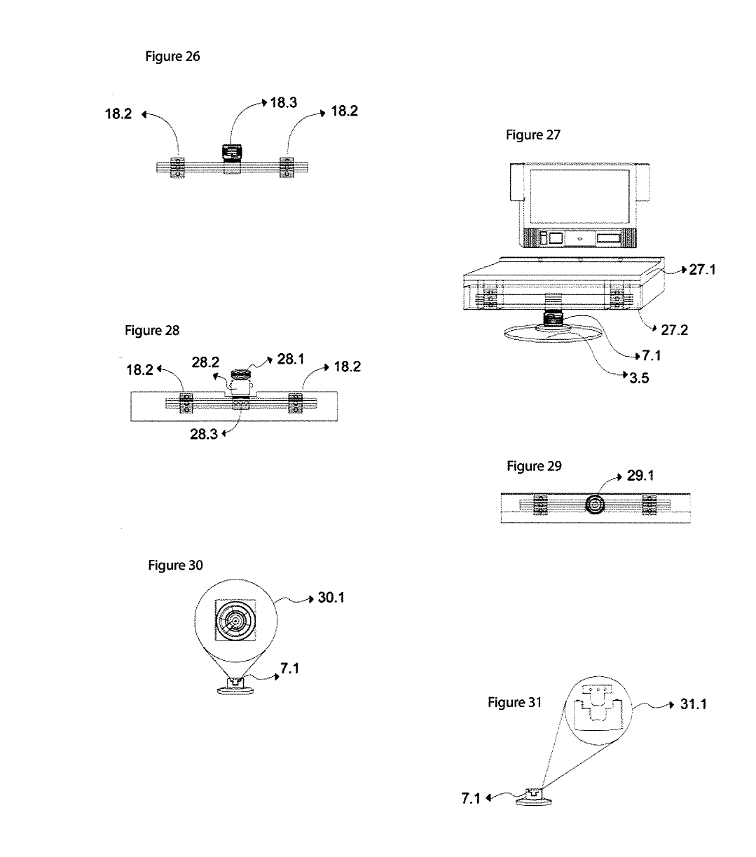

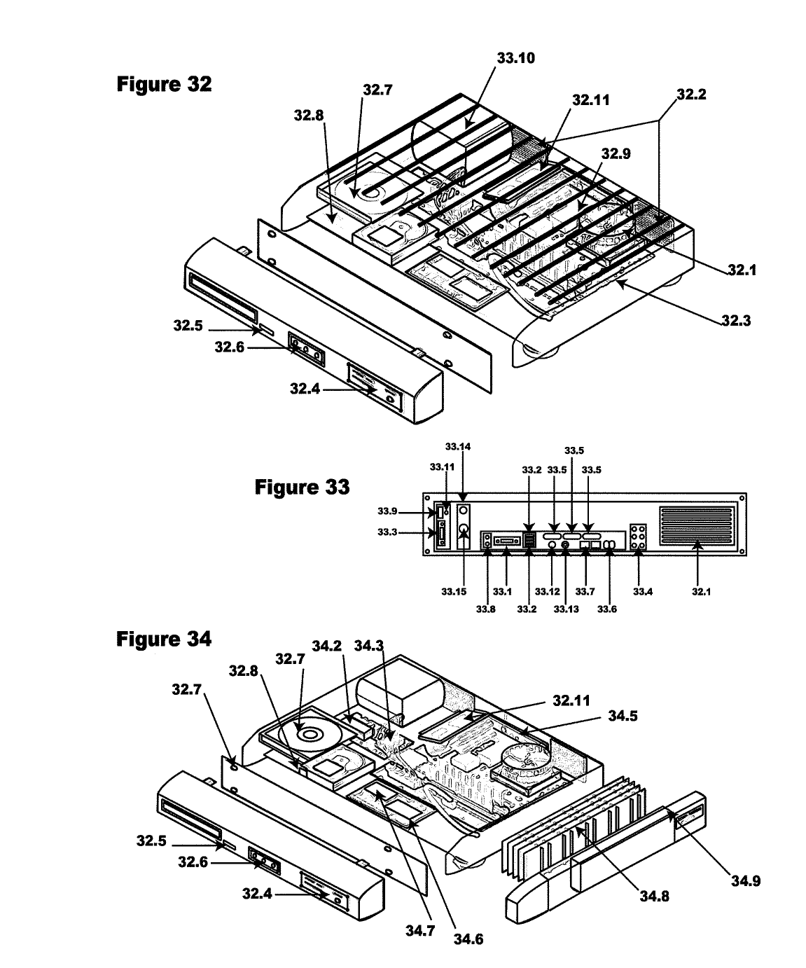

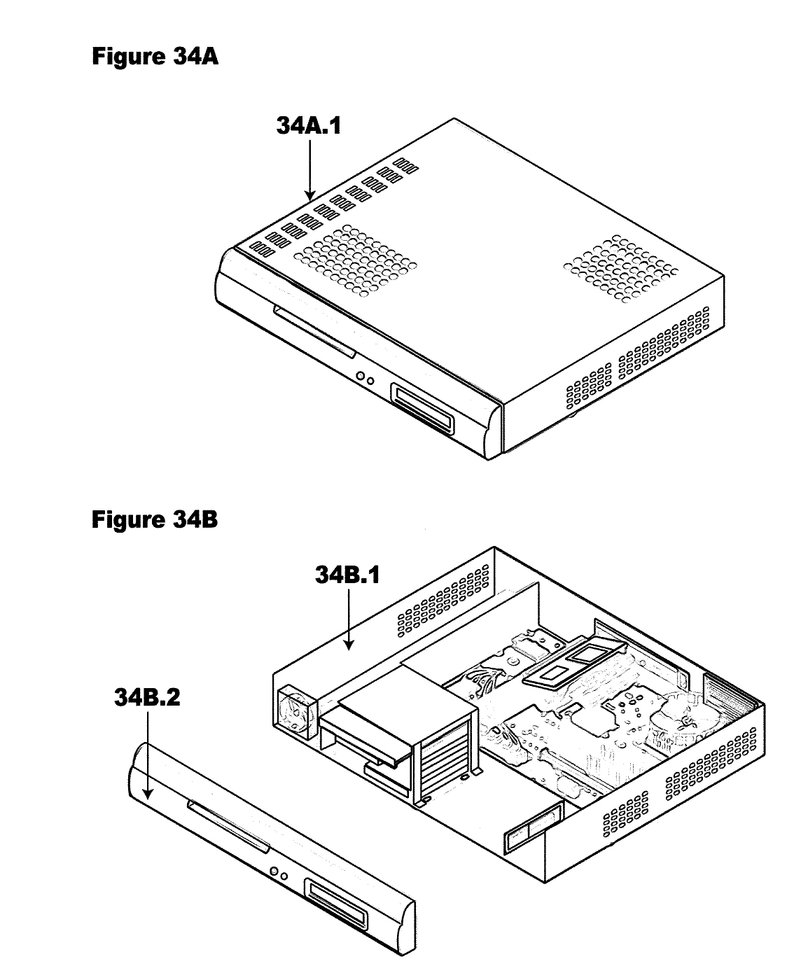

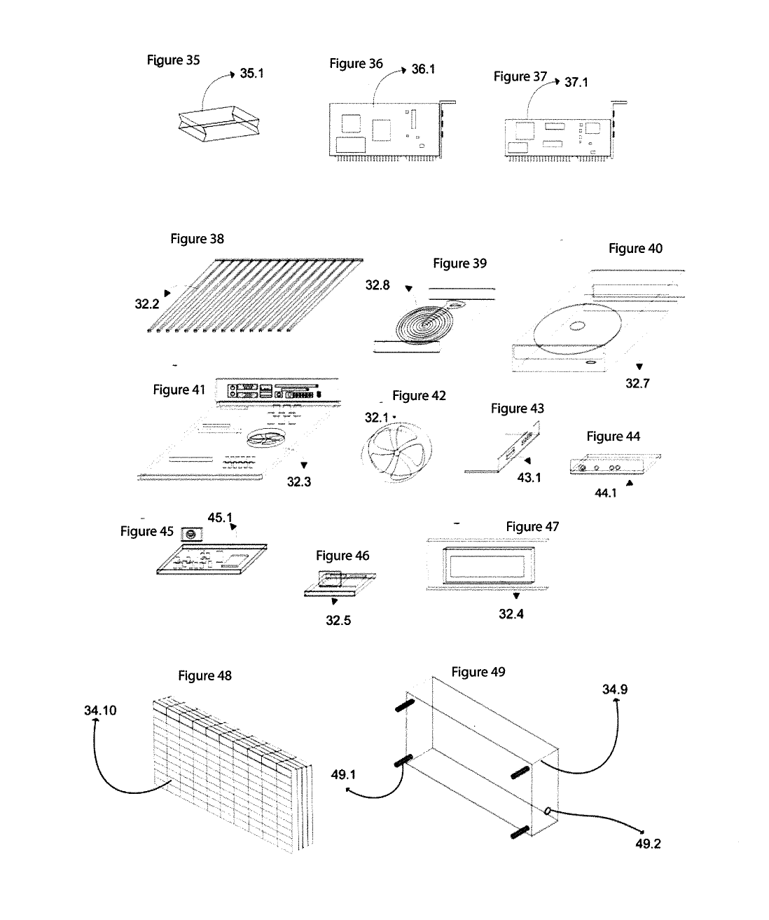

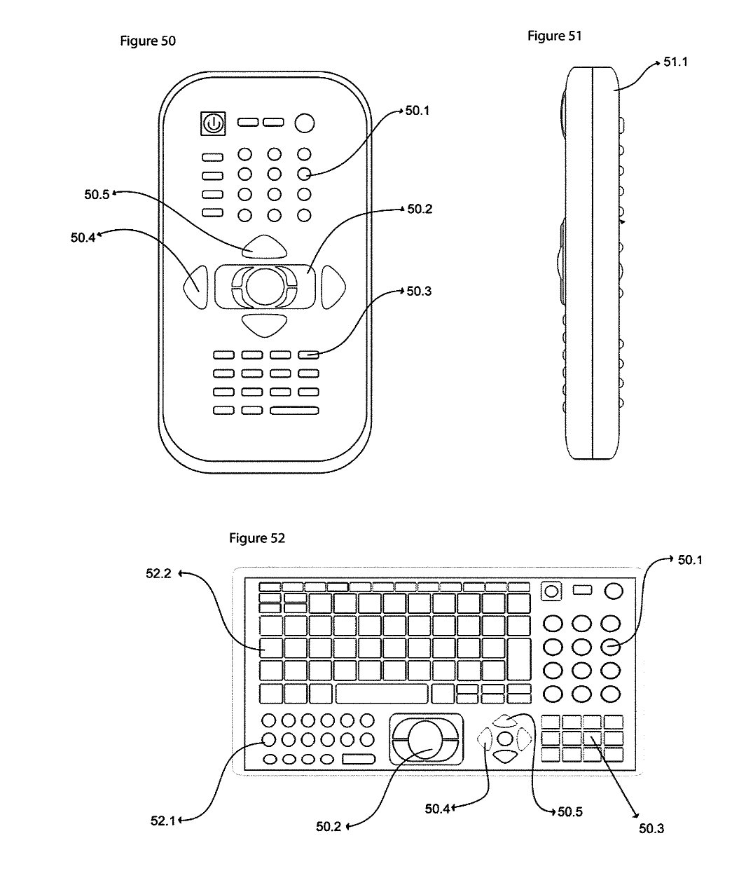

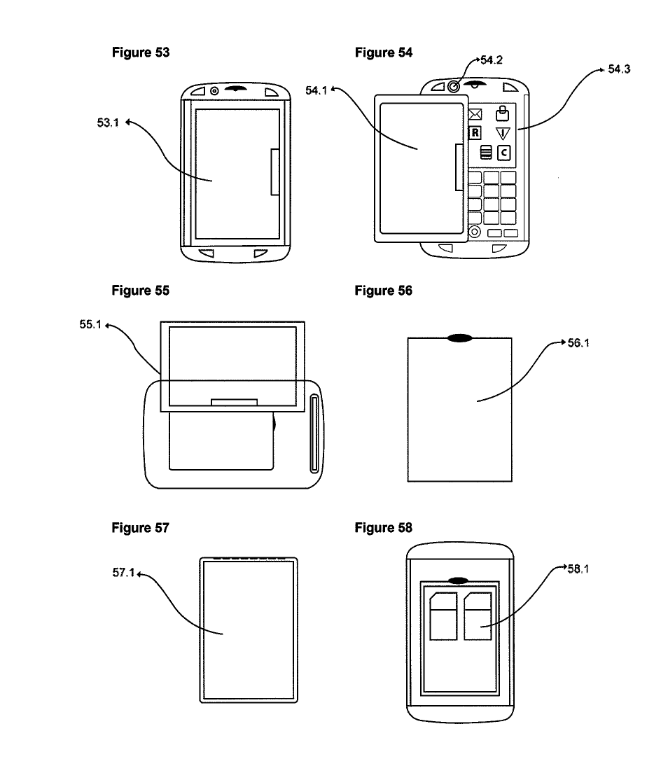

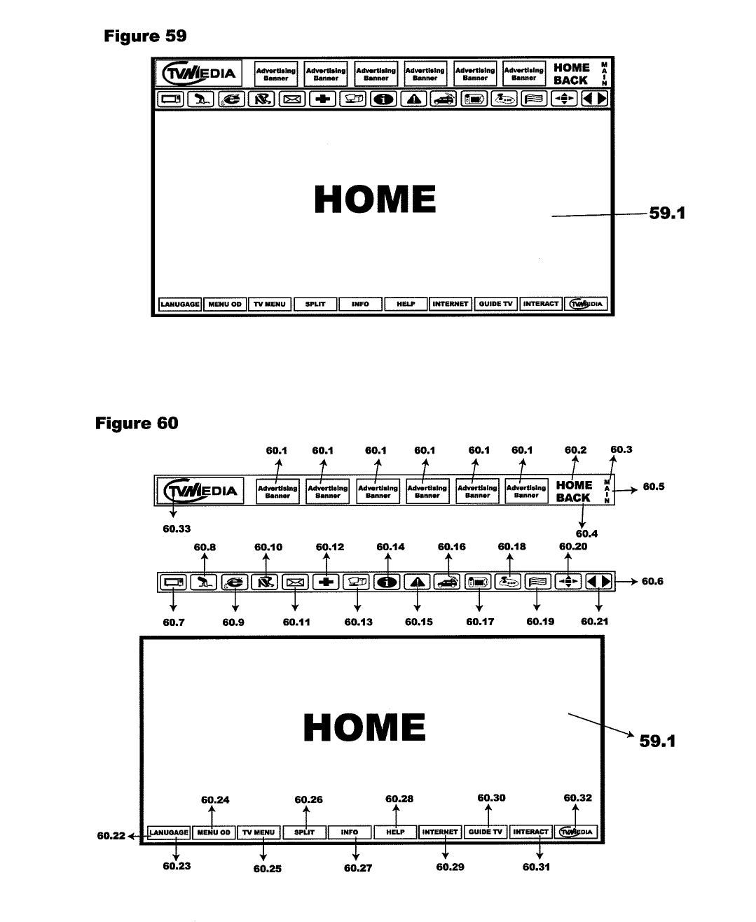

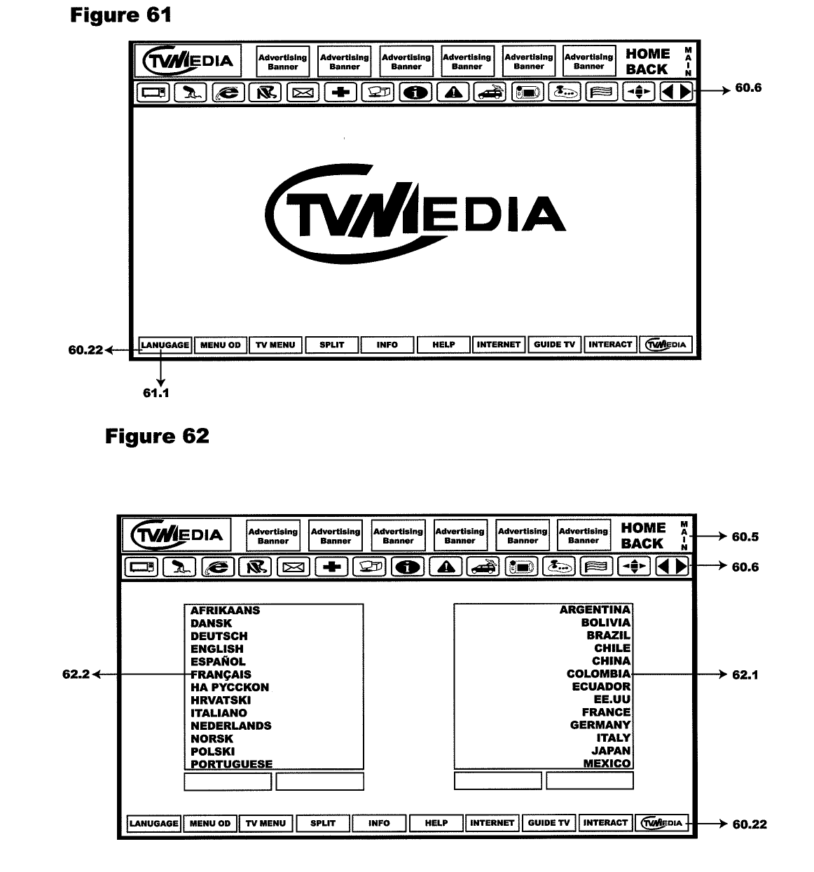

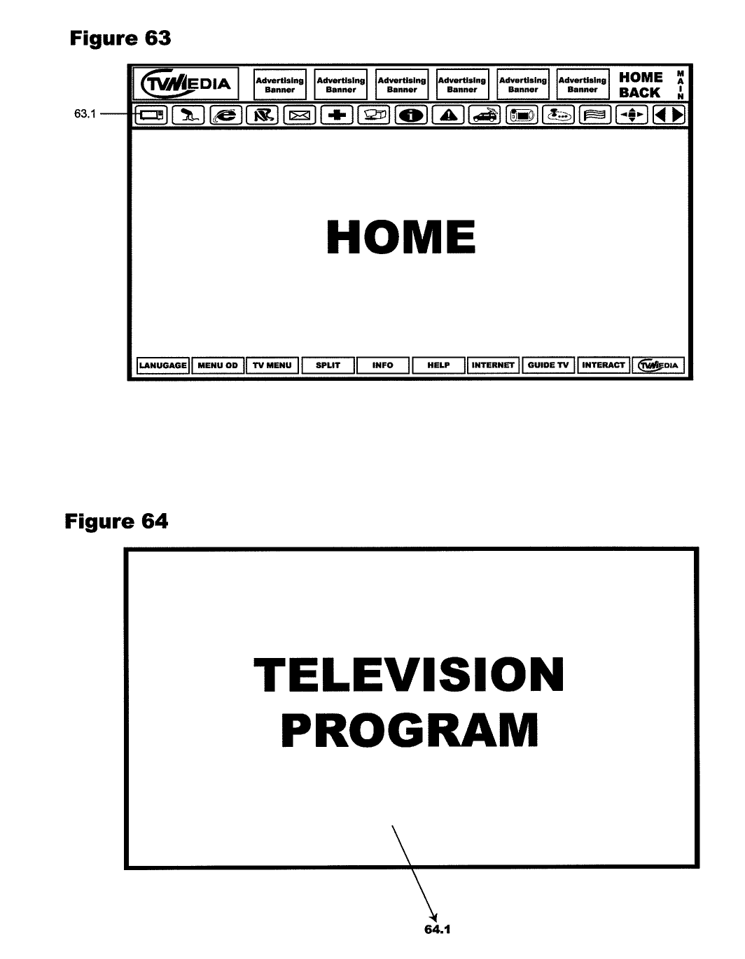

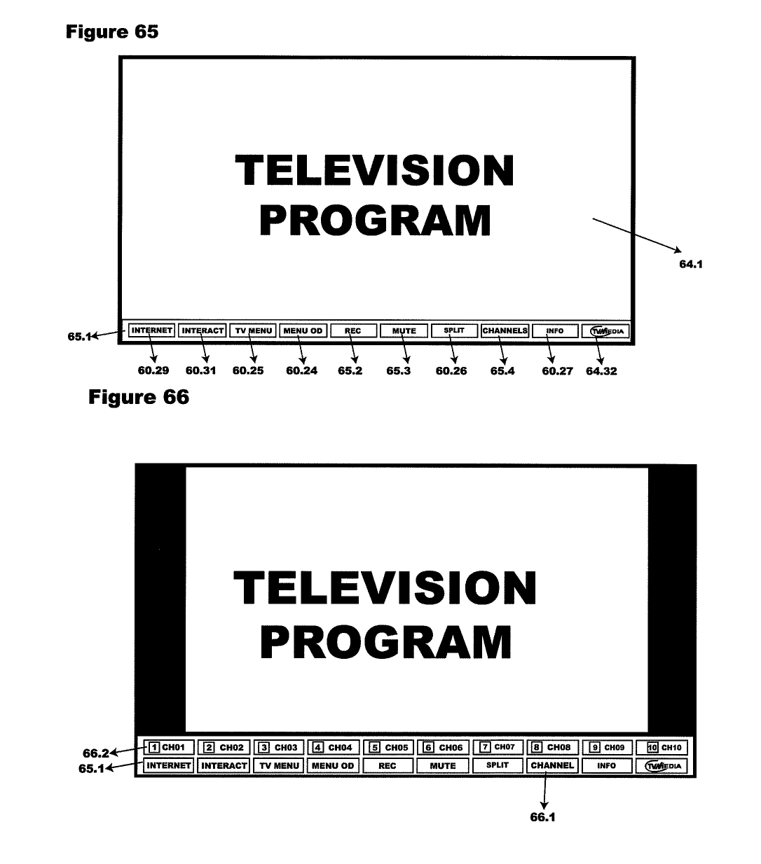

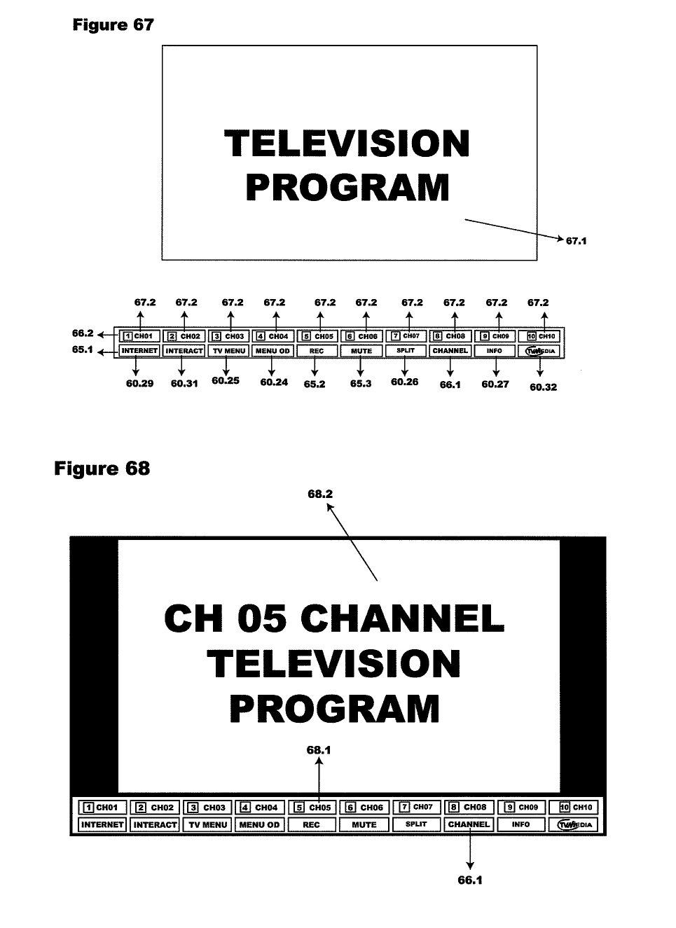

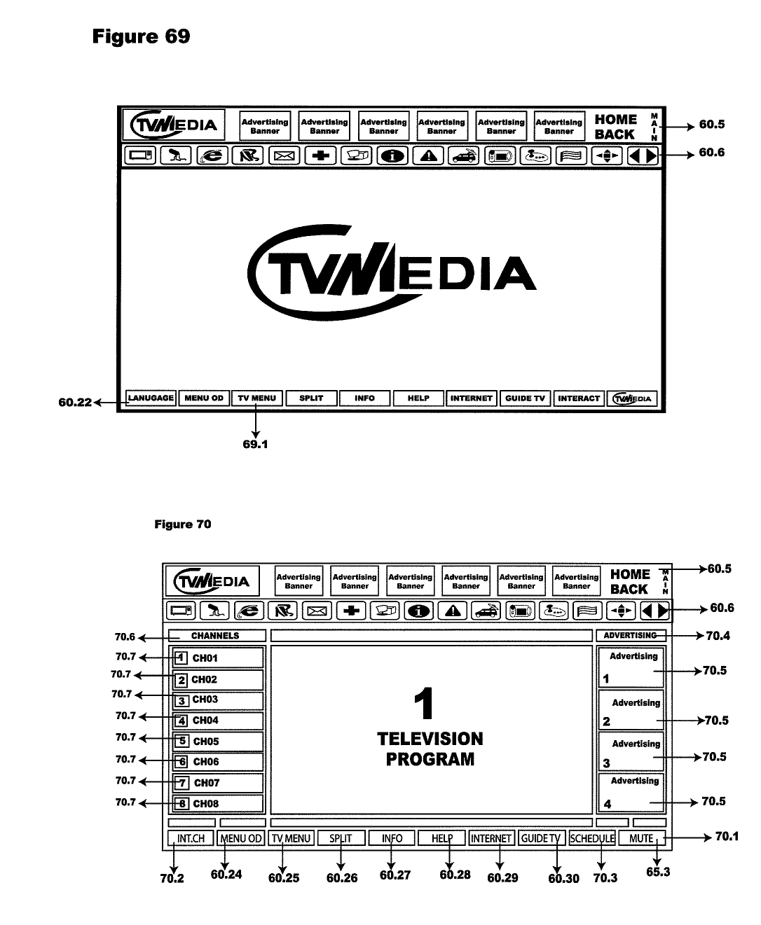

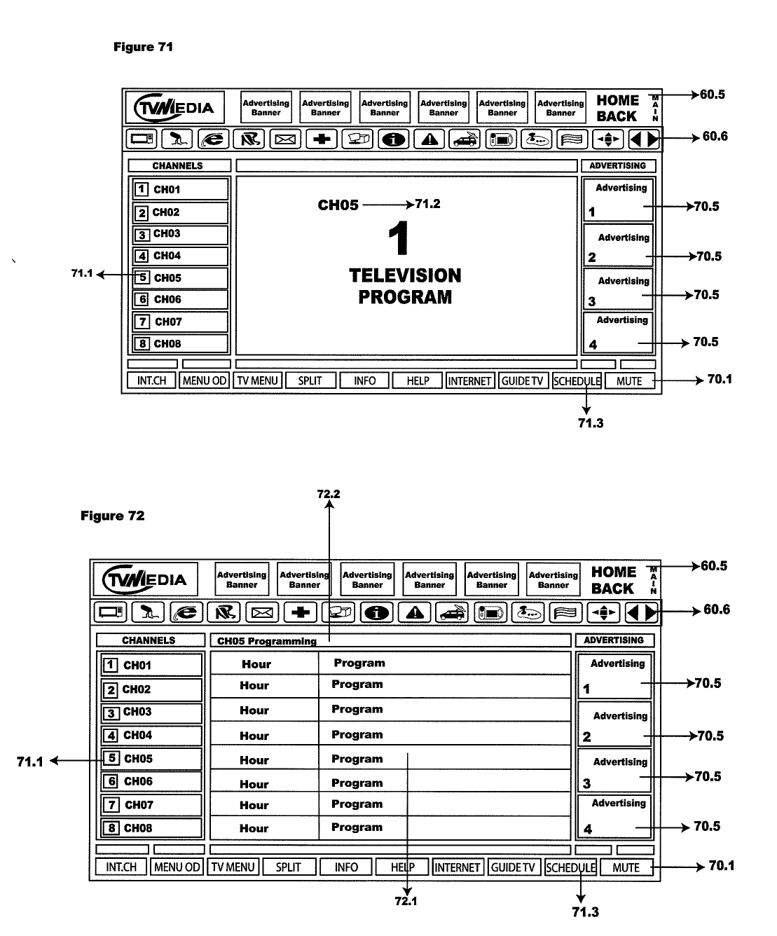

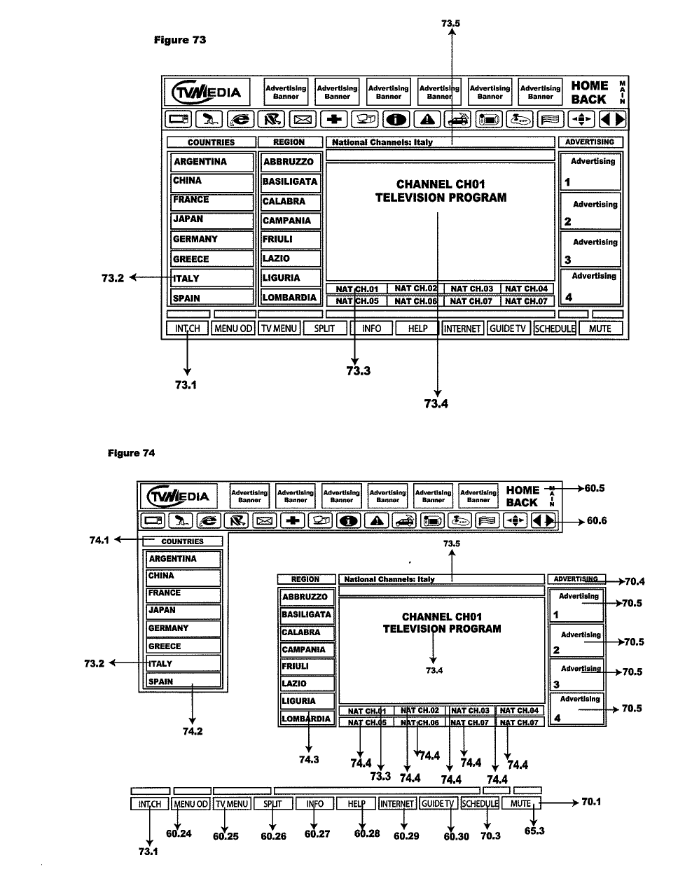

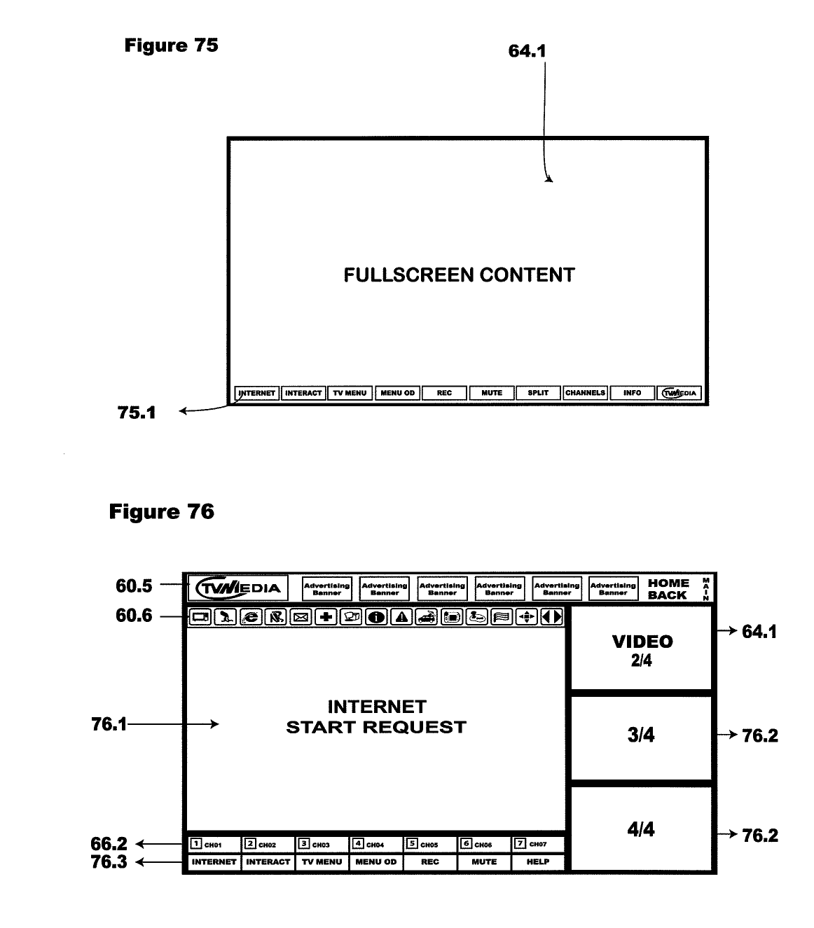

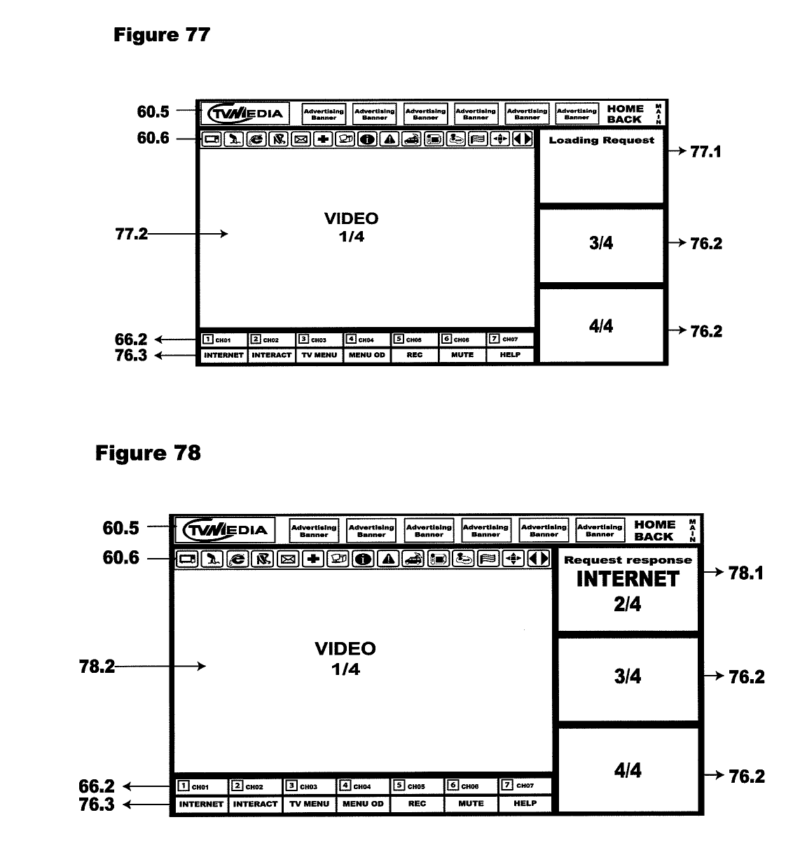

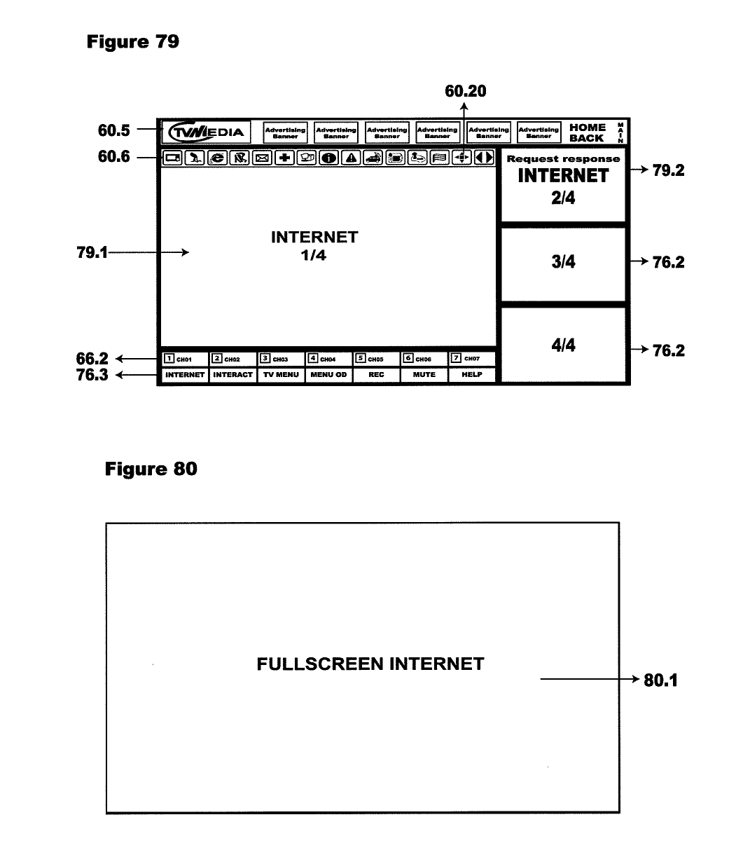

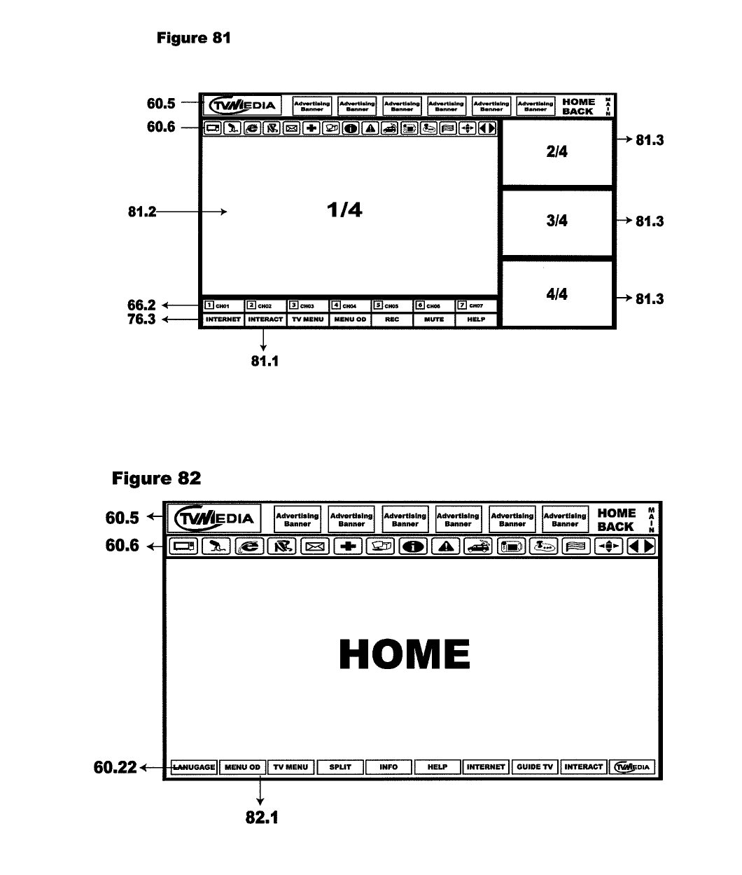

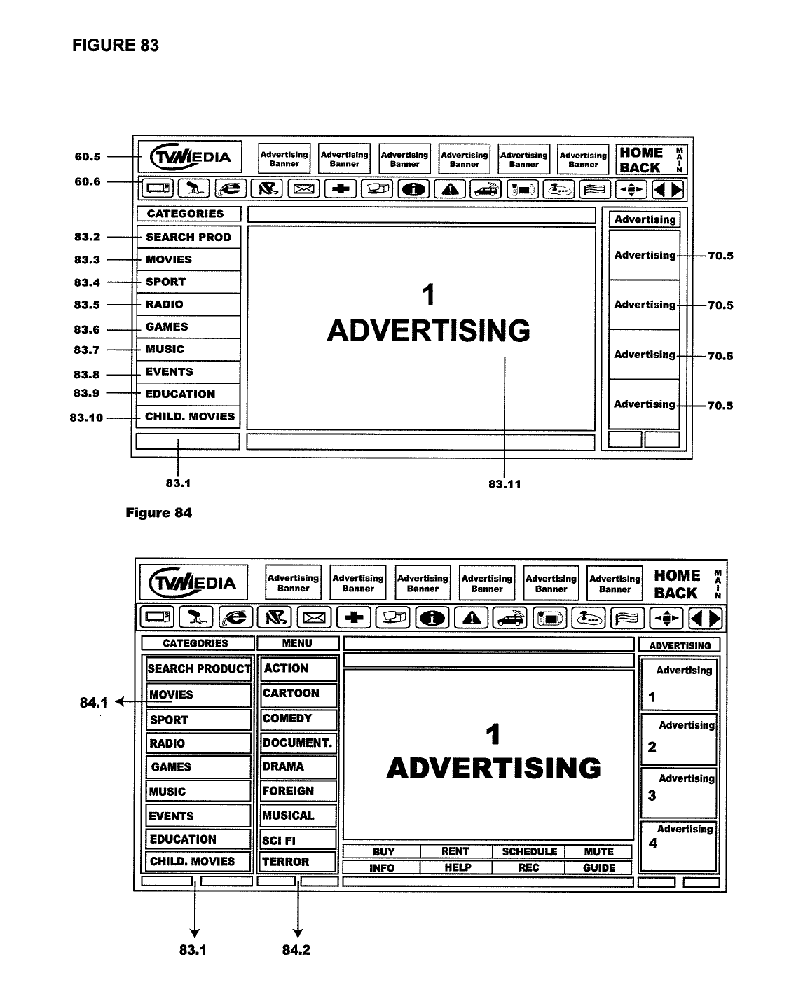

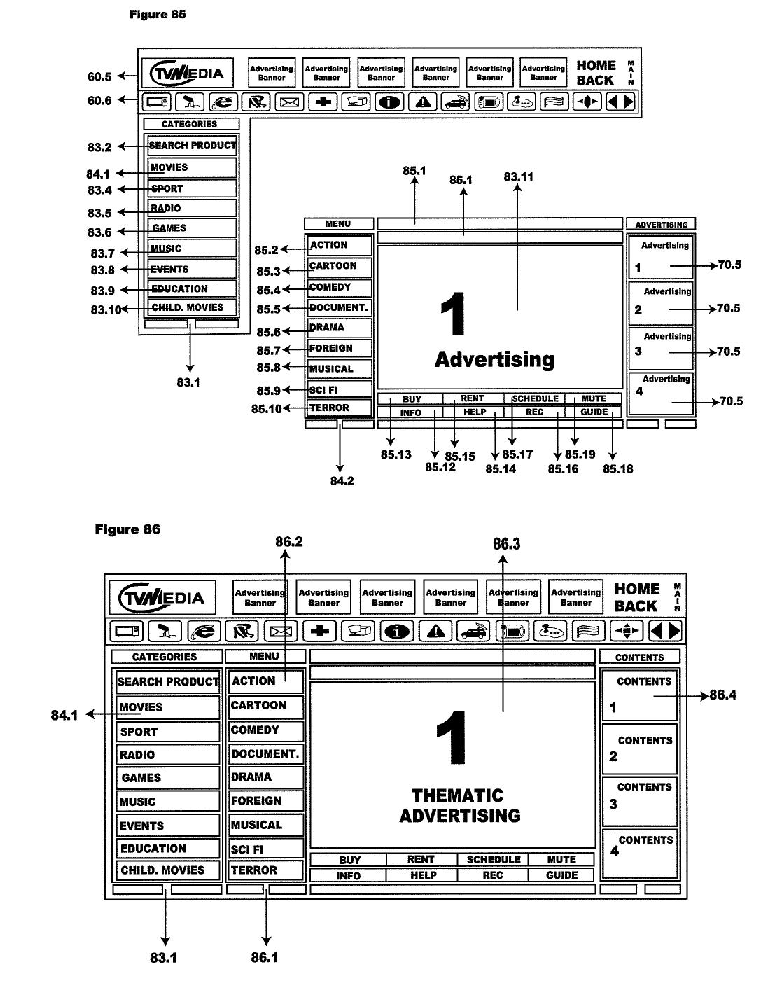

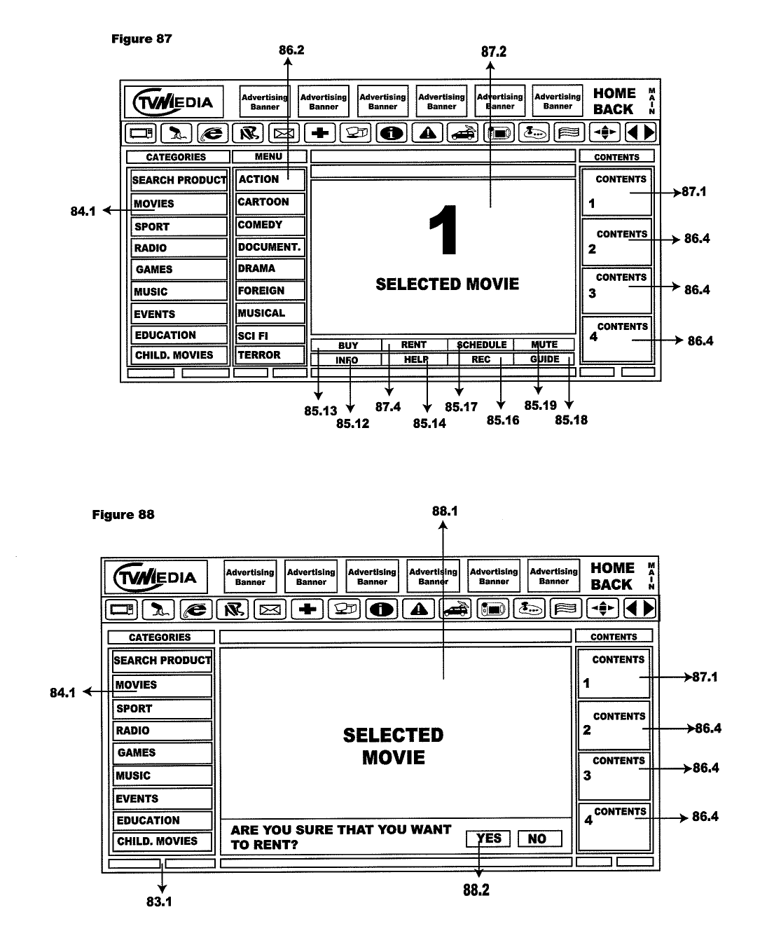

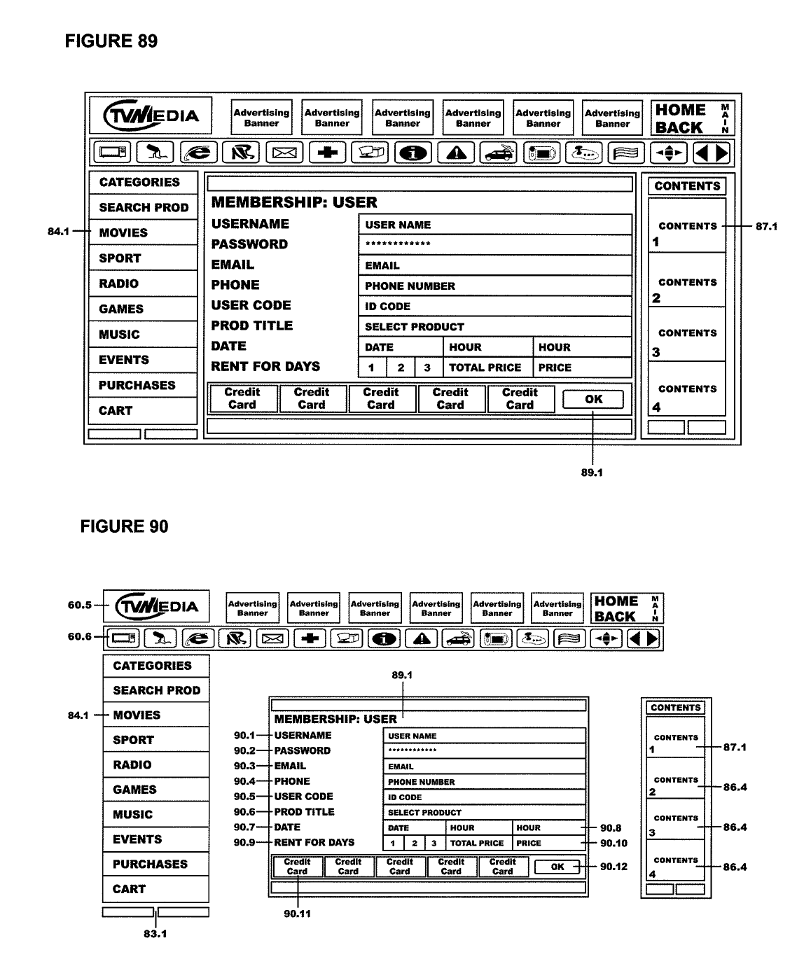

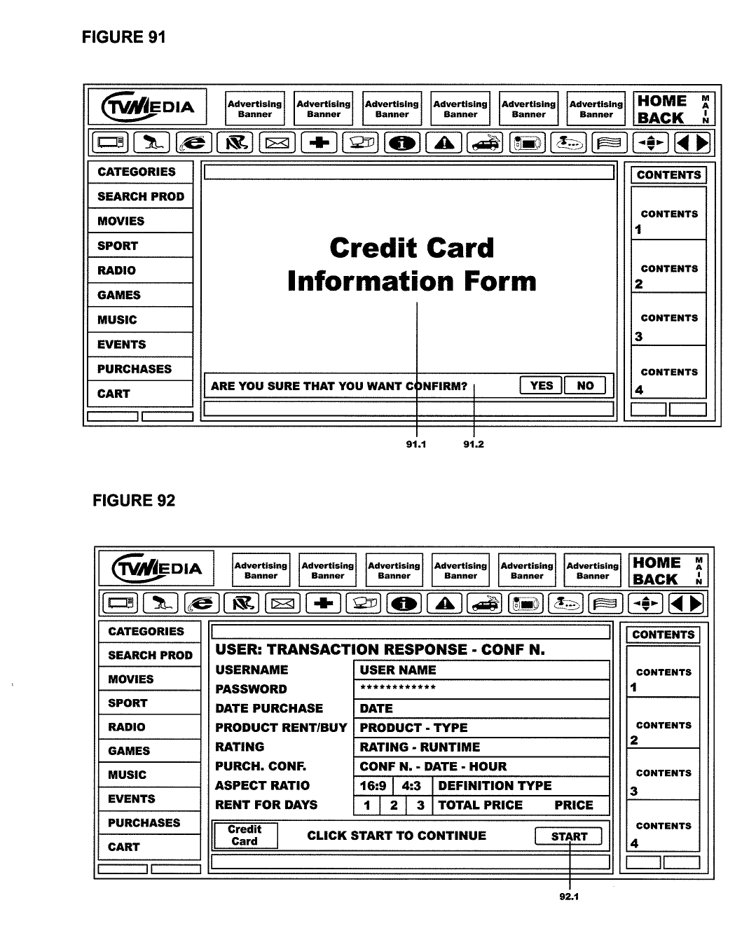

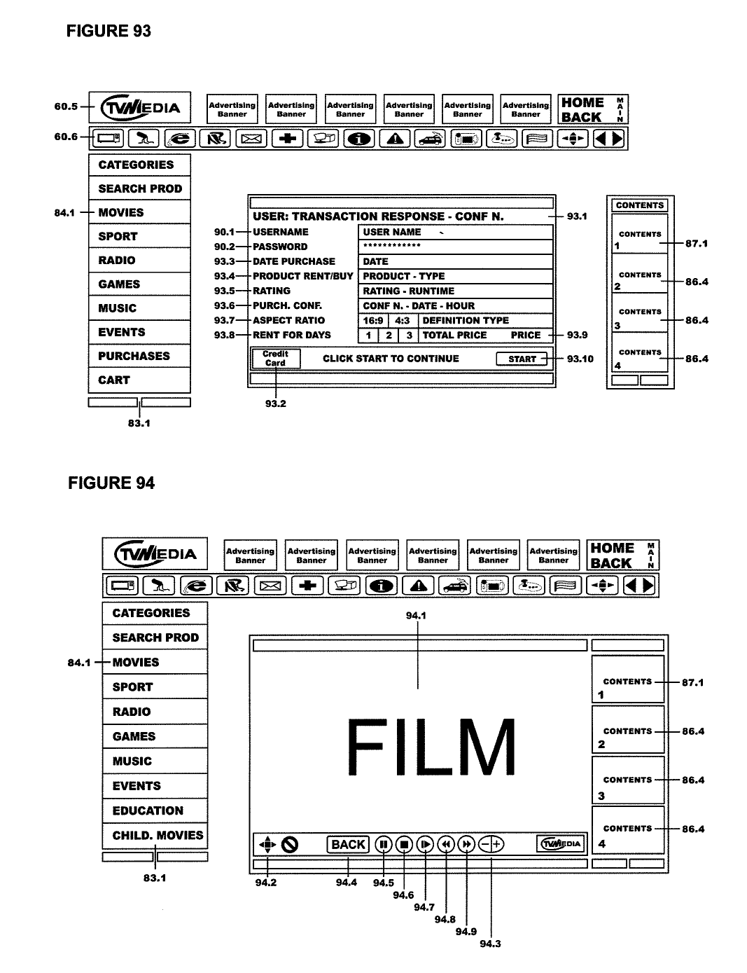

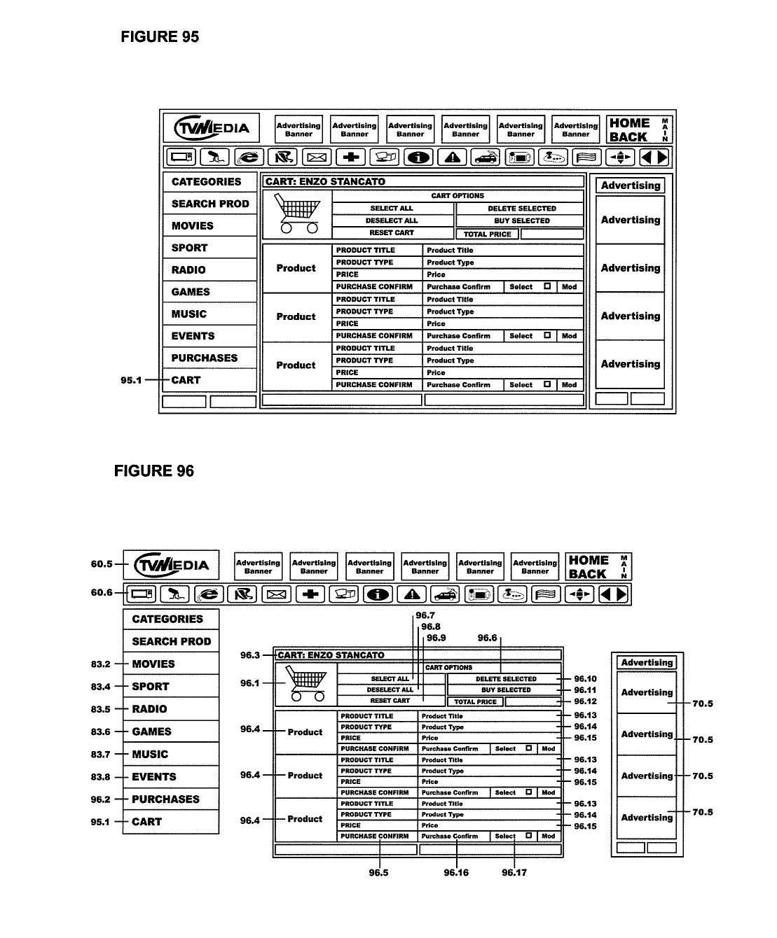

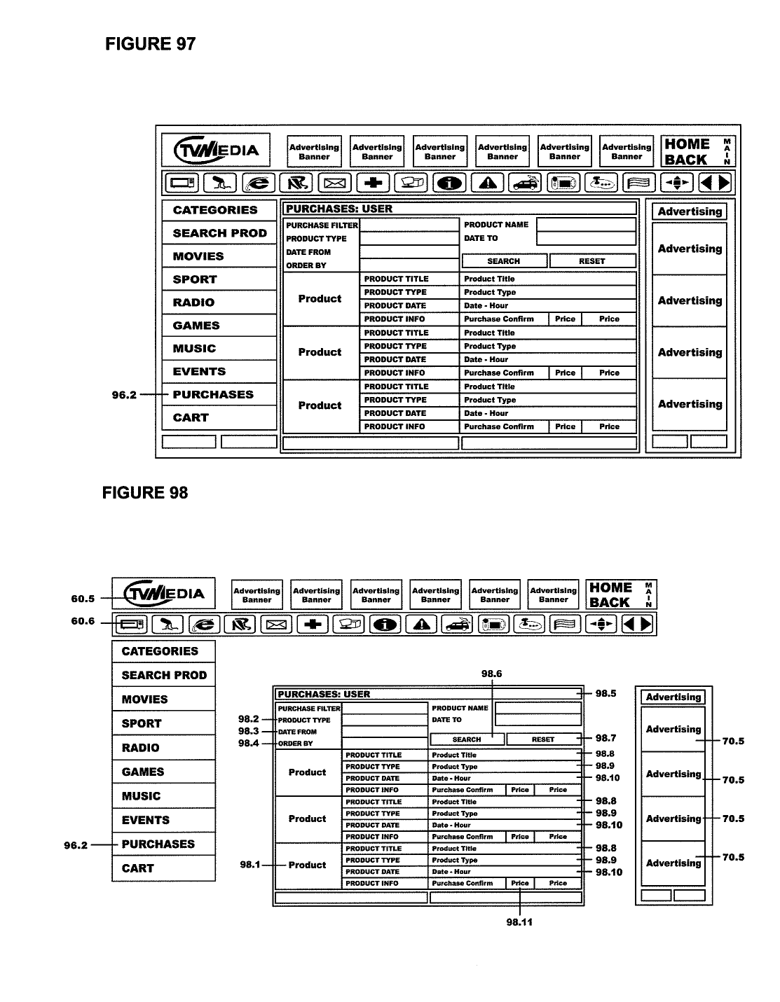

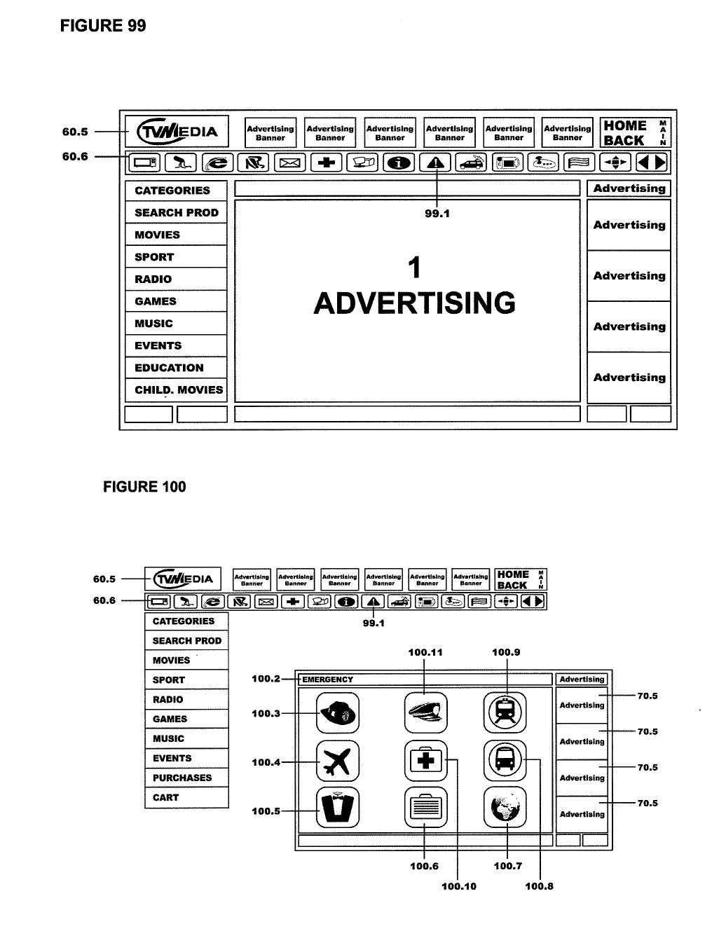

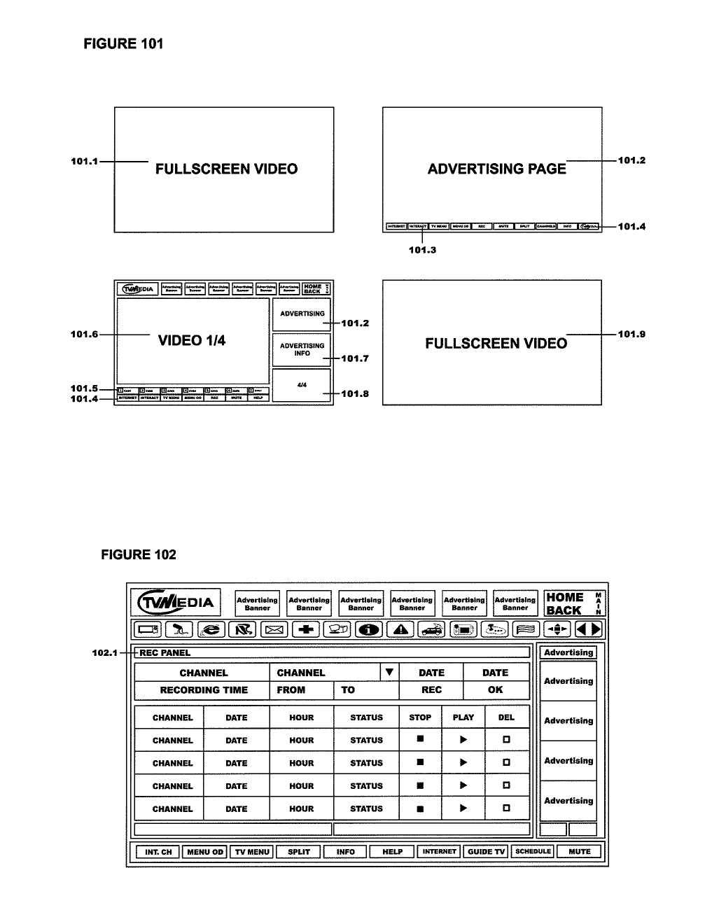

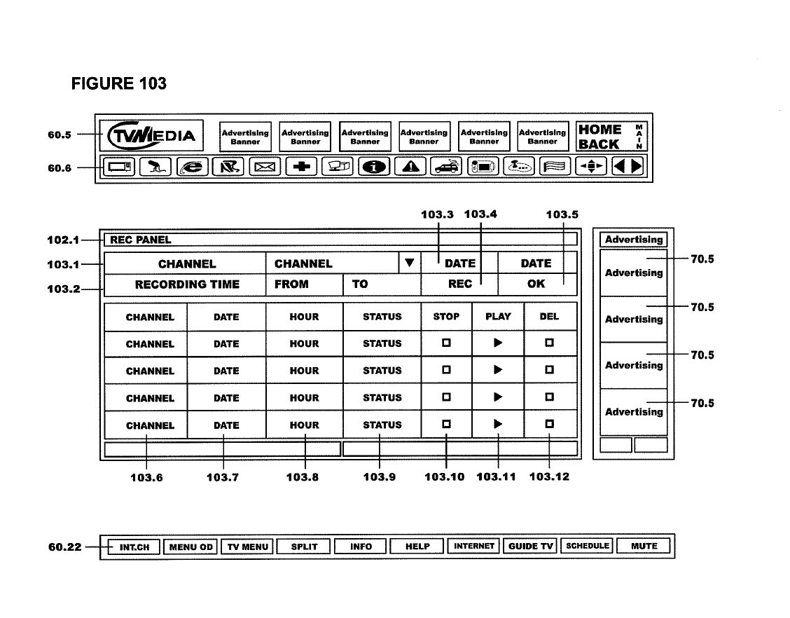

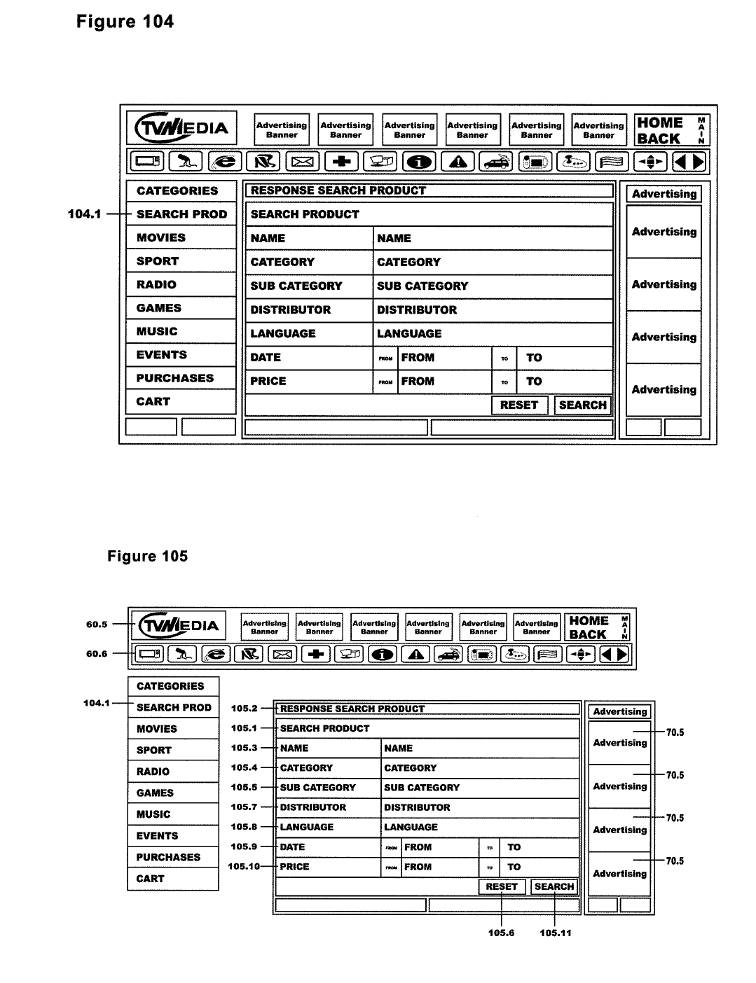

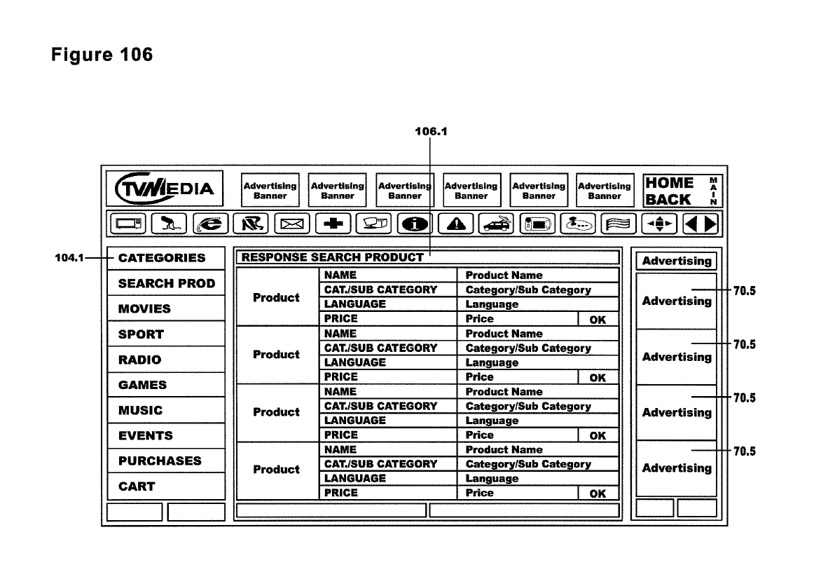

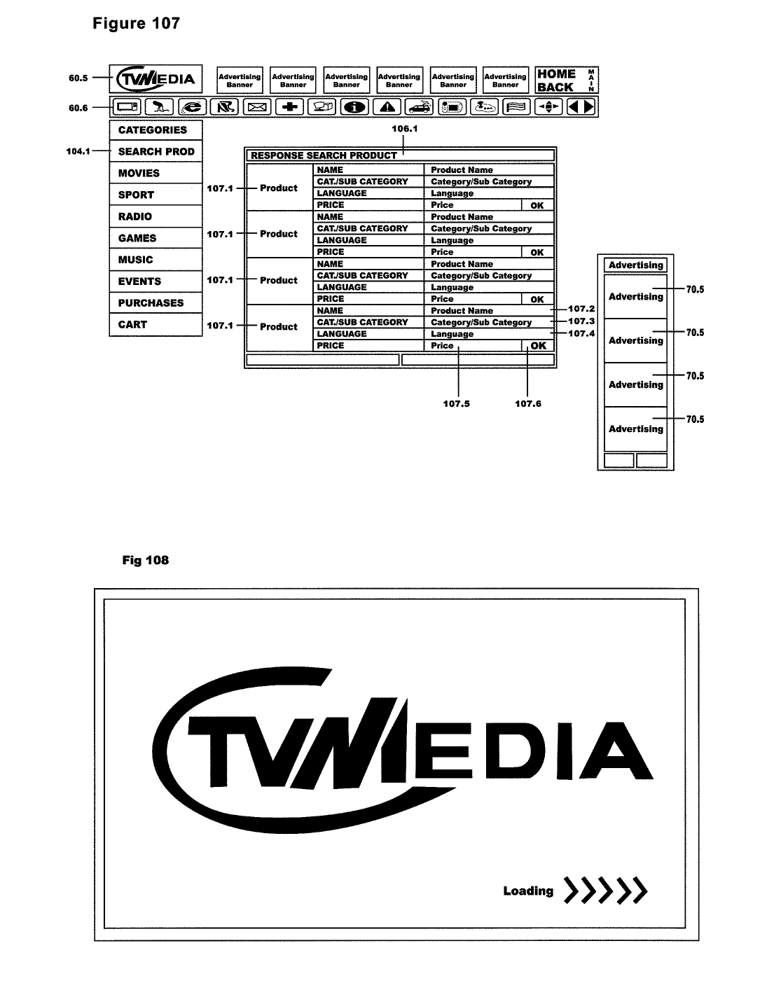

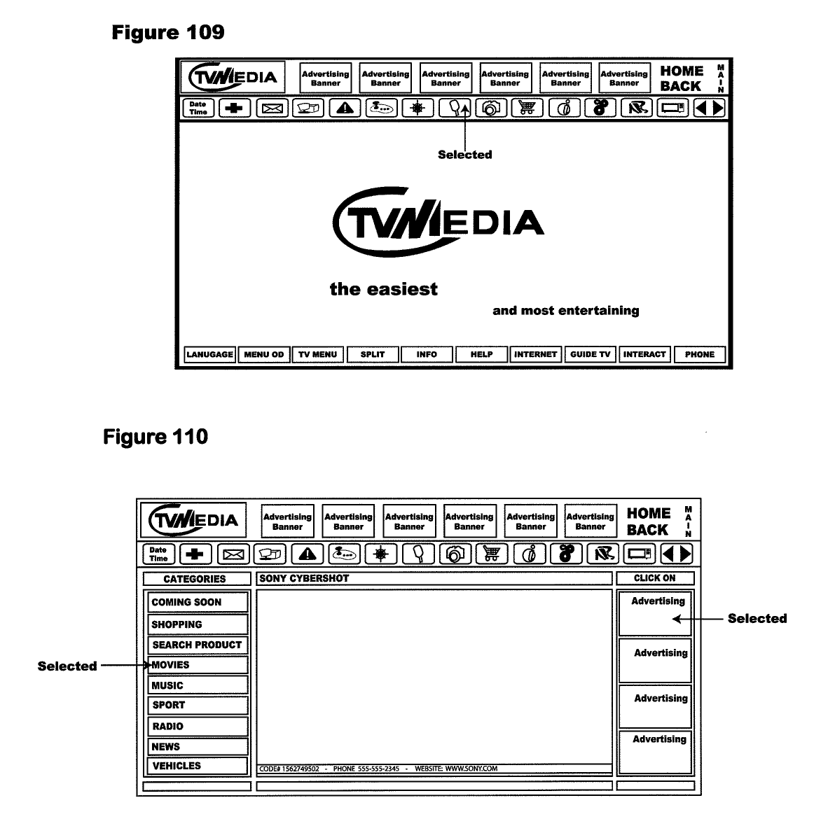

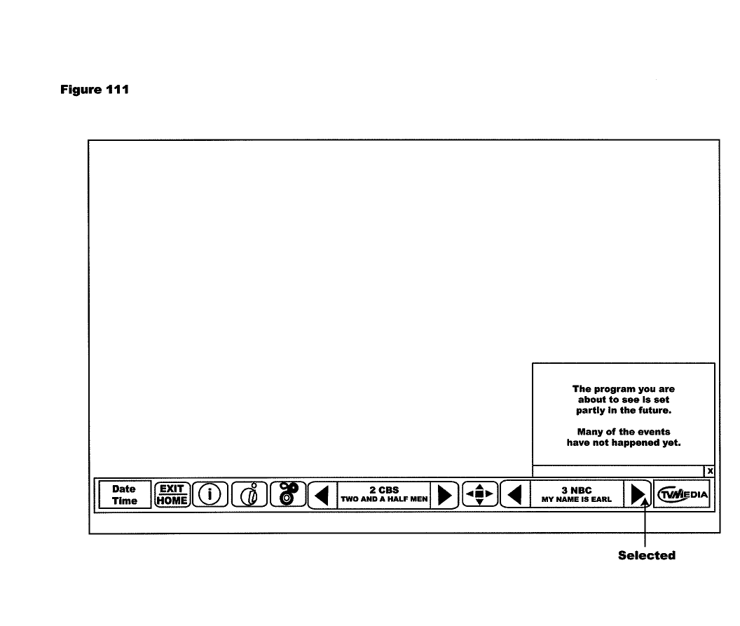

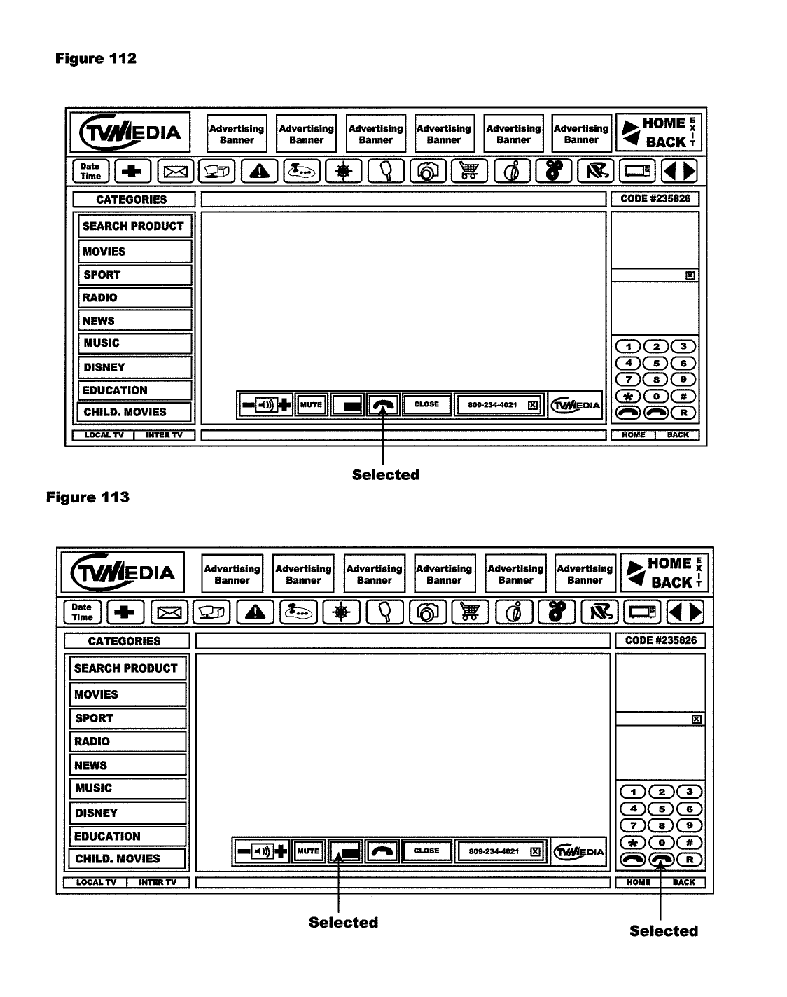

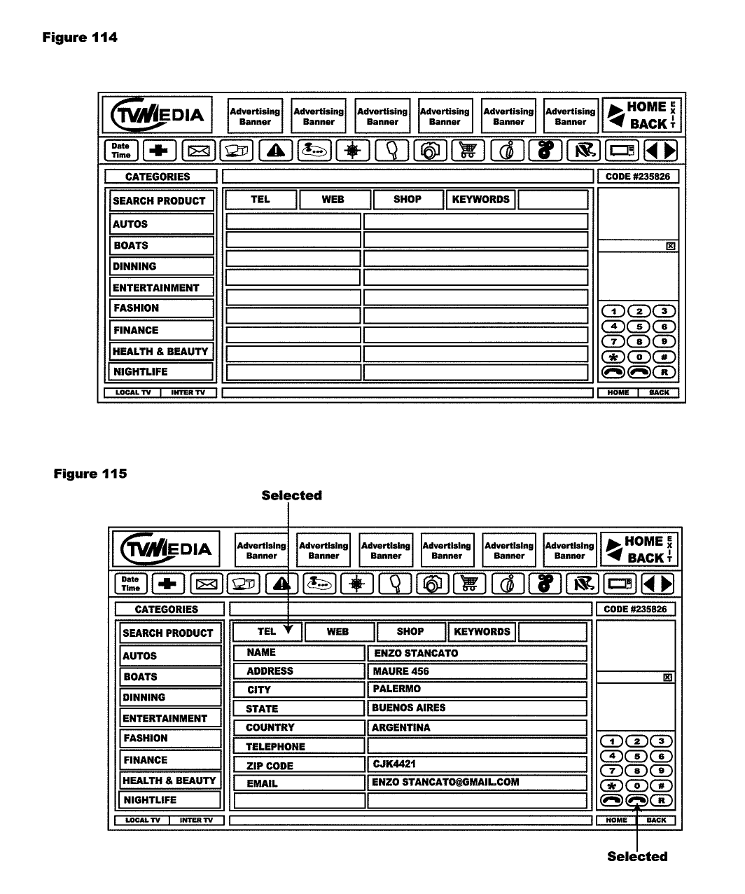

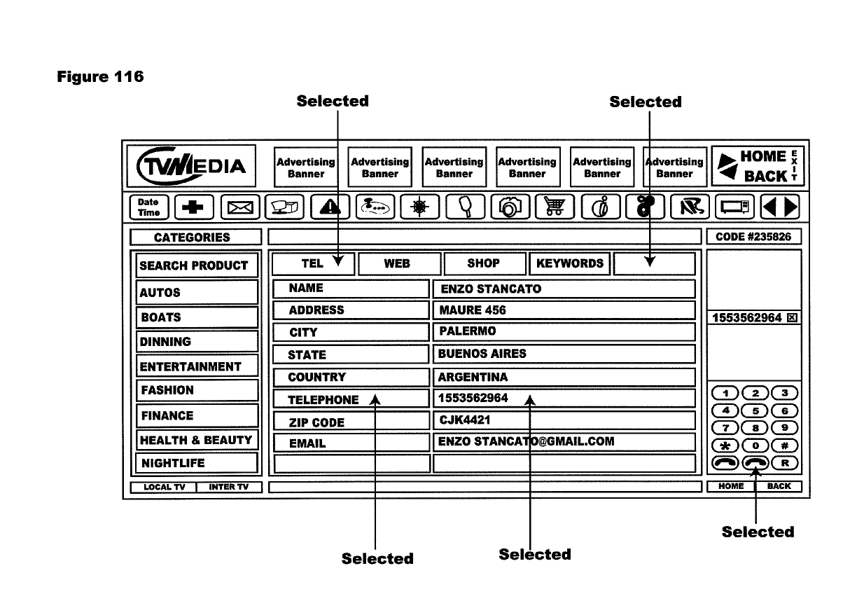

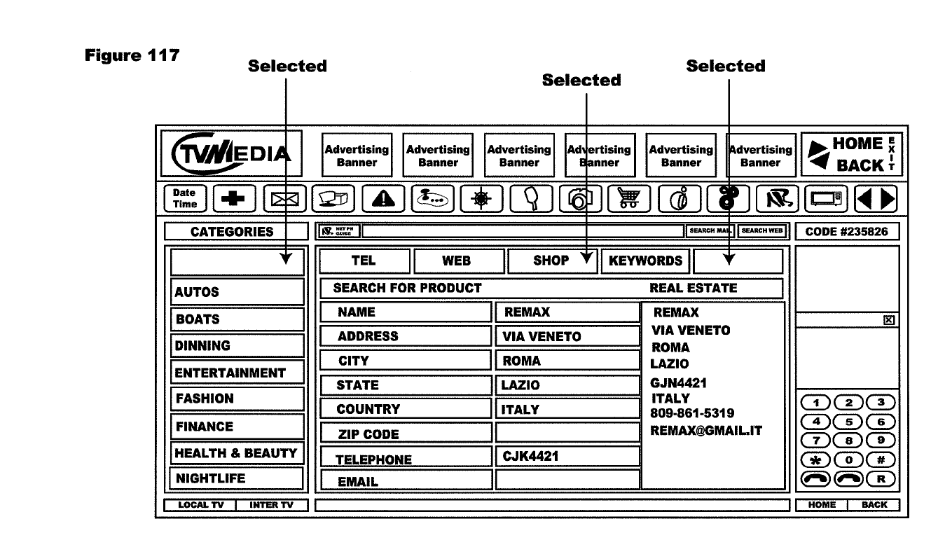

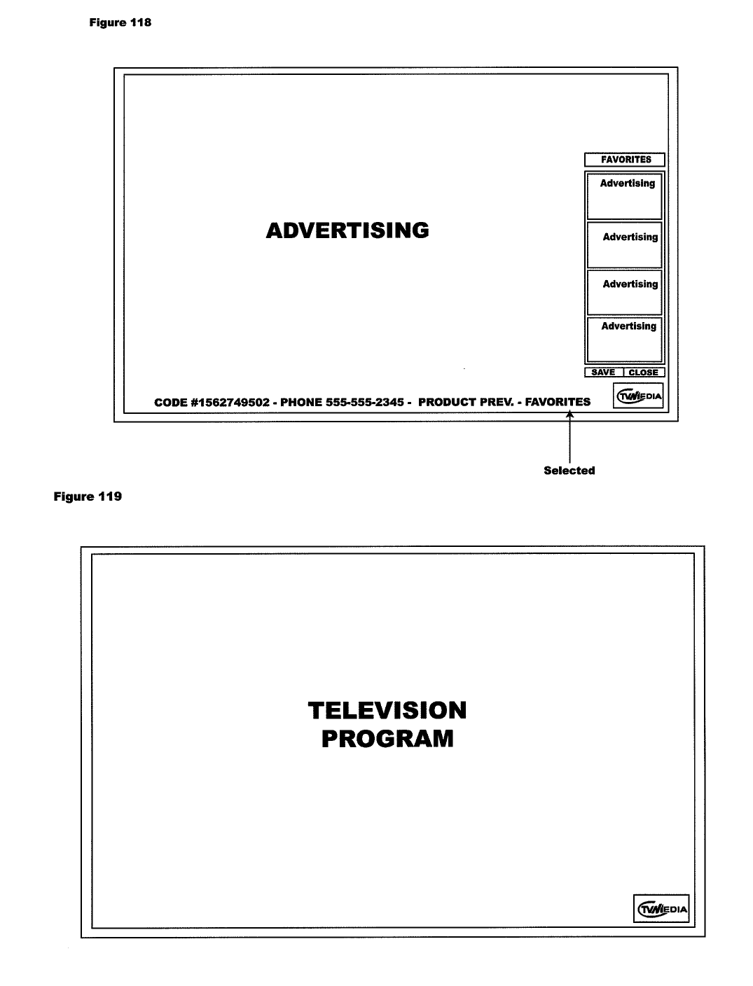

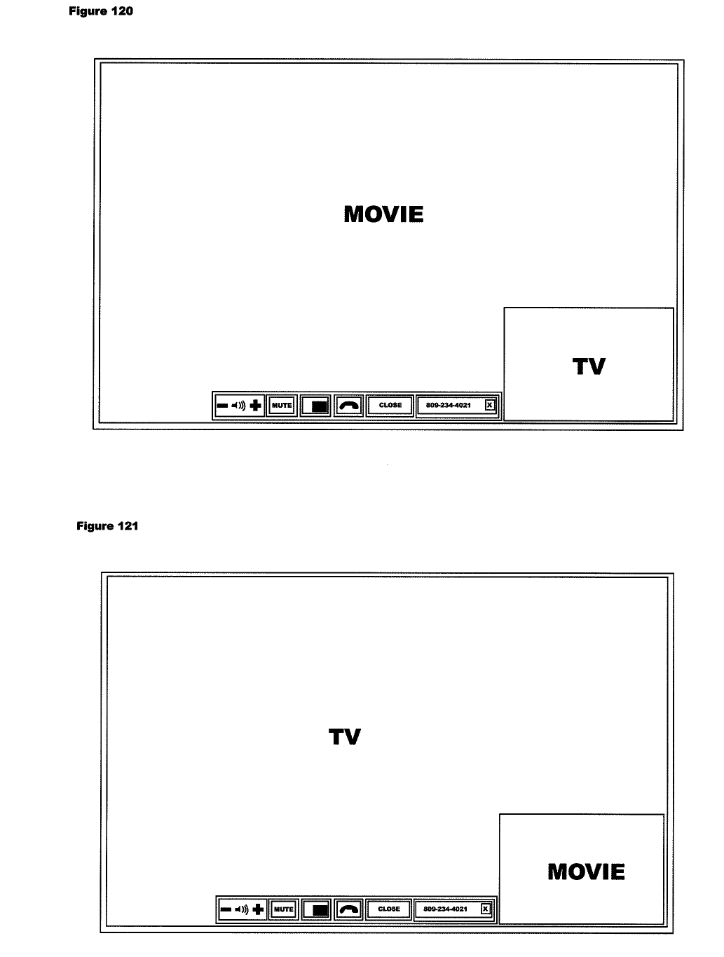

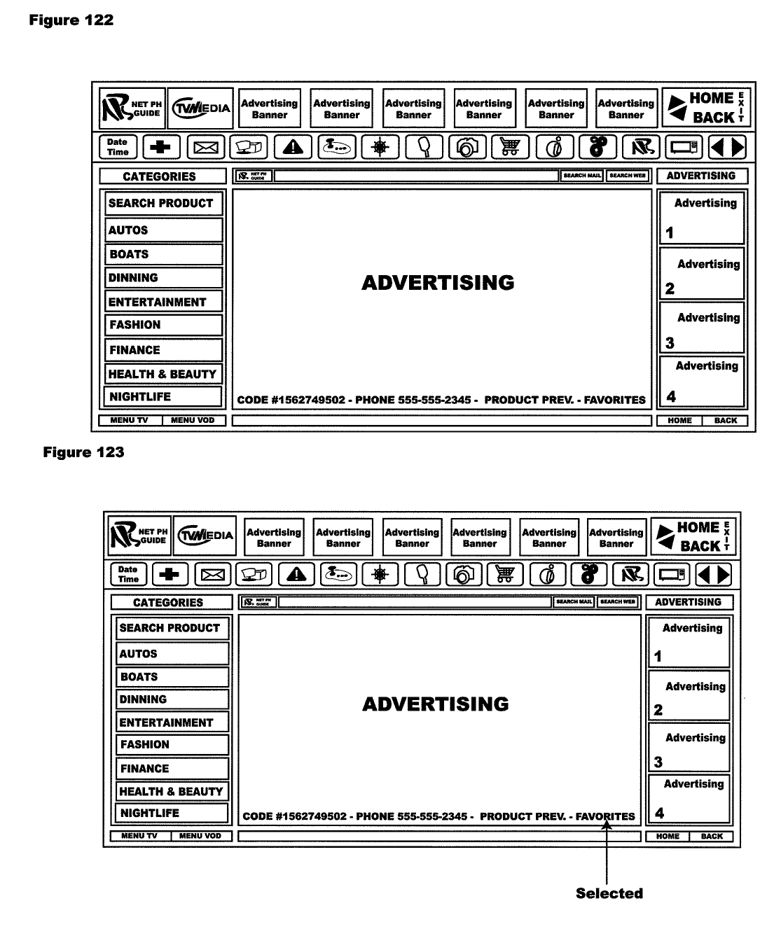

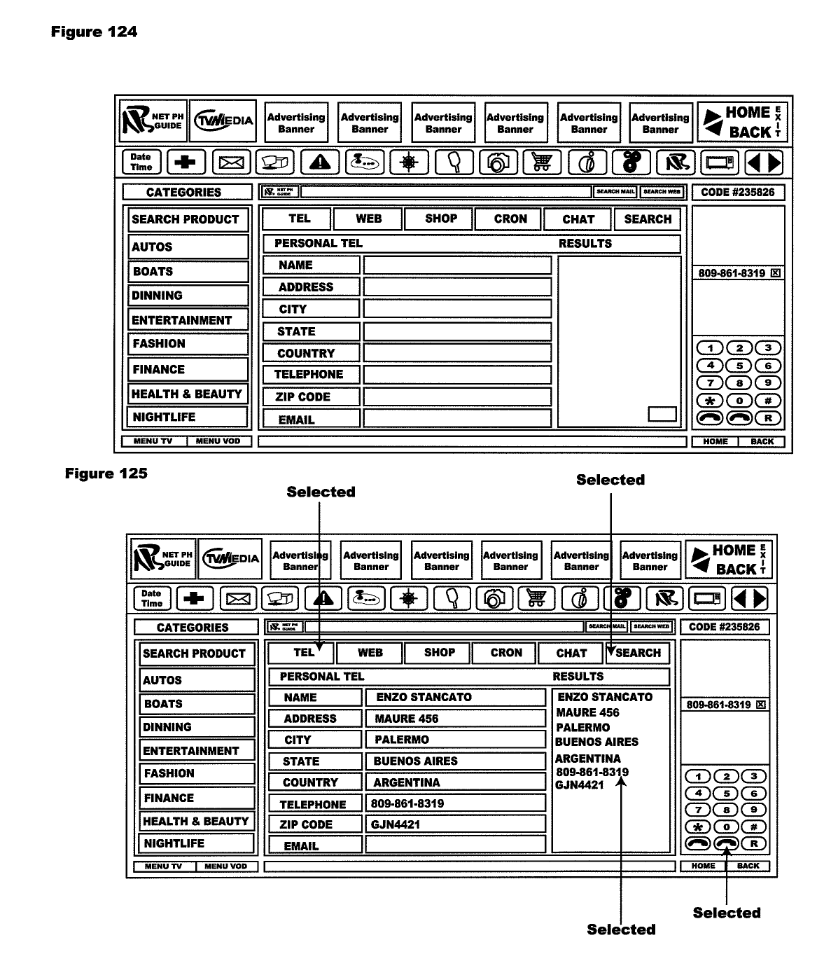

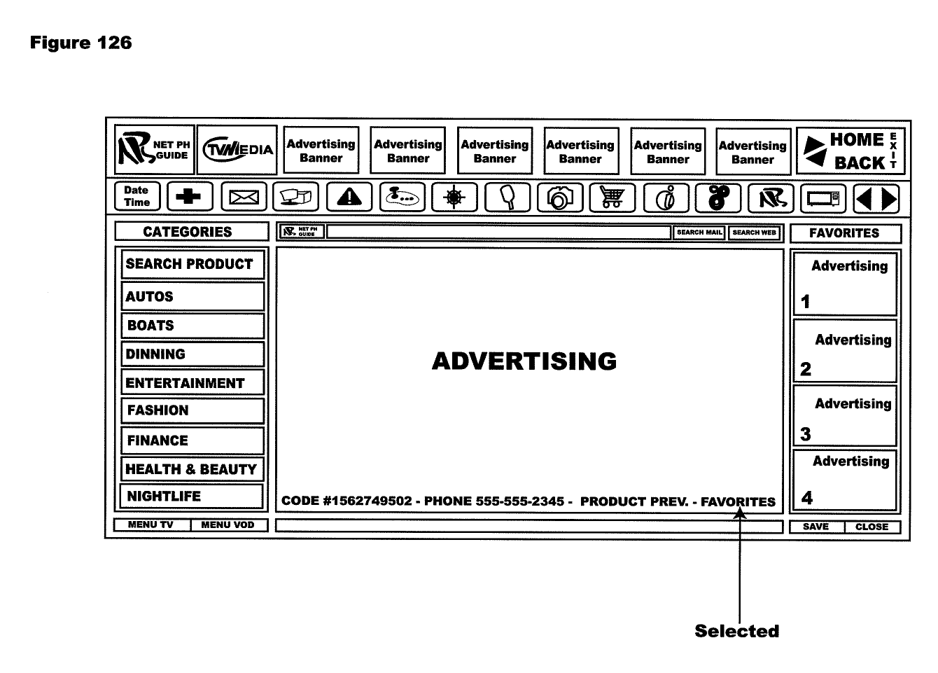

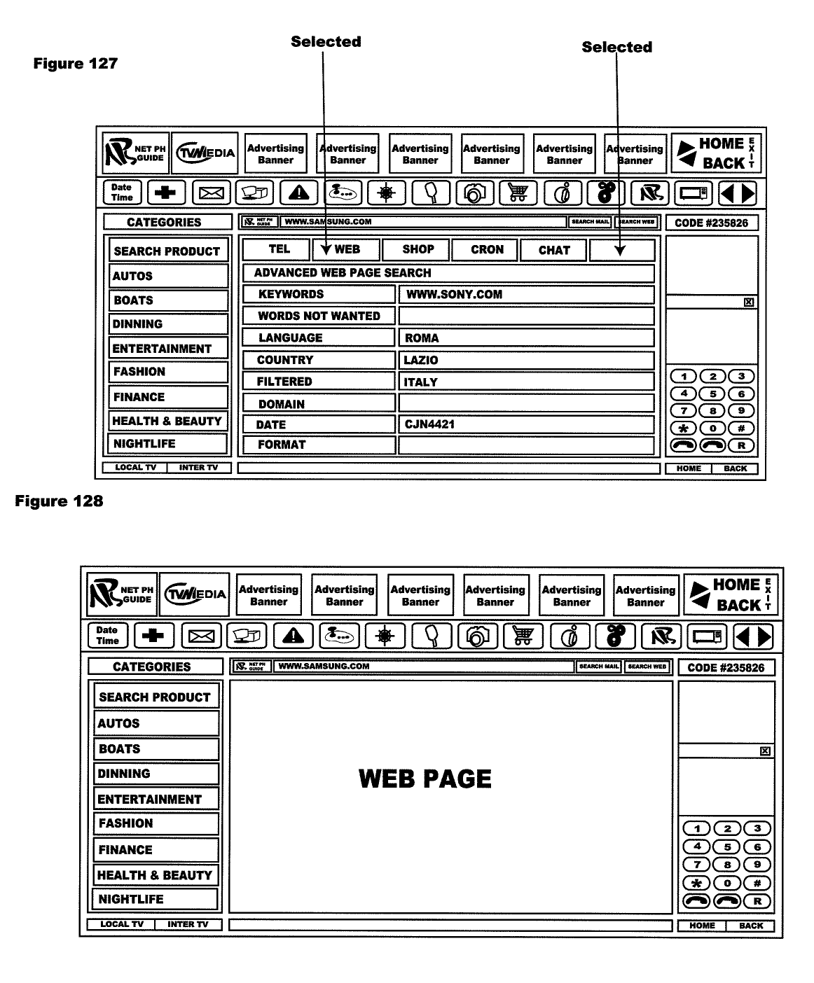

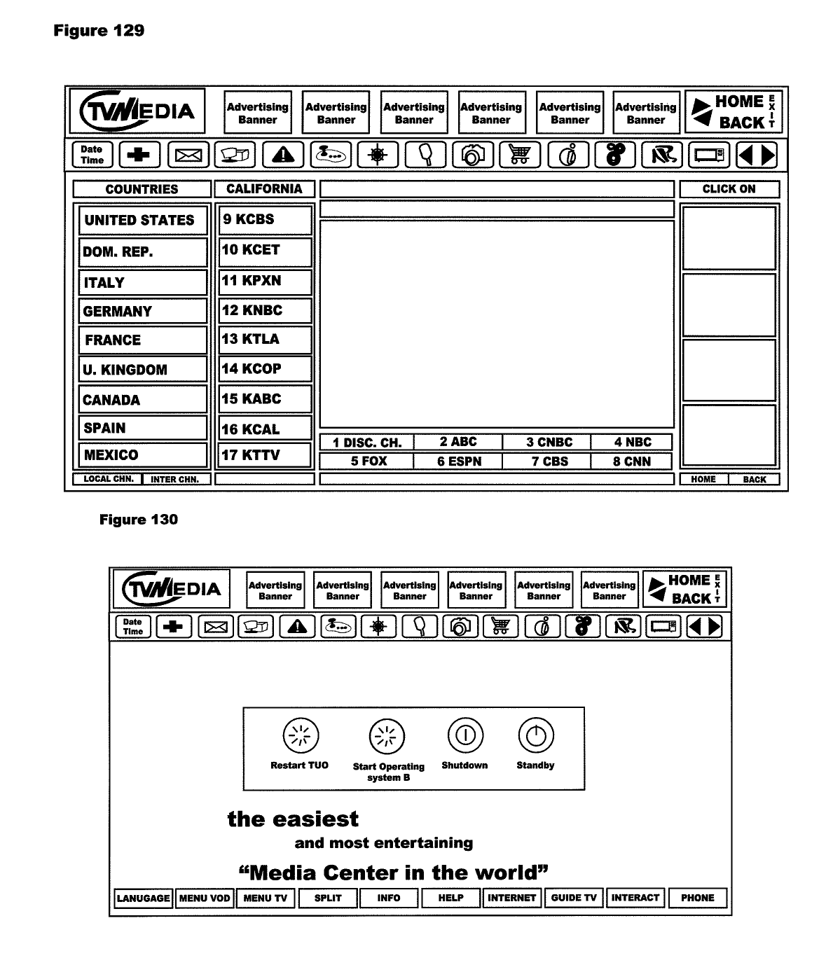

The structure “TV Net Media Center Home” is characterized by a modern design (see FIG. 1.1). Among its features, has a high simplicity and ease of use.

How does it work:

The physical structure is composed by a LCD type monitor case with all the components, software and hardware, that constitute the entire structure.

This allows the user to be able to see television, films and/or go on internet simultaneously (see FIG. 1.2), listening to music and seeing video, phone, and/or buying, renting videos, On-demand, games, music or other content accessible via the Internet.

Physical Structure of the TV Net Media Home Center

At the center of the physical structure of the Tv Net Media Home Center Home (as already described above, is made from a LCD monitor integrated with all the components, software and hardware that constitute the entire structure), Below the screen there is a tray containing various CDs and DVDs (see FIG. 1.3), which can be listened to and displayed automatically operating the remote control. In the back at the center of the box, made of metal/plastic, material integrated with the TV screen, are all the system hardware and electronics, both television and the decoder (see FIG. 1.4), is also equipped with a battery in the lower part of the structure, connected to the Main Board, next (and connected to) to external power, functioning as an integrated UPS.

To the left of the box, behind the screen of television, are all assemble the components of the computer brain (Box) which is related also reader cd-dvd recorder (see FIG. 1.5). In the bottom of the television monitor, there are two internal speakers (see FIG. 1.6); the two sides of the monitor are two more stereo speakers, which can and have a rotation of 180° (see FIG. 1.7), their movement may be activated manually or electronically through the use the remote control.

All this forms an innovative Tele-Computer unique in the world. In summary, the system (Box), located behind the monitor (see FIG. 1.8), is practically a computer with all it's functions and a player with cd-dvd-recorder, infrared sensors, keyboard and mouse with the possibility to use every input/output device of a traditional PC. The interface (see FIG. 1.10) is designed to be able to view all functions and applications, and adaptable to additional ones, infinitely.

The services provided through this structure, also for viewing commercial video entertainment, can be in any language (see FIG. 1.11),independently of which country we are connecting from.

This new system has been designed to give the individual or to all family, the operational work and independence of simultaneously running different functions without interfering with other users running many functions on the same system, computer/television/cable and wireless internet. Our system also provides an electronic device called virtual secretary, mounted on a circuit on one software associated with this circuit, whose function is to provide telephone services management, to answer the telephone, voice mail, call assistant, translator and language program with interactive voice response, and many other functions.

Multifunction Telecommunication Apparatus from Now Called Magic Media Box

Multifunction Telecommunication Apparatus, implemented in a box, provided with a decoder, Lan port, WI-FI card, WI MAX, Bluetooth, with the possibility of being connected to any type of screen CRT, LCD or plasma to work as a computer or as a remotely controlled television.

This structure Offers the possibilità to use a simle TV monitor (CRT, PLASMA or LCD) or PC monitor (LCD, CRT) and other types of monitor, that can be anyway easily adapted to our electronic system and our software system. This is possible because the same video standards ae used ad the box manages the different video devices with it's video card.

It is a metal/plastic structure. The front (see FIG. 1.16) of the structure (Box), is equipped with a receiver and a remote sensor with a digital display and cd/dvd reader/writer. CD-DVD (with the possibility of having the format Blue Ray), and other buttons for digital manual operations. The posterior (back) of the box (see FIG. 1.17) has various ports such as, Wire-Fire, Serial, USB, Releases Video/Audio (Analogue and Digital), telephone, etc. On a side of the frame, a heat sink is installed (see FIG. 1.18) it is attached to box, which is part of an innovative cooling system.

The posterior (back) of the box has various ports such as, Wire-Fire, Serial, USB, Releases Video/Audio (Analogue and Digital), telephone, etc.. On a side of the frame, a heat sink is installed it is attached to box, which is part of an innovative cooling system.

The inside of the box consists of an innovative cooling system itself composed of several heat sinks. Some of these are located in the basis of the box and others are located on the inside of the lid of the box, so that the lid itself serves as a heat sink.

These heat sinks, in addition to two fans, one positioned horizontally in the area of greatest warming of the box, and the other serving as circulation (extractor) of air vertically positioned in the rear area of the box placed next to a window that serves as an air vent. This window has an automatic opening, that that opens when the extractor is functioning and automatically closes when it stops.

These fans function controlled by temperature sensors that allow them to start only when you reach a certain temperature. This is to facilitate the dispersion of heat generated inside the box, and reducing the maximum noise.

The right side (considered if seeing the box from the front)of the “mobile multifunction telecommunications Apparatus”, consists of an auxiliary battery connected Auxiliary connected (removable from the box), and rechargeable directly from the box with a considerable capacity, separate and ventilated through an active and passive heat sink to improve cooling. All this making obsolete the presence of bulky cables that can be eliminated, thus allowing the operation of the box in case of lack of electricity or when you want to use the box in your car or in other mobile circumstances.

The MULTIFUNCTION TELECOMMUNICATIONS APPARATUS (Media Magic Box) is above all an advanced computer, that contains within it a variety of functions with consequent energy savings, unlike some new TV's with a high consumption of energy because they do not act only as a television but support various other technological devices (for example imagine the consumption of a dvd player connected to a TV, plus a PC connected to internet, radio on etc.). All the options and extra multimedia functions are available through a single device that functions as a catalyst: the Media Magic Box, providing you a multifunction system in a single structure. Obviously the description of the boxes below, does not list all components that make up this innovative invention, we refer of course to other components, new software and operating systems technology, exclusively developed for this invention. These were not described for reasons of security, confidentiality and non-disclosure.

Furthermore this type of electronic box contains cards such as: digital tv, satellite, etc..

Mobile Multifunction Telecommunication Apparatus from Now Called Magic Media Box Mobile

The physical structure of the system, it's mechanics and robotics, were created with in mind the goal of integrating them with components of the new generation of computers that reduce the space ensuring the functionality of the box drive. The system has several innovative components, such as a microprocessor that relies on an innovative system for ventilation to improve its capacity, as well as an auxiliary battery to increase the performance and extend its functionality. The use of innovative cards make this structure capable of performing any function both mechanical and electronic, through an operating system and a small integrated monitor innovative interfaces and advanced applications of high technology never known until now, that make the Magic Box Media Mobile an advanced invention in telecommunications. The simplicity and practicality of the Box, associated with high performance, make this structure a small portable PC that gives the whole family maneuverability, and convenience every time there is a travel.

It's a metal/plastic structure, including a folding integrated monitor, similar to a notebook. As a perfect combination of electronics, mechanics and robotics, this structure has all the functions of a computer and has more software that allows the coexistence between all the electronic equipment, television, radio, internet video, tv intranet radio, Internet radio, satellite radio, tv via internet, intranet tv, satellite tv, digital tv (single structure but with the functions of 2 independent computers).

It's practicality and transportability allows the user to be able to easily use this wonderful invention, for multimedia entertainment during leisure travel and/or work.

Both media magic box and media magic box mobile can be in “medium version” and implement a Media magic box that still has excellent performance in terms of speed and quality of access to Telecommunication multifunction Apparatus software, but is a box that does not have all devices of the media magic box, but only the essential ones, the advantage is that the cost is greatly reduced.

The structure is the same of the media magic box, with the difference that some hardware components are not necessary for the usage of the media Magic box medium.

The digital tv card, satellite, tv tuner for example are not present and the remaining components are less powerful versions of the ones of the Media magic box.

System of Multifunction Telecommunications Apparatus Where One Has the Function of Master and the Others of Slave from Now Called Media Magic Box Master/Slave

The multifunction telecommunications Apparatus comes also in the master/slave version (Media magic box Master/Slave) which is, for example, suitable for hotels. Hotels, having a substantial number of rooms can use a Slave box for each room which has lower performance to the other box, but sufficiently satisfactory performance for the use of the customer. The Master box is a super box that manages transactions and communications of the slave box. The master is the box (server) of the administration system in the hotel, it uses an ad hoc system that allows communication and controls the operations of the slaves, using databases constantly updated according to type of contract that the customer makes the hotel.

Only the master controls all the external (with the server for our whole Multifunction telecommunications Apparatus system) traffic between any slave and going from the outside master. Obviously only the video streams in very large terms of bits go directly to the slave (after asking permission to master) this is done not to overload the master, considering that the slaves could be several hundreds. The average Slave magic box allows a partial but at the same time effective use of our service. For example: in the case of all ‘user viewing a single video stream at a time, it does not handle multi video or Full multi processing as in the case of the normal complete boxes (media magic box, media box magic medium) but is great for a customer of a hotel that wants to see clearly the tv, go on the internet or buy on demand.

Physical Structure of Magic Media Box Master/Slave

The slave is a very cheap box that does not have as many devices as the other models, but only those that are indispensable. It has a processor, motherboard and video card with considerably lower performances than other types of box listed above. It Has considerably reduced size and a considerably lower cost. But it allows an excellent communication and interaction with a specialized system for example that of the hotel. The system allows interaction between slave and master. The master is the true server in the hotel system example. The master has a far more complex and elaborated structure, if confronted to the ones of the other boxes but still as a device manages to keep costs down because it only has to manage data and report purchases made by the slave box, not the entire workload of the slaves but works only as a control system and database, authorizing or not the slave to do an operation. The structure of the master is very similar to the average magic box structure, what changes are the larger dimensions and higher hardware performance.

Selling System and Other Computer Applications of the Multifunction Telecommunication Apparatus

The MULTIFUNCTION TELECOMMUNICATION APPARATUS, will also consist in a revolutionary system of purchasing and selling, which will allow the user to buy from home both via telephone and via web, searching and choosing from the catalog contained in this system or searching the product by it's characteristics, and in a’ completely revolutionary way, to buy directly from the product advertisement These active advertisings can be sent or usually while watching a TV program or through some of the multimedia applications of the main device, from now on called Advertising Banners.

If you want to interact with the advertising in banner, the company can advertise the product in photographic and/or in video format.

The selected audio or video banner, contains links to access directly the pre-page presentation of the selected product, and can interact directly with the company that sells the selected product clicking on the web to connect to the web page, or by clicking on the phone to place a phone call, in this way making in any moment on-line purchases or direct telephone purchases, this is made possible by the fact that our interface is equipped with an operating system that makes these innovative services possible.

In the case the user wants to purchase the product he sees in the video advertising (this is possible for those companies that have an agreement with our company to allow the interaction and the usability of the advertising through our system), in other words if you are watching a traditional television broadcast or radio transmission during the advertising the user can purchase the sponsored product directly without the need to make any searches, simply clicking on the product code that appears in the advertising, and quickly buy it, browsing extra information that traditional advertising does not show, making it more likely for the user to become a customer.

Moreover the user has the option to purchase through our call center (and telephone) or through a product advertising web pre-page.

The advantages are that if you cannot devote much attention to the product that the TV channel is transmitting at that moment, the advertising itself can be stored in a dedicated area of the monitor (which does not disturb the screen where the user was browsing for example in internet). Only when the user wants to, he will be able to access several informations on the product. This method of advertising will not be invasive and will not bother the user anymore, which indeed will select the products that he is really interested in.

For this system of purchasing to be complete, a phone and a IT order system has been designed, to accelerate the deliveries, connecting the user directly to the producer of the product, that will turn the order to the distributor of the product nearest to the client.

On the other hand, this system is combined with the possibility that the MULTIFUNCTION TELECOMMUNICATIONS APPARATUS offers, forwarding to the whole world, so that a national television channel may have international visibility, giving the products that are advertises a far larger greater audience and then getting to the consumer anywhere in the world he is. These products not only will be known all over the globe, but you can also sell directly on the world market.

Afterwards, the system purchase has a second phase, the distribution phase, a new method that connects the customer directly with the factory. In this way the manufacturer directly distributes the product through its distribution network or shops, increasing the speed in distribution of the product for the end user.

All this is combined and integrated in the MULTIFUNCTION TELECOMMUNICATIONS APPARATUS, with all the benefits with which this device interacts make something of this invention totally unprecedented in the world market. The possibilities offered by the MULTIFUNCTION TELECOMMUNICATION APPARATUS to rely on a system of phones (fixed or mobile, through both systems) allow you to type by same device and, if it were the case, to investigate telephone verification about the benefits of the product selected. This system of Sales, also avoids the problem of piracy of equipment protected by copyright or intellectual property.

Technology of the Interface—Implementation

For the realization of the interface technology modified Open source software (OSS) was used, All software has been personalized and modified for the peculiar needs of the TVNETMEDIA SYSTEM

The Operating System

The whole software structure of the tvnetmedia is based on a operating system, which is a strong modification of OPEN SOURCE OPERATING SYSTEMS, specialized and personalize to acquire maximum stability and performance for our innovative software.

The Partition/harddisk A, containing the TVNETMEDIA software runs on the proprietary TUO operating system that comes in one package with the TVNETMEDIA software and hardware.

The TUO SYSTEM also guarantees maximum security from tampering and manumissions (willing and unwilling) by the users, and hosts all our innovative communication and encryption security services for the protection of personal data and also of copyrighted media

Presentation of the Interface

Our interface is launched automatically when the operating system starts It gives the user the opportunity and comfort to interact without the need of having to leave the Interface, which is complete to the point that it not only offers the special contents of our interface, but also provides functions of traditional operating systems such as (printing, sending faxes, telephone, videophone, video store, explore and write documents, surf the net, check the emails, view mails, create and send/receive any multimedia content etc..) The potential of interface can be fully used with PC mouse and/or with a remote control containing a mouse system, designed to enable to operate in a simple and practical way in our multimedia system placed on (A). With this device the user can operate with the common remote, and above all can quickly move all along the screen.

To use the box as a classic PC you can easily load a Traditional operating system through a unique command on the interface that will load from another hard disk or another partition a traditional operating system that can be installed by the user, thus allowing the user to use two PCs in a single physical structure. You can with ease and speed move from one system to another.

Using a traditional operating system the user has a High performance PC, also considering the new technologies and innovative hardware and software our box guests.

Description of the Interface and Advertising Management Software of the Tv Net Media Multifunction Telecommunication Apparatus.

Hereby is described more in detail the dynamics and the structure of the interface

It is structured in various parts:

In the first part of the interface, HOME, it is visible at the center of the monitor an animated welcome screen, on the top are available advertising banners and on the top left corner the TVNETMEDIA logo. The advertising banners are dynamic an are changing at fixed time intervals. These banners are linked to access a web prepage of the associated company.

Under the advertising banners there is a scrollable ICON BAR, to access rapidly to the most important functions of the interface itself (police, firemen, ambulance, hospital, email, internet browsing, language and nation selection, road maps, fax, telephone guide, weather forecasts and other services and options, depending on the sections of the interface the user would like toh ave immediate access.

In the top right area it is possible to visualize some buttons that allow the user to perform actions as “back ” or “home”. Back top return to the previously visited section, Home to go back to the initial home screen. On the bottom of the screen there is a bar containing some operational buttons, such as: menu on demand, menu Tv, schedule, split, recording, help, guide Tv, and other services.

The On Demand Screen

Selecting the option “on demand menu” a section opens where the user, by clicking on scrollable menus can choose the type of content to request, video, audio or other, navigating in categories and sub categories (example: for the category film we will have the sub categories containing the various types of film such as: action, cartoons, drama, thriller, etc)

In both the bars of categories and sub categories we can find buttons that are used for the scrolling of the bars. While the user is navigating in these scrollable menus, in the center of the interface interactive television advertisements Are visualized, while on the opposite side there is an advertising scroll also selectable and interactive.

On the top at the center of the TV screen, positioned under the FAVORITE ICON BARS and over the content area, we can see two horizontal bars that display the info about the selected content. For example if we have selected a movie, in the first bar will appear the title of the film with brief info about it, in the second bar instead will appear the hour, day of week, month, lenght of film and other information regarding the selected theme. On the bottom at the center of the interface are positioned buttons for various commands: buy, rent, schedule, mute, info, help, rec, guide.

By pressing the rec button, the interface can record immediately or in a programmed way a non-proprietary content. The user can program the system recording time, the recorded content will be saved on the hard disk and can be accessed from the same recording menu that shows the list of all recorded contents.

The system allows also to visualize all the purchases mad by the user in a fast way, as in the case of a rented movie, clicking on it in the list, the movie will start immediately.

Also part of the interface is a SHOPPING CART, that shows the list of the purchased and allows to by many contents with only one payment, with an internet card or an payment account.

The New System for Sharing of Video Graphics: The “Split”

In order to take advantage of all the system functions of the MULTIFUNCTION TELECOMMUNICATION APPARATUS, a new software system for dividing in frames of images and video, called “SPLIT” was created.

This division has been designed to meet the needs of a single user and/or an entire household by comfortably dividing the monitor in various sections of our interface for a separate and simultaneous video vision and also the various innovative and multiple audio outputs, so you can operate individually and/or simultaneously with them through the various types of screens that our system contains. This innovative system allows the to subdivide the audio outputs, to ensure separation of different sounds if viewing a split there are more than one audio/video stream.

With this hardware, there is an output for every audio stream so they do not overlap on a single output, for each audio output there is a separate audio device (headphones, earphones, speakers). This way our device gives the opportunity to entertain multiple users separately with the same system that will play various functions of the many applications available including: watch a film, watch and interact with advertising, video, listen to music, surfing the internet, conduct video-conferences etc., phone—video phone calls.

The system therefore always offers the possibility to not stop the current operation even if someone needs to make another. Thanks to the SPLIT system one or more users can perform different operations at once. Our system manages in an intuitive and fast way multi-users and multi-functions. For example if you are looking at a football match and contemporary want to see another one or even more then you can do so without disrupting the previous one, displaying many on the same monitor. The user/s will choose the function for every frame in the split, so that one or more users can interact independently on a specific frame having the possibility to move a video or a function in any other frame they want to (swapping)

Details of the Communication

Now we will see more in detail the communication system, referring to operations that the box performs.

Accessing the List of Contents

a. the box makes an SSL connection with the company with which it is connected and is authenticated;

b. if the authentication was successful, the box can take one of the content presentation pages;

c. the company makes a query on the server manager with SSL connection protocols to obtain content data and prepares the submission page;

d. the presentation page content is returned to the box.

All steps between different servers of our system, including the box, take place with SSL-based protocols connections.

Video Channels Transmission Protocol Unicast and Multicast

The transmission channel is carried out through RTP protocol or others may be done in unicast or multicast. The unicast video is sent directly from the server at all clients that require the channel and requires that the server has a bandwidth sufficient Output to serve all requests.

In multicast modes the burden of duplicate packets is entrusted to the network itself. Clients who want to see a channel must ‘join’ the multicast address (of course registration is accepted after authentication), so the server does not send the flow to the individual client but to multicast.

The network, however, must be prepared and provided to the multicast router that multicast duplicating the video stream on all clients joining.

This second option lowers the server load (even a server can serve dozens of channels simultaneously and virtually as many client the entire network can bear).

Also key to decrypt the video is the same for all clients, even if will be dynamically changed at regular intervals to enhance safety.

RTSP Protocol

The video On Demand (OD), in contrast to the direct channel with a advantage of being able to be managed so advanced by the user, or may be paused, sent forward or back and all that is provided by a normal player that displays a file on the local system. This feature interactive with the video stream is guaranteed by using the Protocol RTSP (Real Time Streaming Protocol).

Safety and Installation of Operating Systems Software on the Box

The hardware is the same for all the boxes according to the model, so it makes a printing of the hard disk of the prototype box and you go to all the boxes in series.

The box includes: our operating system (set up ad hoc) program proxy for secure connection based on SSL protocol (Secure Sockets Layer) that on configuration files of the various password box.

Advantage: no need in this way to customize their codes box manually, but only just insert the CD standard (instructions) in so that all the boxes will have initially the same ID.

This issue will be resolved at the first networking of the box to a specific server that configures the codes contained in the configuration files of the box automatically via software (see FIG. 10.1).

So every box will have a custom code that will be unique for a safe recognition, without giving the possibility to access our system to other not authenticated electronic devices.

For your safety the box password is changed from a specific initial password to a server-provided one, so even the assembler/installer of the box will know the same root password.

Example: If the box were originally the same root password (because the CD installation are the same for all box),at the first connection to the server of the box changes.

This is because if someone were to discover the root password of a box could spread easily and can use to access and tamper with the other box from a software.

Safety of all the Multifunction Telecommunication Apparatus

Not only the boxes are equipped with a security software, but also all servers that will be part of our system thanks to use of a “proxy software” that constrains the use of the system software to use of specific hardware, this for the encryption of all information that passes in the system. And also this software cannot be disrupted because there are restrictions on users by the operating system, ie: you do not have all the permissions of a traditional pc admin. Just a specific remote server will have the authorization to change the software installed on A.

As a result we get maximum security for what concerns not only the data (eg password) but also the contents (example: film) and software necessary to operate properly and safely system. All media will be Encypted/decrypted via the Magic Media Box Encryption System (FIG. D1) On our system, other than a software proxy for the system control, we have also included a software proxy concerning the free internet navigation, also on the server side. This system allows us to control all input/output controlling all that concerns the laws regarding viewing and downloading of contents not guaranteed by our servers, but located in unverified locations.

How Does the On Demand Function Work

We have created an on demand services system that can handle the entire cycle of requests until the final distribution. If our client (user-device), requests a content that is not available in the Contents Server at the moment of the request the system will notify the user with a “Content not available” message, and at the same moment will ask the user if he wants to order the content. If the user agrees to order this content, the management server will ask the producer [FIG. D1] for the content. The producer will answer positivly or not in a fixed amount of time and the content will be eventually dispatched to the user.

This gives the possibility to the content producer to know in real- time the actual market requests and useful real-time statistics directly obtained from the user.

The same application can be used to pre-order upcoming contents (“Coming soon” function)

For the Purchase Protection the On Demand function a security system has been elaborated [ see paragraph “tvnetmedia security system”]

Example of an On-Demand Purchace

The user interface through can view the list of movies or contents On-Demand in the catalog and display its trailer or presentation. If the movie or content is already loaded on the server of content the user cpn purchase it. The payment terms provided by the system can be three: Credit Card, The payment card (pre-payed)

Billing. The first mode is mode normally used in the procedures for buying online, requires that the client makes payment via the website of his/her bank.

The prepaid card is a service offered by the system that manages each client account and is rechargeable. With the billing method, also managed by the system, are taken into account the costs carried out by up to a limit, previously set, and then send the bill to the user at the end of a fixed period.

These two modes of payment are protected from a password assigned to each user and the user can change Once chosen mode of payment the box makes the request to the system which verifies the availability of the movie (or other content) and if the payment method is active/valid (enough credit, or pay by credit card successful) then the server will send the movie at the box applicant.

For availability of the movie is not only the availability of a server has the content but the same server has not reached the limit of customers that may serve. Made to the rental box is given a place on the server for content set the duration, period within which the customer can view the video.

Control Ads

Within the user interface are banner advertising and video updatable advertising with a link to a page advertising customized for each banner. We, have various kinds of advertising banners on top, always visible while browsing for that change depending on the ‘interval preset time, the banner side, which change depending on the category because the user selects relating to the same category, and the video-advertising issues and not, that appear while browsing at the center of the interface. The banners and videos are uploaded to the server and are immediately visible from All box, is also guaranteed the rotation of banners so that they are all visible for the same period.

VIDEO Encryption

The movie channels, and all other information to and from customers do not travel through the network in clear but is encrypted so as to be visible only from [see FIG. D1] Customers who paid to see the contents. This process does not increase the Network Load.

User Purchases Panel

The panel purchases user interface is an area that monitors all that the user purchases made through the system. This panel serves for example to know what movie that has been hired yet available to you and how much time remains on the expiry of, or watch those already expired, or have a monthly expenditure incurred, or check the status of orders placed.

Switching Operating Systems and Shutting Down [FIG. d7]

The user can switch from the system (A) containing the tuo/tvnetmedia to the system (B) by pressing the Exit button of the TvNetmedia Interface. At this point the user will be presented with various options of shutdown/restarting systems: restart tuo, start windows, shutdown, standby, in the case the operating system on partition/hard disk B happens to be Microsoft windows™. Whatever system the user may have installed on partition B will appear as an option for restarting the system with operating system B.

This allows a flawless switch between systems,

Specifications and Overview of the Central

The system consists of four main logical drives. Users of service, or the box, and 3 types of servers: The server company, which has the task of creating pages of the catalog content dynamically, the server Managers, which contains the database with information on the box and content, and content server, which stored the contents themselves (see FIG. 6.1). The task of the system is to ensure that only authorized box to connect companies to select the content they wish to view. Once chosen to display the contents of the box can by proxy, their record Key access to the content itself, located on a server content, and view streaming. Furthermore each purchase will be driven by the server managers who keep track of all movements in the box. From the point of view of security must be ensured that the boxes are identified uniquely on the network system, without which their ability passkey can be cloned and then we can authenticate and use the services to place to another customer. The data moving between servers and clients will not be intercepted by other PCs connected to the network. Here is an overview of planned interaction between the components of the system (see FIG. D3) (some passages are sottointesi): The readings on the database (identified by) are safe, because the dbmanager provides authentication and communication with SSL, the request the passkey (identified by) should instead be controlled by the server manager, while the demands of the box (identified by) should be permitted after authentication box, if registered. The workload of the servers within the system is distributed according to tasks that the system must perform: storing data access box, and content, creating dynamic pages presentation of content distribution and content themselves. The manager who manages the database system has a central role in the all transactions involving the content and data must be protected. For ensure control over every single data and wrote that the data are not arbitrarily tampered with the database is accessible from read-only.

Tech Control System Wireless Adapter.

The system is also equipped with a device called tech control, a high tech remote and a keyboard integrated with mouse (see FIG. 1.9).

The Tech Control allows the user the flexibility to do both common tasks of a traditional TV and joint operations with a keyboard PC without having to use multiple tools but by integrating three instruments in one: a mouse, keyboard and remote control, which, however, does not prevent use of the three I instruments separately.

Please note that our technology is designed to adapt both to Touch Screen, and the new technology Moving Screen. Our remote is also equipped with a PC mouse pointer type, and not only can move horizontally and/or vertically, but the scrolling monitor also across the interface and in all possible directions. This creation called Tech Control (see FIG. 4.2), gives the possibility to have a single multifunction device with the same structure. On one side has a PC keyboard with mouse and other embedded options necessary, on the other side has a multifunction remote control containing even a mouse designed to facilitate all transactions on our interface.

Multipurpose Telephone, Alarm System.

Based on these physical structures new integrated systems have been created that expand the invention of the MULTIFUNCTION TELECOMMUNICATION APPARATUS and allow the execution of many other devices, but that basically fulfill the full functionality of

Our system will be equipped with an innovative system which Alarm operation consists mainly through the performance of the device and its main videophone that satisfies different functions (telephone line, mobile phone or even deploying more innovative as such device serves as a video intercom and also as a device with function alarm guarding the environment in which it is located). This device in turn can be connected directly to the central police where the office or the apartment is left unattended. This device is important considering that counts on a significant security system inside it. Using the Telephone Double counting on a sensor system that works in case of loss or removal from the market, consisting of a magnetic sensor, that allows the owner of the phone to have full control of its device. The function of this sensor is to activate an alarm if one where the user is away from Dual Phone Use up to a certain distance. The sensor is built-in Dual Phone Use, and controls the distance to a magnetic device in the hands of the user, which may take different forms.

Away from the scheduled distance, it triggers an alarm that allows identify the exact location of the phone and notify the owner. In the case of accidental loss or theft, you can disable the phone functions, remaining not entitled to its use. To restore all its functions, we must introduce one or more keys or safety pin and only in this way the device may activity.

The Telephone and the Virtual Controller Keyboard

The Telephone/Videophone Function

One of the most innovative functions of the TVNET MEDIA is an integrated VOICE OVER IP telephone, that can be accessed by clicking on the TELEPHONE BUTTON on the bottom bar of the home screen (109) or on the PHONE BUTTON in the FAVORITES ICON BAR (108.2) or anywhere the phone button appears in the interface (as for example in the TVFS function).

Immediately on the right of the screen a PHONE/VIDEOPHONE appears with the image of the person that we are calling, and using the innovative TVNETMEDIA Audio input, output Bluetooth, wireless communication systems the user can talk to anyone without interrupting the other functions of The TVNET MEDIA, he can watch tv, surf on the net or work while communicating in one simple integrated system.

Also the visual phone on the screen can disappear, so to not disturb other functions, you can continue to talk without seeing the phone interface, unless it is a video phone call, in that case the user would maintain the phone on screen. In the case of multiple users at the same time such as conference calls there is a function in the screen functions that allows to place various phone calls and have conference calls also in the same section there is interactive video phone.

This function can be used in conjunction with the interne function. For example if I am surfing on the net, and I want information on a product I can call the customer service of a company while I am consulting the website.

For example I can talk with the airline agent about reserving a ticket while I personally filling up the order on the net or consulting the schedules, or simply I need help on the web page. The function works also if a phone call is received in the section on the top right of the screen an image will appear. You can decide to answer the phone, mute it, or refuse. If the incoming call is a video phone, then the video will appear on the phone. And clicking on the video screen of the phone the image can be enlarged. Even in the case I am watch in content on demand. In that case the content on demand will continue to play or pause, depending on what I want the function to do. By clicking on the image in the videophone, I can view it fullscreen. If I was watching another video, when receiving a video phone call the interface becomes similar to the TV Fullscreen interface, the phone call is enlarged to full screen while the Video content I was watching is put in a bottom right preview window. I can choose to close, stop or continue watching to the video while talking. [FIG. 121]

Our system has a mobile multimedia virtual telephone in which the user can interact via interface without having the physical phone. This virtual device is made by a panel inserted graph automatically (once called via mouse button or TECH CONTROLphysical) in a frame mode of interactive multimedia operating system. The technologies of transmission/reception used by this device are (line traditional phone, wireless and voip). The system has a multimedia tech virtual control in which the user can interact via interface without having the physical control. This virtual device is made by a panel inserted graph automatically (once called via mouse button or physical) in a frame mode of interactive multimedia operating system. And it is usable by any controller input as touch screen mouse etc.

Distribution of Content of Server Package

The company manager has several servers where copies are kept contents of the package provided by companies cable company to end users. The main server that is what has all the copies of purchased content for the cable company, provides copies of the contents of the package to other servers interconnected with each other via the main server in a star way—i.e. each server communicates with the others. All contents of a package of cable company are then geographically distributed even though all have the same information. The reasons are many: 1. Each server will have a geographic area and then some users to manage it intends to provide permissions, you have the basis for data of registered users and provide the video stream to clients. 2. In this way the user of a certain geographical air is served in as speedily and efficiently. 3. The time latency of the network decreases, because the server is closer to client. 4. The guarantee for the client to be served is greater, because the client could be served by the server geographically closest, or another little farther, because the servers communicate in complete among them only for information that was known to bear any other server. path. For example, if a server specific area is too overloaded to the client's request will be forwarded by the server load to the server nearest and less load for a distribution complete communications over the network. 5. Each server has the same content package of basic guarantees back up in case of damage thereto, users that ‘area will still have satisfied the demands by next server closer. This type of design (see FIG. D4) is just to keep the slender the challenges for servers content of the package that will be those requested more secure because the content they own, are included in package already paid by ‘user

The TVFS (TV Fullscreen)

Clicking on the button TV FS on the bottom bar in anyone of the screens of the Tv net media interface or on the TV icon placed in the favorite Icon scroll the user can access the TV FS section (IMAGE n.112)

In this section it is possible to visualize fullscreen TV channels, and simply clicking on the TV net Media Logo placed in the bottom right of the screen we can access the TVFS BAR (IMAGE n112.1)

If I want to change channels I can do so with the remote control.

By pointing the mouse at the bottom appears a bar with volume-channel switching, forward, rewind, record, stop, the full screen and the back button to return to the previous section of the tvnet media.

After we have clicked on the TV NET MEDIA logo The TVFS BAR appears, with it's many useful functions available and many commands to navigate.

At startup the TVFS will be set at the last viewed tv channel of the available channels. It is possible to navigate quickly the channels selecting from the CHANNELS panel (112.2) the right (112.3) or the left arrows (112.4) to go back or forth in the channels list. When the User clicks on one of the navigation arrows, immediately the text in the middle of the two arrows shows the title of the currently viewed channel (112.5) and the information on the current program on that channel (112.6), the TVFS will visualize immediately the new video of the channel.

The other buttons available on this bar are: INTERNET QUICK ACCESS BUTTON (112.7), that opens immediately the internet section, THE TELEPHONE BUTTON (112.8) that opens the telephone function, The PROGRAM GUIDE(112.9) that opens the into screen with details on the video and the programming.

The recording button is also present and is active when recording is allowed, such as free-tv, pre paid events, music videos, and many others.

Also on the left side of the bar there is the WATCH FUNCTION and The CALENDAR FUNCTION 112.10, always active. Clicking on this area the user can always access his personal organizer, agenda, calendar, time management functions, and international time functions, in the same way he can by clicking on the watch placed on the favorites icon bar, this section alsco gives you temperature and the weather forecast and traffic reports also the horoscope information.

Next to the watch we can find the EXIT (112.11) button for exiting quickly the interface and the Home button, for returning to the HOME screen of the Tv net media.

The Tvfullscreen Preview Function

One of the most interesting and highly innovative functions of the TVNETMEDIA is the PREVIEW (113.1) that is controlled by a panel placed on the right of the channels panel. It is similar in looks to the CHANNEL panel, but does a completely different function.

At Startup of the TVFS function the PREVIEW panel has in its center the word PREVIEW (113.2), to indicate that no channels are currently previewed. Selecting a channel in PREVIEW PANEL clicking on the right or left arrow (113.3 and 113.4) we can select the channel to preview.

Immediately, when we selected a channel the name of the channel and the name program currently playing are displayed in the center of the panel and a smaller PREVIEW WINDOW (114.1) appears in the bottom right of the screen, without disturbing the vision of the main TV FS CHANNEL (114.2). Both videos can be visualized together.

The user can continue to watch the main program, while exploring in the PREVIEW window other channel or decide to watch simultaneously two channels.

Clicking on the TVNETMEDIA button (114.3), we can make the bar disappear leaving only the main TV fullscreen video and the preview window visible (115). Clicking on it again we can bring back the TVFS BAR.

Also, the user can decide to close the preview window by clicking on the X button (115.1) placed on the bottom right corner of the preview window, if the user clicks on it the preview window will close and the system will return to view only the main channel (112)

THE SWAP FUNCTION can be accessed clicking on the Swap button (112.12), placed in between the CHANNELS panel and the preview PANEL. Pressing the SWAP button switches the main channel with the preview channel, allowing the user to see the preview in fullscreen and put the video that was before in fullscreen in the preview window.

The Watch/Time Managment Function

The watch is placed on the left of the favorites icon scrolling bar (108.1). Clicking on this area we can access the WATCH FUNCTION and The CALENDAR FUNCTION 112.10, always active. Clicking on this area the user can always access his personal organizer, agenda, calendar, time management functions, and international time functions.

Net Phone Guide

Net phone guide is a revolutionary and complete search engine that gives the user the possibility to find whatever he wants, and most importantly, to access and communicate with the numbers and addresses he finds immediately, integrating with the TVNET MEDIA TELEPHONE FUNCTION.

Clicking on the NET PHONE GUIDE icon placed in the FAVORITES ICON BAR (108.3) or anywhere else in the interface where the net phone guide button appears, we can access the net phone guide search engine interfaces (109).

The LOGO TV NET MEDIA, placed in the upper left corner of the screen, will change to NET PHONE GUIDE (109.1), An interface, showing various bottons appears with Various access functions, one of the functions is to access web pages.

Clicking, the SEARCH screen will appear (109.2). The user will be able to search by name, address, last name, and many other parameters, in the whole world function is to access personal or company email. The other function is to access phone numbers throughout the world.

By clicking any of those buttons a window appears with the search form where we can insert all information all information of the person or Company phone or webpage you wish to find. In the same screen there is a search button, by clicking on the search button a certain number of results per page will appear. By clicking on the number or the name will view the complete address to find more easily your requested person or company.

Searches can be done for products, telephones, web searches, inserting a wide range of possible parameters, for example if I want a phone number, but have only an address, I can search only by address. Or I can also search by name, or by any other possible valid information, searches can be afterwards refined adding more search parameters.

The TV Net Media Secure Media System and Server System

Our invention has a strong network security for delivering, decoding, verifying and updating all content contained on our servers and accessible on the interface. Most importantly a particular attention has been reserved for the method of distributing content protected by copyright.

The Network encryption system gives absolute security guarantee to the provider of the content, that can with confidence insert his copyrighted media in our system, knowing it will have the maximum level of protection provided by the industry today.

In the following paragraph we will explain the security mechanism when providing the content to the box.

How Does Our Security Work (Image D1)

D1.1 The user/Box requests a content to the millennium server (Server A) wich is a content distribution manager server and also of his area, he is validated as a user.

D1.2 The millennium server requests a first key, we will call “Access Key” to the Local media content server. The Dedicated Local media content server (Server B) is a server owned by the content provider that physically resides in the same location of the Millennium server. This is done to guarantee maximum speed and quality of service to the user, on the other hand to guarantee maximum security to the content provider this server has only Encrypted material and millennium (server A) has no way to, copy, access, use or decrypt anything on that computer without the permission and authorization of the content provider.

D1.3 The (Server B) Checks if it has the requested content, if it does, it returns a unique Access key to the Server A.

D1.3b After the validation and verification of availiability of the movie on the local server the payment procedure begins and the millennium server charges on the client's account with the financial institution he prefers.

D1.4 A second key, the “decrypting key” is requested to the central content library (server c), located in the premises of the content provider, this server can also be very far from the millennium server location, being this part of communication only a simple key request, and non an actual transfer of large amounts of data.

D1.5 The decrypting key is returned to the millennium server.

D1.6 The decrypting key and the access key are returned to the client, without the content.

D1.7 The client Requests the encrypted movie, using the “access key” to the server B.

D1.8 Server B sends the ENCRYPTED MOVIE to the Client.

The box now will use the decrypting key to decrypt

The Decription can occur only inside the box, at the last moment, during reproduction of the content, the content itself is still stored encrypted, and can be decrypted only in the instant the user decides to view, listen or watch the media.

All servers have security certifications and all communications are protected via the latest SSL standards.

If for some reason the content is not available on SERVER B, a request and a reservation is made to the server C owned by the content provider. The Server C will after a certain amount of time send the movie, encrypted, to server B. The insertion, encryption and management of the movies is completely transparent and easy to use. It is totally controlled by the media provider, thanks to a Web Application devoped by us, called the MEDIA MANAGEMENT SYSTEM (MMS) [paragraph 32]. The MMS is an application that content providers can safely use to insert their encrypted content inside their local dedicated server inside the millennium premises.

The Tv Net Media Management System (MMS) Application

This Application allows the content providers to control directly the server that contains their encrypted media inside the millennium server system, add content, modify, remove automatically taking care of the transmission and most importantly, the conversion and encryption of the file that will be sent to their local dedicated server (B) [FIG. d1].

Not only the content company can also have through our interface a constant flow of statistics about how much of their content is watched and receiving the requests of content from the users.

The application is divided in 3 areas Management, Statistics and Request Analysis.

In Area 1. “management” the content provider can view the content he has put on his dedicated server B, add, modify, or remove whatever he wants from it. Immediately the interface in all the households that have the Tvnet media client will be updated with the new information.

All management operations are done from this area that shows us a list of content on the dedicated server.

When he adds a file the content provider only has to insert the file he wishes to add from his central server, press the “ADD” button and the software will automatically: compress in our format, Encrypt with a key only the content provider server (server c) knows and send it automatically to server B, inserting all information in the database.

All the passages of the management of the MMS have the advantage of being real-time and transparent.

This application makes the streaming and the delivery of content easy and protected and that's why it is unique and exclusive in today's technology.

In area 2, statistics The Content provider can receive all statistics of how much has his content be requested, at what time and at what price, to monitor constantly the level use of the system. This is most important for the provider to make strategic decisions on future content to insert in the system, maximize customer satisfaction and increase overall revenue.

Area 3 request analysis, In this area the content provider sees all requests arrived to his server of content that is present in their central library (SERVER C) but not in their local millennium server (B), they can decide if and when to satisfy these requests simply accessing the management area.

The transmission of new content from server C to Server B can be done in many ways, via IP, via satellite or dedicated cable or radio or wireless.

With even only one employee an entire system can be easily maintained, content can be added, and customer requests can be satisfied in few clicks.

The Tvnet Media Advertising System—Details

A new type of advertising can be implemented with the functions of the TVNETMEDIA, using together the power of the Videophone, interactive capabilities, secure payments and virtual secretary. All commercials inside the TVnetMedia are selectable. Once selected it is possible to place an order immediately or in a second moment using the virtual secretary. If the user decides to check the products that interested him later, these are placed in an area called: FAVORITE ADVERTISMENTS ACCUMULATION BAR [FIG. 118]. All my favorites will be here for a certain amount of time, more or less a month, after they will be automatically removed. When the user decides to interact with this advertising, he activates the TVNET MEDIA SELLING SYSTEM [FIG. D6]. Our call centre places the order directly to the producer closest the user that is calling, and automatically he will receive his merchandise at home [FIG. D6].

Personalized Interface of the MENU ON DEMAND:

All categories can be updated and changed by our servers, and private multimedia distributors can reserve for themselves private areas for their names. The scrolling menu allows to add as many entries we wish to add. Once the multimedia distributor has his own section, when the user accesses that section the whole appearance of the TVNETMEDIA system will change in theme with the distributor's look, making the TVNET MEDIA also a personalized interface

Parental Control

In this area of the configuration panel the user can activate or Deactivate the TV NET MEDIA parental control system. This system, if activated will make so that the tvnet media in all it's sections will automatically, not show any content that is not suitable for minors. This important option configures the TV NET MEDIA as a safe system for children and provides guarantees to the parents that traditional tv cannot give.

The Hotel and All Gated Communities Distribution System.

For gated communities such as hotels, cruise ships, hospitals and others we have developed a distribution system that allows many users to access on demand functions and TVNETMEDIA services easily. The Community Network is composed by 3 main Devices [FIG. D4]
1. The Community Server
2. The Router
3. The Slave Boxes

The Community Server has locally stored a certain number of Encrypted Contents, that can be demanded always accessing and validating with our central server. The reason why communities will have this local server is to lower the bandwidth required to satisfy all demands of the many slaves present in the network.

The Whole community will appear to the central TVNETMEDIA Server as one Super-client and all billings of viewed content in the local server will be done automatically on the account of the community.

The process of encryption/Decryption is similar to the normal encrypting/decrypting method the user of Mediamagic box or Tvnetmedia has [FIG. d1].

Innovative Channel Distribution System—

The Server that provides service for the clients of the Magic Media Box has many innovative ways to send and compress Digital signals for transmitting in the most efficient way the requested contents. [FIG. D2]

For the transmission of channels the server will acquire from different sources (antenna, satellite, cable---) and transform them in the correct format for being viewed by the TYVNETMEDIA. The Channels are then Multiplexed and transmitted to the clients.

On the other hand all On demand services, and all other services will be managed by our dedicated servers via an Internet connection, which will vary, depending on the connection aviaiable (wimax, broadband, etc..)

The live channels will be demultiplexed By the MAGIC ROUTER hereby described.

The Magic Router [FIG. D3]—

The magic router performs the traditional functions of the router, plus many more tasks. It has the job to harmoniously distribute all channels and bandwidth It is composed by a traditional wimax or broadband input and an internal router with outputs, to give the connections to all the slave boxes in the household [FIG. D2] But it also possesses unique satellite decoding capabilities. It receives the multiplexed signal from the TVNETMEDIA servers and multiplies it ×6 to its 6 internal decoders. These decoder are commanded via IP by the slave boxes, so that they can receive any given channel the slave requests. So the magic router is more a central of media distribution, where the boxes may access the Broadband internet services or access one of the many multiplexed channels, commanding one of the internal decoders of the MR [FIG D3].The magic router can also be made with more than 6 channels, and gives the possibility to have in your household many more boxes without having to install expensive decoders and hardware in each one of them.

1. Multifunction apparatus for telecommunications that includes two hard disks or two separated partitions of one hard disk, expansion cards for web connection, tv tuner and decoder for receiving radio and television programs, remote control characterized by the fact that a first OS for the multimedia functions on the first partition or hard disk, that both the first and the second Partition or hard disk are controlled with the same remote control, that the first OS has hardware and software restrictions and that it cannot be modified by the user or replaced and that the second operating system does not have restrictions and can be modified or replaced by the user, that this multifunction apparatus also contains a removable and rechargeable battery.

2. Multifunction apparatus for telecommunications according to claim 1, gives the possibility of switching from the first hard disk/partition to the second one and vice versa, but it is not possible an interaction between the first partition/hard disk and the second.

3. Multifunction apparatus for telecommunications according to claim 2 characterized by the fact that the hard disks/partitions do not have conflicts between them and moreover keep the multimedia structure (disk 1) free from any potential computer virus, blocking non authorized access, this is achieved through independent Operating Systems, with Open source platforms adapted to work with our system and that the hard disk or partition for the multimedia system (from now on defined as A), contains an independent operating system for the single Telecommunication function with hardware and software restrictions.

4. Multifunction Apparatus for telecommunications according to claim 3 characterized by the fact that that the Remote Control has a first side that has commands for: Channel control, volume, images, on/off, short cuts to access particular pages of the installed software on the first hard disk/partition, such as Home, Previous, Next, Direction controls and a second side that has a QUERTY keyboard, a numeric keypad, a trackball mouse, Audio/Video Shortcuts to use the computer.

5. Multifunction Apparatus for telecommunications according to claim 4 characterized by the fact that the mentioned apparatus is connected to a CRT, LCD or PLASMA.

6. Multifunction Apparatus for telecommunications as in claim 4 characterized by the fact that the electric battery is rechargeable and removable and is cooled by active and passive heat sinks, to improve the heat dissipation.

7. Multifunction Apparatus for telecommunications according to claim 4 characterized by the fact that this multifunction telecommunications apparatus has a ventilation system made by 2 fans that pull out the hot air, improving heat dissipation of the electronic components and distributing in a balanced way air inside the unit, that the air distribution that this innovative system generates allows the components of the device to heat later, and when this may happen, a temperature sensor sends to the system an alert to cool the system, this alert gives the second fan the command to activate, that the first fan that performs it-s traditional function for the CPU is completed with the second fan, located horizontally, close to the side cover on the opposite side of the CPU, and expels the hot air through an air grid on the cover, that in the moment the sensor communicates to the fan to stop when the temperature has decreased, that this mechanism allows air circulation in a way that the hot air is concentrated in the areas closet o the fans, so that they can extract easily and that the device has robotic that can open to send more air to the device's internal hardware when the temperature reaches a certain limit.

8. Multifunction Apparatus for telecommunications according to claim 4 characterized by the fact that this apparatus has a double use remote control that allows the user to interact via keyboard and via graphical interface.

9. Multifunction Apparatus for telecommunications according to claim 5 characterized by the fact that the monitor is embedded.

10. Multifunction Apparatus for telecommunications according to claim 5 characterized by the fact that the monitor can be closed, to implement a notebook-like structure.

11. Multifunction Apparatus for telecommunications according to claim 6 characterized by the fact that it possesses an internet camera so that a radio broadcasting station can easily become a television broadcasting station, that the system uses an internet camera and a server box for radio stations, that the radio stations have the internet camera connected to a server box, i twill send information to all the users in the world, and that the same can happen without using the server box, considering that the camera is a mini PC; but to have a high image quality, security and stability it is preferable that the information captured by the camera are sent to the server, that the server allows the pre-programming of the advertisements that will start as soon as the internet camera is interrupted for reasons of advertising interruptions or other, that it will use a software system that allows to record all transmissions of the station on the box server.

12. Multifunction Apparatus for telecommunications according to claim 10 characterized by the fact that it implements a security system that uses the internet camera and a VOIP telephone, with a movement sensor that captures the movements in front of the device, having a ray of light that creates a infrared barrier between 2 points, a receiver/mirror and the camera as source. Locating in various positions these devices the user can create various types of barriers depending on the type of household he wants to protect, that when the barrier is interrupted or movement is detected an acoustic alarm is activated, that the telephone integrated in the device will send a security message (to public and/or private security) with it's VOIP system, transmitting a pre-recorded message, explaining the situation and giving the address, and also the camera will start a recording of what is happening in the house, with “panoramic” recordings from all angles, as allowed by the 360 degree rotating system, that the camera allows a double use of the device, it captures three thousand frames per minute and is capable of making an instant analysis of the changes that are happening in the frames recorded by the optic sensor, finding eventual movements that may occur, that with this detection system we can measure the level of movement in the image, and determine if in the system there is a small or large object, also can distinguish areas in a same image and every area with a different sensibility to movement, and that when calling the authorities the telephone stays connected, thus functioning as a audio surveillance, so that the authorities have knowledge of what's happening in the house or in the office of the user of our device, that the camera of our apparatus is equipped with fire, temperature, humidity sensors, that connect to other sensors placed in the rest of the protected premises, to alert the authorities according to the type of emergency, that when the alarm activates and when the communication to security forces starts, according to the situation inferred by the analysis of the audio video data the authorities can decide to deactivate, the alarm, in the case of a fake emergency.

13. Multifunction Apparatus for telecommunications according to claim 12 characterized by the fact that our device is equipped with a video camera, that enables to capture pictures and record video to be sent to any other device in the world that can receive this type of data, which the camera with a spherical dome Structure is claimed as integrated in our device, but also for any other independent use possible, that the camera has to lenses that share the same physical structure and have a spherical mechanical system, a dome-like structure, that is composed by a spherical mobile part that contains the cameras, leaving them pointing in opposite directions, but with full mobility and completely independent for each camera, that the mobile spherical dome-like mobile part can move in an angle of 360°, in any direction and can move manually and also via electronic-mechanical commands, that the video camera, with one of it's integrated cameras can obtain images and recordings of the objects that the user chooses, and with the other camera, the user can be recorded for videoconferencing purposes, that the video-camera can also count on an integrated security system, that ports to the VOIP telephone which is integrated in the preinstalled software.

14. Multifunction Apparatus for telecommunications according to claim 5 characterized by the fact that it can be implemented as a cylindrically shaped structure that has the possibility to rotate on an axis, in an automatic manner with electromechanical commands, that can be activated via connected input devices (with a special motor created for this purpose) but also manually.

15. Multifunction Apparatus for telecommunications as in claim 4 characterized by the fact that the software device that can place and receive calls using according to VOIP technology that the audio phone is also Videophone and that it has a virtual secretary.

16. Multifunction Apparatus for telecommunications according to claim 15 characterized by the fact that it posesses a virtual secretary that is a software with voice recognition capabilities, accepts commands from the user executing operations of communication and of answering machine, that the virtual secretary also has the function of connecting the user with a e-commerce centre in the moment he clicks on an active advertisement, that the software gives information on the incoming phone calls and also manages the archive of calls, that the software shows a log of incoming received and not received phone calls, that it has the possibility to convert vocal messages in text and to transmit in the text archives these messages to any recipient, via internet.

17. Multifunction Apparatus for telecommunications according to claim 16 characterized by the fact that an order made by the user inside the interface, by clicking on an advertisement, is sent by the software to the virtual secretary program, that transforms it in an preformatted text order and sends it directly to the distribution center, making the whole process an automated ordering procedure, that in case the user prefers to talk to a call center employee instead of the automatic order, the virtual secretary will connect him with a call center operator that will provide any extra information the user may need and eventually place an order.

18. System for the management of the sale of on-demand content that uses one or more multifunction Telecommunication apparatuses according to claim 4 characterized by the fact that a user can request a content to a server Millennium, from now defined as SEVER A, that is a manager for the distribution of content in the area, and is authenticated a san authorized user, that the server A requests a first key, that we may call “ACCESS KEY”, to the local content server, from now on called SERVER B, it is a server of property of the content provider that is physically placed in the same premises of SERVER A, that the server B checks the availability of the requested content, and if it is available, it sends an unique “ACCESS KEY” to server A, that after the user validation and the verification of the availability of the content on SERVER B, can start a payment procedure and the SERVER A gets the correspondent amount of money from the users account, with a previously chosen financial institution, that a second key, the “DECRYPTING KEY” is requested to the central content server, from now named “SERVER C”, that is placed in the premises of the content provider, this server C can be also very distant from the physical location of server A, because this part of the process is only a simple. key request, not an actual transfer of great quantities of data, that the DECRIPTION KEY is returned to server A, that the decryption key and the access key are sent to the user, without the content, that the user requests the encrypted content from SERVER B using his ACCESS KEY, that the SERVER B sends the encrypted film to the user, that the user, using the box, will use the Decrypting key to decrypt the content, that the content is stored inside the box still in encrypted mode and can be decrypted only in the moment the user decide to view or listen to the content that all the servers have security certifications and all communications are protected with the latest SSL standards, that if for any reason the content is not available on server B a reservation request is made to the SERVER C owned by the content provider, that the server C, after a certain time, sends the movie, always in crypted format to the B server, that using an application that is a system for content management on servers the content providers can insert their content in their dedicated server B, located in the same premises of the server A.

19. System for the management of on demand content sales according to claim 18, characterized by the fact that an interface that show san inventory of channels both National and regional exists, of all nations of the world, that it is accessible via IP TV and the communication between all the server A in the world, that the regional channels, otherwise not visible in a generic X region, is requested by the user through the interface of his multimedia PC, the live stream of this interface is transferred from the server A of the region in which the regional cannel is normally transmitted to the server A placed in the region where the request has been made and sent to the user via IP, that the existence of this collaborative mechanism between the A servers allows an extension of the available content.

20. Multifunction Apparatus for telecommunications according to claim 4 characterized by the fact that it has the functions TV FULLSCREEN and PREVIEW FUNCTION. Clicking on the button TVFS placed anywhere on the interface the user can access the area of the FULLSCREEN TV vision, a television seen in fullscreen that has several functions, accessible via a bar that can be visible or hidden with a simple user command, that extends its functionality, that the preview function, present on the bar allows to navigate and see the PREVIEW of the channels in a little window placed on the bottom right of the screen. With the SWAP function we can switch the content of the fullscreen with the one of the small window and vice versa, instantly

21. Multifunction Apparatus for telecommunications according to claim 18 characterized by the fact that it has a web application, the Media Management System, to help provider to manage and insert their contents inside the server A, that it has a friendly user interface and gives the possibility to the content providers to insert, transmit, trace and convert in the correct format their product, that will be immediately visible to the user of the Multifunction Apparatus for telecommunications, that the web application is divided in 3 parts, a first one that allows to insert through forms the desired content, after that the content provider has clicked on “send” the system will take care of the conversion in the right format, encryption and sending the decryption key to the content provider, of the transmission of the data to server A, that the second part is a detailed reporting of the usage of the previously inserted content, service that allows the user to make strategic decisions, and that the third part of the program is an integrated communication system to receive eventual requests from the users not loaded on server B, but available in the catalogue of the provider.

22. Multifunction Apparatus for telecommunications according to claim 18 characterized by that it possesses an advertising system that is composed by 3 main parts, an interactive interface that allows the user to click on a number, code or website name to but. Clicking on the website, a company pre-page will appear to place orders, that all orders can be made instantly via call center and virtual secretary of the interface and that the content of the order will be sent using the distributor closet to the user.

23. Multifunction Apparatus for telecommunications according to claim 22 characterized by the fact that the interface has a favorite advertisings BAR, every advertisement the user clicks on will be added to this scrollable bar, to be consulted afterwards, allowing the user to postpone eventual purchases.

24. System for the management of the sales of the on-demand content according to claim 18, characterized by the fact that it has a system for distributing content in hotels and other gated communities, that for the billing system it has a Content Sub server, placed inside the served community, to give content locally, this server is protected with the same security methods with 2 keys, that all the purchases made by the boxes inside the community will be sent to the sub server that will provide an internal personalized billing, while the community seen as a single entity will pay the total sum of all single bills.

25. System for the management of on demand content sales according to claim 24 characterized by the fact that is includes an Internet/satellite ROUTER, that has internet lan, wimax inputs, a routing circuitry for the internet signal and also capabilities of Satellite decoding, that is composed by a certain number of decoding circuits, that receive the multiplexed signal in input and send it to the single multifunction telecommunication computers placed in the internal network served by the internet/satellite router.

26. System for the management of on demand content sales according to claim 25 characterized by the fact that the internet/satellite router has it's application in the network composed by n computers in the same premises, typically, but not limited to, from 2 to 3 multimedia PC's

27. System for the management of on demand content sales according to claim 25 characterized by the fact that the router receives the multiplexed signal from the A servers and multiplies it n times sending it to it's n internal decoders, the number of internal decoders implemented can be 3-4 or more, according to need, that these decoders are commanded via IP from the slave boxes, so that they can receive any channel requested by the box via an IP command. This device should be considered a central for the distribution of media inside the house, where multifunction Telecommunication computers can access broadband internet or access one of the satellite channels, remotely tuning one of the internal decoders of the router, having this way in one location many terminals without needing to install satellite decoders and expensive hardware in each one of them.

28. System for the management of on demand content sales according to claim 25 characterized by the fact that the router has the job to distribute evenly all channels and available internet bandwidth to the multimedia computers in the house, that the router is made of a traditional or Wimax net input and an internal router with various outputs, to give internet connection to the various Multimedia PC's of the house.
